(19) United States
(12) Patent Application Publication
(10) Pub. No.: US 2023/0162883 A1
(43) Pub. Date: May 25, 2023

(54) COMPOSITION AND METHOD

(71) Applicant: THE UNIVERSITY OF LIVERPOOL, Liverpool, Merseyside (GB)

(72) Inventors: Jianliang XIAO, Liverpool, Merseyside (GB); Yi HUANG, Liverpool, Merseyside (GB); Elliot BENNETT, Liverpool, Merseyside (GB); Chaoyun SONG, Liverpool, Merseyside (GB)

(21) Appl. No.: 17/768,088

(22) PCT Filed: Oct. 9, 2020
(86) PCT No.: PCT/GB2020/052527

§ 371 Date: Apr. 11, 2022

(30) Foreign Application Priority Data
Oct. 11, 2019 (GB) 1914777.6

(51) Int. Cl. H01B 3/00

(52) U.S. Cl. CPC H01B 3/004; H01Q 1/36

(57) ABSTRACT

A composition is described, having a relative permittivity, preferably a real part ε′γ of a relative complex permittivity εγ, substantially inversely proportional to the square of a frequency of an alternating electrical field, preferably due to an electromagnetic field, for example applied thereto and/or propagating therethrough.

### FIELD

The present invention relates to compositions for radio and microwave engineering.

### BACKGROUND TO THE INVENTION

Radio communications have experienced amazing developments since 1990s. We are now entering 5G era, more wireless systems and applications will be undoubtedly emerging as an essential part of our daily life and the global economy. A major challenge is how to make the wireless systems multifunctional and reconfigurable over an ultra-wide or multi-band. For example, smartphones already include multiple antennas because antennas which are not a significant fraction of a wavelength in size are inevitably inefficient. Hence, the smartphones include multiple antennas for cellular, Bluetooth, GPS, Wi-Fi and NFC systems over the frequency range from about 13 MHz to 5 GHz. For example, a smartphone may include one or two antennas for Wi-Fi, one for Bluetooth, one or two for GPS, and two or four for 4G LTE cellular communications. It is now extremely hard to add more functions and frequencies to the smartphones, because the multiple antennas need to operate simultaneously without interfering with one another. Software defined radio is considered as the best solution for future radio systems where ultra-wideband RF/microwave antennas and devices are required.

Hence, there is a need to improve antennas and relevant devices.

### SUMMARY OF THE INVENTION

It is one aim of the present invention, amongst others, to provide a composition which at least partially obviates or mitigates at least some of the disadvantages of the prior art, whether identified herein or elsewhere. For instance, it is an aim of embodiments of the invention to provide a composition that has a relative permittivity substantially inversely proportional to the square of a frequency of an applied electrical field. For instance, it is an aim of embodiments of the invention to provide a composition in which the effective wavelength is a constant, for example over a frequency range of interest.

A first aspect provides a composition having a relative permittivity, preferably a real part ε′ᵣ of a relative complex permittivity εᵣ, substantially inversely proportional to the square of a frequency of an alternating electrical field, preferably due to an electromagnetic field, for example applied thereto and/or propagating therethrough.

A second aspect provides a method of providing a composition having a relative permittivity, preferably a real part ε′ᵣ of a relative complex permittivity εᵣ, substantially inversely proportional to the square of a frequency of an alternating electrical field, preferably due to an electromagnetic field, for example applied thereto and/or propagating therethrough, wherein the method comprises:

including a solid phase in a liquid phase; and

optionally solidifying, at least in part, the liquid phase, thereby providing the composition.

A third aspect provides an electronic device comprising a composition according to the first aspect.

A fourth aspect provides use of dispersed powders in a dielectric matrix as an antenna and RF/microwave devices.

### DETAILED DESCRIPTION OF THE INVENTION

According to the present invention there is provided a composition, as set forth in the appended claims. Also provided is a method of providing such a composition, an electronic device comprising such a composition and use of of such a composition. Other features of the invention will be apparent from the dependent claims, and the description that follows.

The first aspect provides a composition having a relative permittivity, preferably a real part ε′ᵣ (also denoted as ε′) of a relative complex permittivity εᵣ, substantially inversely proportional to the square of a frequency of an alternating electrical field, preferably due to an electromagnetic field, for example applied thereto and/or propagating therethrough.

In this way, a wavelength of electromagnetic radiation, for example radio waves, in the composition (also referred to herein as a composite material) is substantially constant such that an antenna comprised of such a composition operates at all frequencies, with substantially equal efficiencies. In this way, a single antenna may be used for transmission and/or reception across a broad band of frequencies, for example from 3 kHz to 300 GHz, preferably from 1 MHz to 10 GHz.

In one example, the composition comprises a set of liquids, including a first liquid and optionally a second liquid, and optionally, a set of solids including a first solid.

Compositions according to exemplary embodiments may be conveniently grouped thus:

Composition I

A liquid mixture, Composition I, with a desired dielectric relaxation gradient is formulated from 1 liquid+1 (or more) liquid or solid compounds from our library of dielectric materials or other sources. The amounts and type of each starting component, e.g. a solvent or an ionic liquid, will vary, depending on the desired complex permittivity required for a specific application. The dielectric properties of the composite liquid material, Composition I, can be tuned by varying the nature of the components and their ratios.

Composition II

When the desired dielectric relaxation gradient is achieved in the Composition I, an appropriate amount (often <1 wt. % but generally no more than 5 wt. %) of a low-molecular weight gelator (LMWG—such as Z-ILeuNHC₁₈H₃₈ or R—C₁₂C₁₂) is added, affording a gel solid composite material, Composition II, which may display a similar dielectric spectrum.

Composition III

If required, specific particles of metal or metal compounds of preferred composition, size and shape (e.g. spheroid copper particles with an average particle size of 10 μm) are introduced into Composition II, affording a new composition III that may display a different dielectric spectrum.

General Method for the Preparation of Compositions II and III

To a starting liquid mixture with a specifically tuned frequency-dependent permittivity is added 2-40 gL⁻¹ (dependent upon starting liquid composition) of a solid LMWG and the mixture heated whilst stirred (up to but not exceeding the boiling point of the starting liquid) until the solid LMWG has completely dissolved. Upon cooling to room temperature the material solidifies into a gel, affording Composition II. If required the material can be further tuned by the addition of solid particles of precise composition, size and shape, which affords Composition III. Mechanical strength of the composite materials can be further improved by the addition of suitable polymers (such as PVP or carbopol 940). The addition of required solid particles or polymers should occur at any point before the cooling phase.

Composition IV

Composition IV comprises a polymer (insulating matrix material) mixed with particles or a combination of particles of different types (filler material) and also a liquid additive which may behave as a solvent or plasticizer binding the composite material together (heating may be required), which at certain ratios of materials gives rise to a desired complex permittivity inversely proportional to the square of the frequency in a given range, or close to it. The complex permittivity of these composite materials can be tuned by varying the ratios of starting materials. This patent concerns the development of composite dielectric materials with desired electromagnetic properties (such as permittivity and conductivity) for specific RF/microwave and energy related applications.

The invention describes a novel theory and method for the formulation of configurable material compositions with precise electromagnetic properties. Complete control over the broadband permittivity spectrum of a material is achieved through the preparation of a starting liquid with the required dielectric relaxation (gradient), the optional “hardening” of the starting liquid with low wt. % additives (physicochemical and/or mechanical material property alteration) and then customization of the polarity by the addition of immobilised “dielectrically active” particles of predetermined chemical composition and/or size (dielectric constant tuning). The materials also maintain extremely low dielectric loss in terms of electromagnetic energy dissipation.

Dielectric materials are widely used in electrical and electronic systems. Printed circuit boards (PCBs) and capacitors are just two good examples where a dielectric material of low loss is employed to separate two conductors. In RF/microwave systems, dielectric materials are utilized for devices such as dielectric resonant antennas (DRAs), waveguides and resonators. The most important electromagnetic properties of the material are permittivity, conductivity and permeability in these applications. Since the permeability for most materials is about the same as free space (air), thus the focus is on the permittivity and conductivity which can be characterised using the complex permittivity.

In general, permittivity (also called dielectric constant) is not a constant as it can vary with the frequency of the field applied, humidity, temperature, and other parameters. There have been a lot of studies on permittivity and several approximation models for the permittivity have been developed. The most well-known is the Cole-Cole model which is often used to describe the dielectric relaxation in polymers. The complex permittivity of a polymer can be expressed as:

$$ε ( ω ) = {ε}_{∞} + \frac{{ε}_{s} + {ε}_{∞}}{1 + {( j ωτ )}^{1 - α}}$$

where ε_{∞} and εₛ are the “infinite frequency” and “static/zero frequency” permittivity respectively, ω is the angular frequency and τ is a time constant—depending on various factors. The exponent parameter α takes a value between 0 and 1. When α=0, Cole-Cole model reduces to Debye model. Other models, such as Lorenz and Drude models, are employed for other types of materials. Due to the complexity of the permittivity, there is no accurate general permittivity model available for all materials. In the RF/microwave frequency band, the permittivity of most materials generally decreases with increasing frequency (relaxation).

The permittivity of composite dielectric materials has been studied for applications such as energy storage, various techniques and additive materials (including metal particles) have been investigated. The main focus of these studies seems to be on how to make the material of certain desired features (such as high permittivity, low loss, or good isolation), not on how to control the relaxation response of the material over a certain frequency band. The inventors have identified that the permittivity of some specially designed composite dielectric materials can be made approximately inversely proportional to the frequency square over quite a large frequency band, thus the wavelength inside the material becomes a constant, as shown in FIG. 1A, where the measured permittivity along with the wavelengths in free space and the material are given as a function of frequency. The composite material is made of a host medium (i.e. the matrix), inclusion particles (i.e. the particles) and a gel (optional), as described below. This is a very interesting and important result—since it means that the wavelength in the material λ becomes a constant as can be seen from the wavelength equation below:

$$λ = \frac{{λ}_{0}}{\sqrt{{ε}_{r}}} = \frac{c}{f \sqrt{{ε}_{r}}} = \frac{c}{f \sqrt{constant / {f}^{2}}} = \frac{c}{cons t a n t}$$

where εᵣ is the relative permittivity of the composite material, λ₀, f and c are respectively the wavelength, frequency and the speed of wave/light in free space, c=3×10⁸ m/s. The constant is determined by the material.

The significance of this is that devices fabricated using our new composite materials would operate at all frequencies (high and low) in the band while their size could be made smaller than a device without the material, one size is suitable for all which would also lead to greatly reduced manufacturing costs. For example, five traditional standard waveguide horn antennas of different sizes may be replaced by just one waveguide horn filled with the new composite material. It is apparent that the antennas and electronic devices fabricated using the new configurable composite materials offer ultra-wideband capability, miniaturisation, and low cost. They are most suitable for software defined radio, communications, radar and other applications (such as energy storage).

An embodiment of the presented invention includes a material whose permittivity is not a constant but inversely proportional to the frequency square; thus the effective wavelength in the material is a constant. The significance of the invention is that devices fabricated using our novel composite materials would operate at all frequencies (high and low), meaning single-sized devices leading to greatly reduced manufacturing costs. Further features of devices fabricated using the configurable composite materials include ultra-wideband capabilities, miniaturisation, and metal free technologies, with applications including, e.g. dielectric resonator antennas and lens antennas with uses such as software defined radio, communications and radar.

The present invention may provide access to customised dielectric materials for specific RF/microwave applications. A hybrid liquid/solid material can be formulated which possesses exact required dielectric/electromagnetic properties either for a targeted specific application, or alternatively to be formulated for a purpose which has not yet been achieved, or even considered, due to a material with the required properties not yet being available.

We can create materials with a high dielectric constant, tunable broadband permittivity and low dielectric loss, using simple, common and cost-effective non-hazardous starting materials.

These novel compositions will create an opportunity for reducing the cost, size, weight and complexity in RF/microwave devices. They may also open up new design possibilities for future devices by the creation of materials with previously unattainable properties. These materials could also be investigated for application in other highly desirable areas, including capacitor/battery applications, microelectronics and stretchable/wearable electronics among others.

The essential requirements for the desired materials (i.e. the compositions) are the permittivity of the material being inversely proportional to the frequency square and the conductivity being very small over a large frequency and temperature range. The frequency range of interest is from 80 MHz to 30 GHz (i.e. from FM to mmWave) to cover most of the widely used frequencies. It is not possible for a single material to work through the whole frequency range but we expect each composite material will work from f₀ to about 10f₀ (f₀ is the start frequency, such as 80 MHz): the wider the frequency range, the larger the permittivity range. In practice, it is likely that at least 3 different composite materials will be required to realistically cover the whole spectrum of interest. The desired temperature range is −40° C. to 70° C. which should be achievable from the initial results and knowledge we have obtained.

We have compiled a library of dielectric liquid materials and this has provided insight into the chemical nature of different complex permittivities. For example, we have determined the chemical moieties which relate to extremely large dielectric constants with sharp relaxation spectra (FIG. 2B). It is the latter class of molecules (extreme dielectric constants with very sharp relaxation as the frequency increases) that are of primary focus when producing compositions that possess complex permittivities that are not constant but inversely proportional to the frequency square.

In particular, the inventors have identified a link between the extent of inter- and intra-molecular interactions (imposed by hydrogen bonding) and its effect on the dielectric relaxation of the material. This can be seen in FIG. 2A. Although structurally similar, the frequency dependence of the dielectric constant shown by acetone and propan-2-ol is vastly different. The inventors have observed a similar effect between N-methylformamide (NMF) and dimethylformamide (DMF). It thus appears that it is the enhanced hydrogen bonding ability of the molecules that renders its dielectric relaxation much faster with increased frequency. FIG. 2B further shows that amides capable of hydrogen bonding display fast relaxation with frequency. Furthermore, the inventors have shown that introducing solid particles of defined particles size, morphology and/or composition and optionally gelator molecules can increase the complex permittivity of a liquid without affecting significantly the permittivity/frequency gradient (FIG. 1B).

Materials Selection Criteria

All materials are selected on the basis of the criteria below. Their compatibility with each other in final composites is also taken into consideration. Generally, the composites comprise one or more liquids and optionally, one or more solids.

Particles

Properties to consider when selecting particles or mixtures of particles (filler material) include high permittivity, low loss, sharp dielectric relaxation as the frequency increases, chemically stable, high density, homogeneous distribution within the matrix, ability to have their surface chemically modified, evenly distributed particles sizes and morphology, low cost, low toxicity, ease of preparation and stability to temperature, moisture and oxygen. In relation to mixtures of particles being used as filler, the ability to alter ratios of particles, which would allow tuning of the complex permittivity, is preferred.

Liquids

Liquid selection for composite materials is based on various roles they may play, including controlling the complex permittivity, tuning the dielectric relaxation, modification of particle surfaces, increasing homogeneity and distribution of particles within composites, processing polymers, altering the physical state or viscosity of materials, and acting as solvent. When in combination with gelators, the liquid may act as the matrix material. The liquid should have chemical stability, stability to temperature and air, and low toxicity, and be ease of synthesis, low cost and able to contribute to lowering the loss tangent.

Polymers & Gelators

Properties to consider for selecting polymers (insulating matrix) include low loss, stability to temperature thermophysically, electromagnetically and chemically, ease of processing, low cost, low toxicity, ability to be tuned dielectrically, ideally already showing some dielectric relaxation as the frequency increases, and their ability to contain various amounts of filler particles whilst retaining good thermophysical properties. Gelators which successfully gelate and are compatible with desired liquid materials will be selected, and those are preferred which gelate the liquid materials with minimal amount while producing composites with the highest tolerance to temperature (i.e. gel melting temperature). Desirably, the gelators should be of low toxicity.

Amides

In one example, the composition comprises an amide, for example having a functional group R₁—NH—CO—R₂ and/or having an isobutyramide functional group R₁—NH—CO—CH(CH₃)₂.

Examples include N-methyllauramide, N-methyloctanamide, N-Methylpivaloylamide, N-(tert-butyl)pivalamide, N-methylisobutyramide, N-isopropylisobutyramide, N-methylbutyramide, N-Ethylbutyramide, N-n-Propylbutyramide, N-methylpropionamide, N-Ethylpropionamide, N-propylpropionamide, N-butylpropionamide, N-methylacetamide, dimethylacetamide, N-methyl-N-vinylacetamide, formamide, N-methylformamide, N,N-dimethylformamide, N-ethylacetamide, N-propylacetamide, N-butylacetamide, N-pentylacetamide, N-hexylacetamide, N-heptylacetamide, N-octylacetamide, N-ethylformamide, N-isopropylacetamide, N-(cyanomethyl)formamide, N-(2-hydroxyethyl)formamide, N-propylformamide, N-cyclopropylformamide, N-butylformamide, N-tert-butylformamide, N-phenylacetamide, N-methylbenzamide, N-phenylbenzamide and N-Methylmethanesulfonamide.

Plasticizer

In one example, the composition comprises a plasticizer. Plasticizers include but are not limited to, dimethylcarbonate, diethylcarbonate, dibutyl phthlalate, tetramethylurea, triethylphosphate and trimethylphosphate.

Relative Permittivity

In one example, the relative permittivity of the composition relaxes as a function of the applied electric field.

In one example, the composition has a static relative permittivity of at least 100, preferably at least 1,000, more preferably at least 10,000 and/or has a static relative permittivity of at most 20, preferably at most 10, more preferably at most 5 at a frequency of 10 GHz.

Gelator

In one example, the composition comprises a gelator, for example <1 wt. % but generally no more than 5 wt. %, such as R—C₁₂C₁₂ and/or Z-ILeuNHC₁₈H₃₈. Gelators include but are not limited to, N,N′-((1R,2R)-cyclohexane-1,2-diyl)didodecanamide, benzyl ((2R,3R)-3-methyl-1-(octadecylamino)-1-oxopentan-2-yl)carbamate, trans-(1R,2R)-1,2-Bis(dodecylamido)cyclohexane, trans-(1S,2S)-1,2-Bis(dodecylamido)cyclohexane, trans-(1R,2R)-1,2-Bis(11-bromoundecanoylamino)cyclohexane, trans-(1S,2S)-1,2-Bis(11-bromoundecanoylamino)cyclohexane, N,N′-Bis(octadecyl)-L-Boc-glutamic Diamide, (S,S)-Dodecyl-3-[2(3-dodecyl-ureido)cyclohexyl]urea, N,N′-((1R,2R)-Cyclohexane-1,2-diyl)didodecanamide, 1,3:2,4-Bis(3,4-dimethylbenzylidine)-sorbitol. Other gelators are known.

R—C₁₂C₁₂:

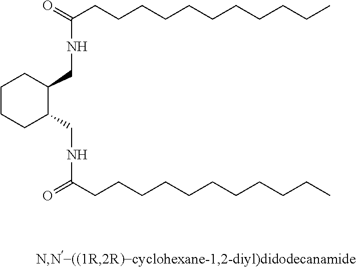 [SMILES: CCCCCCCCCCCC(=O)NC[C@@H]1CCCC[C@H]1CNC(=O)CCCCCCCCCCC]

Z-LeuNHC₁₈H₃₈:

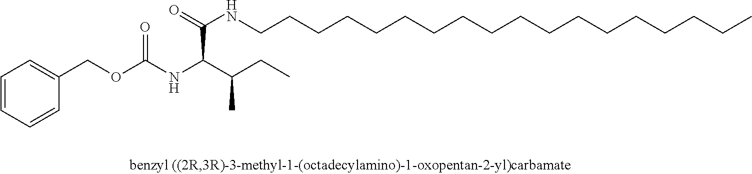 [SMILES: CCCCCCCCCCCCCCCCCCNC(=O)[C@H](NC(=O)OCc1ccccc1)[C@H](C)CC]

Polymeric Additive

In one example, the composition comprises a polymeric additive for example PVP powder, carbopol 940, PVB and polystyrenes.

Polymer

In one example, the composition comprises a polymer. Suitable polymers include, but are not limited to, fluoro-polymers (such as PVDF and its co-polymers e.g. PVDF-HFP), Carbopols, acrylics such as PMMA, polystyrenes, polyesters, epoxies, polyamides, silicones, polyvinylpyrrolidones, polyvinyl chlorides, polypropylenes, polyethylenes, polysiloxanes, polyimides, polyacrylonitriles, sulphur polymers and other synthetically functionalised polymeric materials.

Dielectric Liquid

In one example, the composition comprises a dielectric liquid (i.e. a first liquid or a second liquid).

Neutral Liquid

In one example, the composition comprises a neutral liquid (i.e. a first liquid or a second liquid), for example comprising an amide, a sulfonamide, a sulfinamide, a phosphoramide, an alcohol, a nitrile, an organohalide, a ketone, a pyridine, a pyrrolidine, a piperidine, a furan, a sulfoxide and/or an alkylene or cyclic carbonate.

Ionic Liquid

In one example, the composition includes an ionic liquid.

In one example, the ionic liquid comprises a imidazolium ionic liquid, for example C₂C₁im BF₄, C₂C₁im CH₃CO₂, C₂C₁im EtOSO₃, C₂C₁im N(CN)₂, C₂C₁im OTf, C₂C₁im NTf₂, C₂C₁im SCN, C₂C₁im DEP, C₂C₁im L-Lac, C₂C₁im FeCl₄, C₂OHC₁im OTf, C₂OHC₁im PF₆, C₃C₁im I, C₃C₁im NTf₂, C₃OC₁im PF₆, C₄C₁im BF₄, C₄C₁im SCN, C₄C₁im L-Lac, C₄C₁im MeOSO₃, C₄C₁im N(CN)₂, C₄C₁im NTf₂, C₄C₁C₁im NTf₂, C₆C₁im BF₄, C₆C₁im NTf₂, C₆C₁im PF₆, C₆C₁im I, C₈C₁im NTf₂ and/or C₈C₁im Cl.

In one example, the ionic liquid comprises a choline ionic liquid, for example [Ch] HCO₂, [Ch] L-Ala, [Ch] L-Cys, [Ch] L-His, [Ch] L-Lac, [Ch] L-Lys, [Ch] L-Phe, [Ch] L-Pro, [Ch] L-Tryp, [Ch] Cl/Urea and/or [ACh] NTf₂, preferably [Ch] L-Ala.

In one example, wherein the ionic liquid comprises a phosphonium ionic liquid and/or a sulfonium ionic liquid, for example aP₄₄₄₃ HCO₂, aP₄₄₄₃ CH₃CO₂, aP₄₄₄₃ L-Lac, aP₄₄₄₃ L-Val, P₄₄₄₁ MeOSO₃, P₆₆₆₍₁₄₎ Cl, P₆₆₆₍₁₄₎ NTf₂ and/or S₂₂₂ NTf₂.

In one example, the ionic liquid comprises an ammonium ionic liquid, for example N_{HHH2} NO3, N_{HHH(2OH)} HCO₂, N_{HHH(2OH)} CH₃CO₂, N_{HHH(2OH)} L-Lac, N_{(2OH)(2OH)(2OH)1} MeOSO₃, N_{(2OH)(2OH)(2OH)1} L-Pro, N₈₈₈₁ NTf₂, N_{122(2O1)} BF₄ and/or DIMCARB.

In one example, the ionic liquid comprises a pyrrolidinium ionic liquid, a pyridinium ionic liquid and/or a piperidinium ionic liquid, for example C₄C₁Pyrr OTf, C₄C₁Pyrr N(CN)₂, C₄C₁Pyrr FAP, C₄-3-MePyrr NTf₂, C₆py BF₄, C₆py NTf₂, C₄-3-Mepy MeOSO₃ and/or C₃C₁Pip NTf₂.

Solid

In one example, the composition comprises a solid (i.e. a first solid), for example an amide, an oxime, phenone and imidazole.

Particles

In one example, the composition comprises dispersed particles. These dispersed particles may be the same as or distinct from the first solid (i.e. a first solid or a second solid).

Particles may boost the overall permittivity (such as ceramic or metal particles, e.g. BaTiO₃ or Cu), sharpen dielectric relaxation (e.g. carbon particles) or even reduce loss (low loss inorganic solids e.g. SiO₂). Particles may also affect the thermos-physical properties of the final composites such as resistance to temperature, hardness or tensile strength.

Particles include, but are not limited to; ceramics, inorganic oxides and metal chalcogenides such as BaTiO₃ (BTO), BaₓSr₁₋ₓTiO₃ (BSTO), CaCu₃Ti₄O₁₂ (CCTO), Pb[ZrₓTi₁₋ₓ]O₃ (LZT), (Pb_{0.94}La_{0.06})(Zr_{0.57}Ti_{0.43})O₃ (PLZT), SiO₂, MoS₂, FeS, Bi₂S₃; metals such as aluminium, nickel-coated graphite or other metal coated particulates; in one example, the metal is a transition metal, Sc, Ti, V, Cr, Mn, Fe, Co, Ni, Cu or Zn. In one example, the metal is Y, Zr, Nb, Mo, Tc, Ru, Rh, Pd, Ag or Cd. In one example, the metal is Hf, Ta, W, Re, Os, Ir, Pt, or Au. The particles may comprise a plurality of such metals. In one example the particles are inorganic or other particles such as carbon or related mineral particles/geolites. The particles may comprise a combination of such materials.

In one example, the particles comprise a metal and/or a metal compound, for example a pure or unalloyed metal, an alloy thereof, an inorganic compound such as a ceramic comprising the metal, an organometallic comprising the metal and/or mixtures thereof.

It should be understood that unalloyed metals refer to metals having relatively high purities, for example at least 95 wt. %, at least 97 wt. %, at least 99 wt. %, at least 99.5 wt. %, at least 99.9 wt. %, at least 99.95 wt. %, at least 99.99 wt. %, at least 99.995 wt. % or at least 99.999 wt. % purity.

In one example, the metal is a transition metal, for example a first row, a second row or a third row transition metal. In one example, the metal is Sc, Ti, V, Cr, Mn, Fe, Co, Ni, Cu or Zn. In one example, the metal is Y, Zr, Nb, Mo, Tc, Ru, Rh, Pd, Ag or Cd. In one example, the metal is Hf, Ta, W, Re, Os, Ir, Pt, Au or Hg. In one example, the metal is a lanthanide. In one example, the metal is La, Ce, Pr, Nd, Pm, Sm, Eu, Gd, Tb, Dy, Ho, Er, Tm, Yb or Lu. In one example, the metal is an actinide. In one example, the metal is Ac, Th, Pa, U, Np, Pu, Am, Cm, Bk, Cf or Es. The particles may comprise a plurality of such metals.

Generally, the particles comprising a metal, for example a pure or unalloyed metal or an alloy thereof, may comprise any metal amenable to fusion by melting. Generally, the particles comprising a metal, for example a pure metal or an alloy, may comprise any metal from particles, for example powder particles, may be produced by atomisation. These powder particles may be produced by atomisation, such as gas atomisation or water atomisation, or other processes known in the art (such as electrospinning).

The inventors have identified that a morphology, for example the shape, of the particles (or a largest dimension of an agglomerate) may affect dispersion thereof in the matrix, viscosity of the composite material, homogeneity in the composite material and/or behaviour of the composite material. In one example, the particles have a regular, such as spherical, cuboidal or rod, shapes and/or an irregular, such as spheroidal, flake or granular, shapes (also known as morphologies). The inventors have identified that a size, for example the diameter, of the particles (or a largest dimension of an agglomerate) may affect dispersion thereof in the matrix, viscosity of the composition, homogeneity in the composition and/or behaviour of the composition. Non-uniform dispersion in the composition may result in inhomogeneity in the composition, such that regions in the solidified material have relatively higher or relatively lower volumetric densities of the particles than desired, potentially resulting in agglomeration including contact between adjacent particles. Such inhomogeneity in the composition may give rise to non-ideal behaviour. Relatively small particles may adversely affect dispersion, agglomeration and/or viscosity. Relatively large particles may result in settling thereof and/or gross inhomogeneity.

In one example, at least 50% by weight of the particles have a diameter at most 200 μm, at most 100 μm, at most 50 μm, at most 25 μm, at most 15 μm, or at most 10 μm and/or wherein at least 1% by weight of the particles have a diameter of at least 10 nm, at least 100 nm, at least 1 μm, at least 2.5 μm, at least 5 μm, at least 7.5 μm, or at least 10 μm. Preferably, the particles have a mean diameter of about 10 μm.

For regular shapes, the diameter may refer to the diameter of a sphere or a rod, for example, or to the side of a cuboid. The diameter may also refer to the length of the rod. For irregular shapes, the diameter may refer to a largest dimension, for example, of the particles. Suitably, the particle size distribution is measured by use of light scattering measurement of the particles in an apparatus such as a Malvern Mastersizer 3000, arranged to measure particle sizes from 10 nm to 3500 micrometres, with the particles wet-dispersed in a suitable carrier liquid (along with a suitable dispersant compatible with the particle surface chemistry and the chemical nature of the liquid) in accordance with the equipment manufacturer's instructions and assuming that the particles are of uniform density.

In one example, at least 50% by weight of the particles have a diameter at most 100 nm, at most 75 nm, at most 50 nm, at most 25 nm, at most 15 nm, or at most 10 nm. In one example, at least 50% by weight of the particles have a diameter of at least 75 nm, at least 50 nm, at least 25 nm, at least 15 nm, or at least 10 nm. In one example, at least 90% by weight of the particles have a diameter at most 100 nm, at most 75 nm, at most 50 nm, at most 25 nm, at most 15 nm, or at most 10 nm. In one example, at least 90% by weight of the particles have a diameter of at least 75 nm, at least 50 nm, at least 25 nm, at least 15 nm or at least 10 nm. In one example, at least 95% by weight of the particles have a diameter at most 100 nm, at most 75 nm, at most 50 nm, at most 25 nm, at most 15 nm or at most 10 nm. In one example, at least 95% by weight of the particles have a diameter of at least 75 nm, at least 50 nm, at least 25 nm, at least 15 nm or at least 10 nm. In one example, at least 99% by weight of the particles have a diameter at most 100 nm, at most 75 nm, at most 50 nm, at most 25 nm, at most 15 nm or at most 10 nm. In one example, at least 99% by weight of the particles have a diameter of at least 75 nm, at least 50 nm, at least 25 nm, at least 15 nm or at least 10 nm.

Particles of these sizes may be termed nanoparticles. Generally, nanoparticles tend to agglomerate, to reduce surface energy. Agglomerates are an assembly of a variable number of the particles and the agglomerates may change in the number of particles and/or shape, for example. Nanopowders are solid powders of nanoparticles, often containing micron-sized nanoparticle agglomerates. These agglomerates can be redispersed (at least to some extent) in the solid state using, for example, ultrasonic processing. Nanoparticle dispersions are suspensions of nanoparticles in a liquid carrier, for example water or organic solvent/organic matrix. Agglomeration may depend, for example, on temperature, pressure, pH-value, and/or viscosity.

Agglomeration of the particles may result in non-uniform dispersion of the particles in the matrix and/or inhomogeneity of the composite material. Hence, a suitable particle size may be also a balance between reducing agglomeration while avoiding settling in use, all while achieving a uniform dispersion and homogeneity. Furthermore, a form of the particles (nanopowder or suspension) may affect dispersion in the matrix. The inventors have determined that particles of the described sizes, for example provided as microparticles may provide this appropriate balance.

In one example, the composition comprises from 1 to 60 wt. %, preferably from 5 to 50 wt. %, more preferably from 10 to 45 wt. %, most preferably from 15 to 40 wt. %, for example from 25 to 35 wt. % particles, for example 33 wt. %. The inventors have determined that for a broad proportion of particles in the composition, quasi-ideal behaviour may be achieved. Additionally, a uniform dispersion of the particles may be achieved.

In one example, the particles are in suspension, for example in a matrix provided by a liquid phase such as including the amide and/or the ionic liquid, as described above, optionally comprising a gelator, as described above.

Gel

In one example, the composition comprises and/or is a gel, for example a hydrogel, a nanocomposite hydrogel, an ionogel, an organogel and/or a xerogel.

In one example, the composition has a dynamic viscosity in a range from 10 to 1,000 Pa·s at 25° C. The dynamic viscosity may be measured at 25° C., for example using a Brookfield Dial Reading Viscometer model LV, RV or HA in accordance with the manufacturer's instructions.

Composition I

In one example, the composition comprises one or more liquids and optionally, one or more solids.

In one example, the composition comprises an amide, as described above. In one example, the composition comprises a dielectric liquid and/or a neutral liquid, as described above. In one example, the composition comprises an ionic liquid, as described above.

Composition II

In one example, the composition, for example according to Composition I, comprises a gelator, as described above.

Composition III

In one example, the composition, for example according to Composition I or Composition II, comprises dispersed particles, as described above.

Composition IV

In one example, the composition comprises an electrically insulating polymer, dispersed particles and a binder/plasticizer.

In one example, the polymer is a fluoro-polymer (such as PVDF and its co-polymers e.g. PVDF-HFP), carbopols, an acrylic such as PMMA, a polystyrene, a polyester, an epoxy, a polyamide, a silicone, a polyvinylpyrrolidone, a polyvinyl chloride, a polypropylene, a polyethylene, a polysiloxane, a polyimide, a polyacrylonitrile, a sulfur polymer, a synthetically functionalised polymeric material or a mixture thereof.

In one example, the particles comprise a metal and/or a metal compound, for example a pure or unalloyed metal, an alloy thereof, an inorganic compound such as a ceramic comprising the metal, an organometallic comprising the metal and/or mixtures thereof, as described above for example with respect to Composition III.

In one example, the binder/plasticizer comprises and/or is a solvent, for example an organic solvent, an aprotic solvent and/or a polar solvent such as propylene carbonate, and/or a plasticizer such as dimethylcarbonate, diethylcarbonate, dibutyl phthlalate, tetramethylurea, triethylphosphate and trimethylphosphate, as described above.

Method

A second aspect provides a method of providing a composition having a relative permittivity, preferably a real part ε′ᵣ of a relative complex permittivity εᵣ, substantially inversely proportional to the square of a frequency of an alternating electrical field, preferably due to an electromagnetic field, for example applied thereto and/or propagating therethrough, wherein the method comprises:

including a solid phase in a liquid phase, for example which may be a single and/or a pure liquid or a mixture of liquids; and

optionally solidifying, for example using a gelator, at least in part, the liquid phase, thereby providing the composition.

The composition, the relativity permittivity, the real part ε′ᵣ of the relative complex permittivity εᵣ, the frequency, the alternating electric field and/or the electromagnetic field may be as described with respect to the first aspect.

In one example, the solid phase comprises and/or is particles, as described with respect to the first aspect.

In one example, the liquid phase comprises an amide and/or an ionic liquid, as described with respect to the first aspect.

Electronic Device

The third aspect provides an electronic device comprising a composition according to the first aspect.

In one example, the electronic device comprises and/or is an antenna, a dielectric resonant antenna, a lens antenna, a cavity resonator and/or a filter, for example designed to work over an ultra-wideband from 80 MHz to 30 GHz.

Use

The fourth aspect provides use of dispersed powders in a dielectric matrix as an antenna and relevant RF/microwave devices.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1A shows a graph of relative permittivity εᵣ as a function of frequency f of electromagnetic radiation of an ideal material; and FIG. 1B shows a graph of the experimentally-determined real part ε′ᵣ of the relative complex permittivity as a function of frequency f of electromagnetic radiation between 0 and 18 GHz for a composition according to an exemplary embodiment and for a comparative example;

FIG. 2A shows a graph of the experimentally-determined real part ε′ᵣ of the relative complex permittivity as a function of frequency f of electromagnetic radiation for acetone, propan-2-ol, NMF and DMF; and FIG. 2B shows a graph of the experimentally-determined real part ε′ᵣ of the relative complex permittivity as a function of frequency f of electromagnetic radiation for N-methylpropionamide, N-(cyanomethyl)formamide, N-(2-hydroxyethyl)formamide and formamide;

FIG. 3A shows a photograph of permittivity measurement set-up/procedure; FIG. 3B shows a comparison of the real parts of relative complex permittivities (ε′ᵣ) for dielectric reference liquids DMSO, MeOH and EtOH between the data from the NPL and this work (experimental) up to 5 GHz; FIG. 3C shows a comparison of the real part of relative complex permittivity (ε^{′}ᵣ) of H₂O at 25° C. up to 18 GHz between the literature and this work (experimental); FIG. 3D shows a graphical example of the extrapolation procedure used to determine the static dielectric constants.

FIG. 4 shows structures, names and abbreviations of ionic liquids;

FIG. 5 shows procedures and characterisation data for prepared ionic liquids;

FIG. 6 shows spectra acquired for the ionic liquids;

FIG. 7A shows nomenclature for abbreviated IL cations; and FIG. 7B shows structures and abbreviations for complex anions;

FIG. 8A shows the effect of increasing chain length on the real part of the permittivity ε′ᵣ for (a) CₙC₁im BF₄ and (b) CₙC₁im NTf₂ IL series; and FIG. 8B shows the effect of a methyl group on the complex permittivity of butyl-imidazolium NTf₂ ILs;

FIG. 9 shows complex permittivity spectra of Choline AA IL series;

FIG. 10 shows the effect of increasing H₂O concentration on the complex permittivity spectra of (a) N_{HHH(2OH)} HCO₂ and (b) N_{HHH(2OH)} CH₃CO₂;

FIG. 11A shows a method of providing a composition, according to an exemplary embodiment;

FIG. 11B shows a method of providing a composition, according to an exemplary embodiment; and FIG. 11C shows a graph of the experimentally-determined real part ε′ᵣ of the relative complex permittivity as a function of frequency f of electromagnetic radiation for the compositions of FIGS. 11A and 11B;

FIG. 12A shows a method of providing a composition, according to an exemplary embodiment;

FIG. 12B shows a method of providing a composition, according to an exemplary embodiment;

FIG. 12C shows a graph of the experimentally-determined real part ε′ᵣ of the relative complex permittivity as a function of frequency f of electromagnetic radiation for the composition of FIG. 12A; and FIG. 12D shows a graph of the experimentally-determined real part ε′ᵣ of the relative complex permittivity as a function of frequency f of electromagnetic radiation for the compositions of FIGS. 12A and 12B; and

FIG. 13A shows a method of providing a composition, according to an exemplary embodiment;

FIG. 13B shows a graph of the experimentally-determined real part ε′ᵣ of the relative complex permittivity as a function of frequency f of electromagnetic radiation for the composition of FIG. 13A.

### DETAILED DESCRIPTION OF THE DRAWINGS

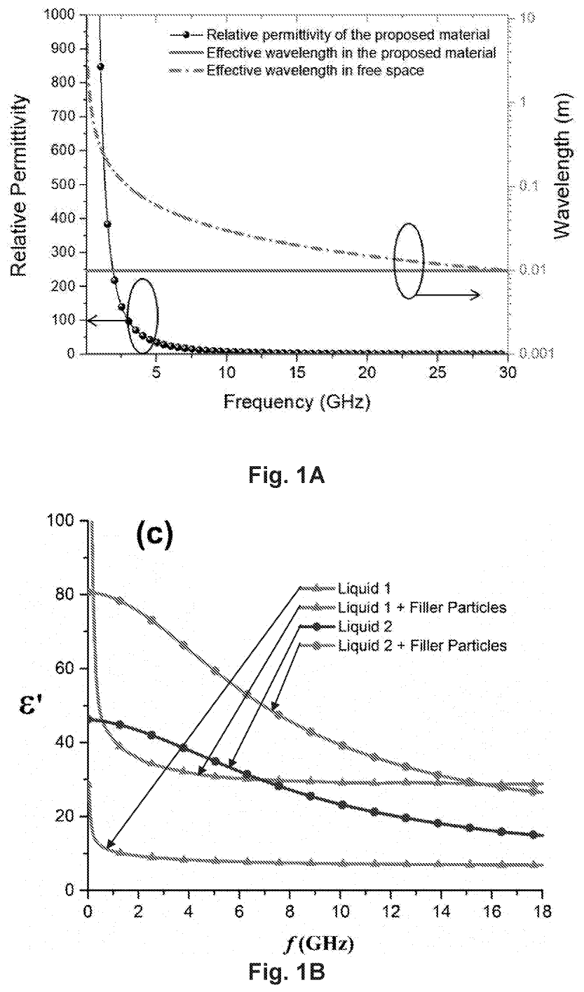

FIG. 1A shows a graph of relative permittivity εᵣ as a function of frequency f of electromagnetic radiation between 0 and 30 GHz of an ideal material, in which the relative permittivity εᵣ ∝1/f² (i.e. ideal behaviour). In this way, the effective wavelength λ of the electromagnetic radiation in the ideal material is constant as a function of the frequency f of the electromagnetic radiation between 0 and 30 GHz, as also shown in FIG. 1A. FIG. 1A also shows the effective wavelength λ of the electromagnetic radiation in free space.

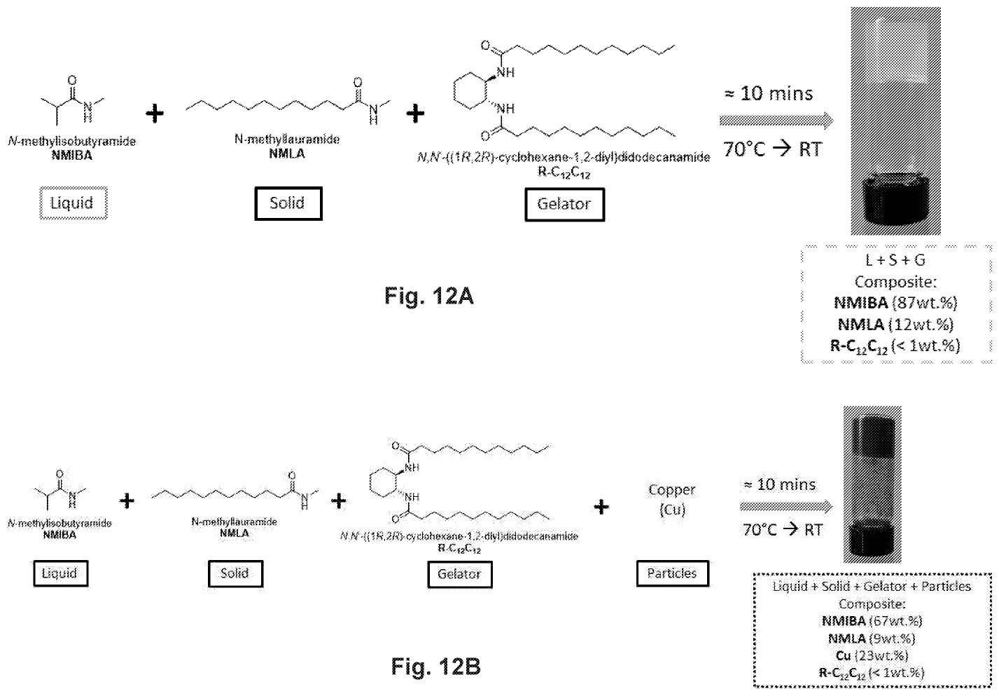

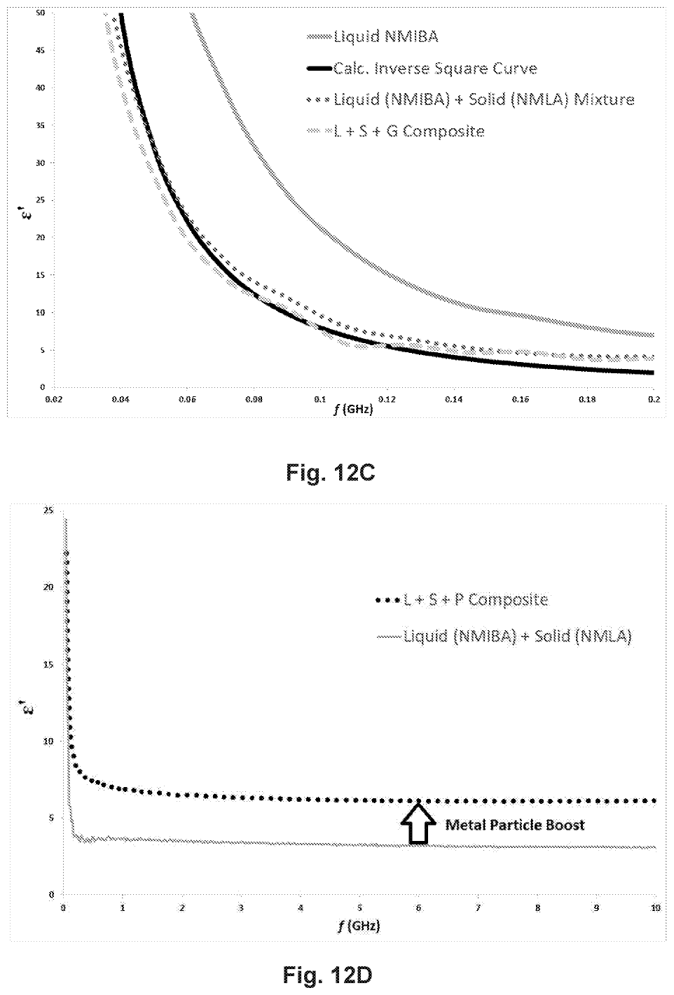

FIG. 1B shows a graph of the experimentally-determined real part ε′ᵣ of the relative complex permittivity as a function of frequency f of electromagnetic radiation between 0 and 18 GHz for a composition according to an exemplary embodiment, labelled ‘Liquid 1+Filler’ particles, and for a comparative example, labelled ‘Liquid 2+Filler’ particles. Shown also are the experimentally-determined real part ε′ᵣ of the relative complex permittivity as a function of frequency f of electromagnetic radiation between 0 and 18 GHz for ‘Liquid 1’ and for ‘Liquid 2’. In FIG. 12C, between 0.04 and 0.08 GHz, the real part ε′ᵣ of the relative complex permittivity of the composition is reduced by 4 times from about 50 to about 12.5. That is, the exemplary embodiment approaches the desired behaviour of the ideal material of FIG. 1A.

Liquid 1 is an ionic liquid (IL) Ch L-ala (cholinium L-alaninate).

Liquid 2 is DMSO (dimethylsulfoxide).

The filler particles are precipitated copper particles, having a diameter of about 10 μm.

The composition ‘Liquid 1+Filler particles’ was prepared by dispersing the copper particles therein. The viscosity of Liquid 1 is sufficiently high to suspend the copper particles therein for a period of time.

The composition ‘Liquid 2+Filler particles’ was prepared by dispersing the copper particles in a mixture of warmed Liquid 2 and a small amount (<2 wt. %) of synthesised gelator molecules. After cooling, the mixture (i.e. Liquid 2 including the gelator) gelates and immobilises the dispersed copper particles within the self-assembled gel matrix.

### Example 1—Liquid+Liquid+Gelator (L+L+G)

Generally, Composition II may comprise two organic liquids from which variation of the ratios of each liquid produces a new mixture which has a permittivity inversely proportional to the square of the frequency in a given range, or closer to it. This liquid composite may be gelated or “hardened” using organo-gelator additives or polymer additives (heating may be required).

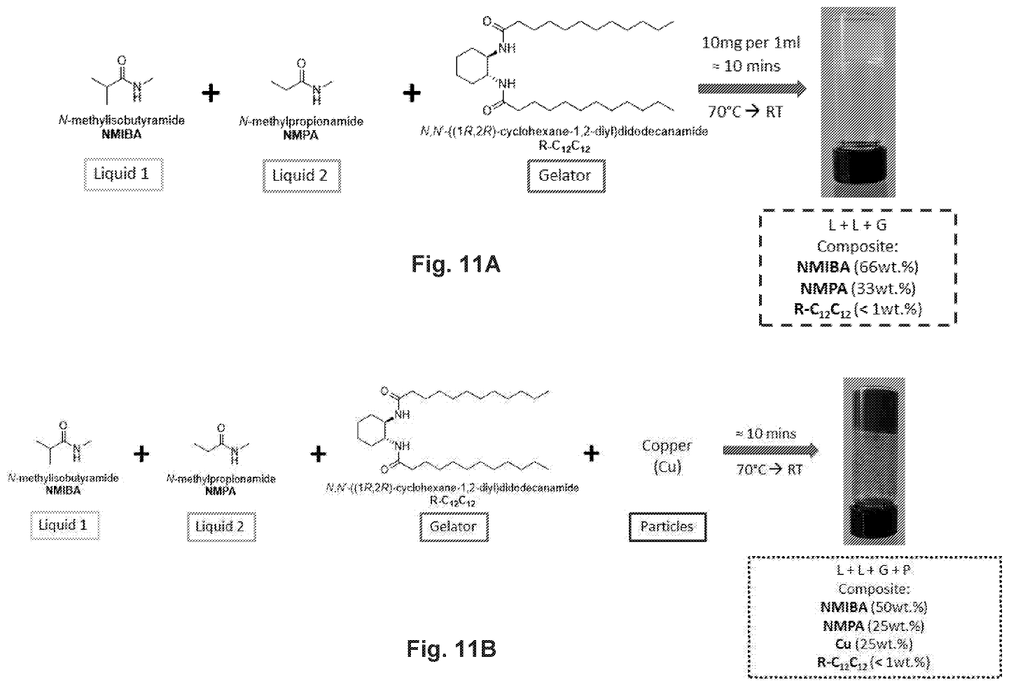

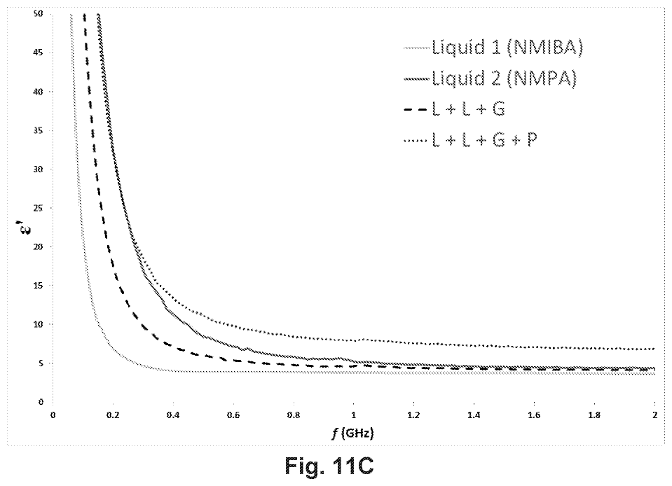

An example of L+L+G composite material is described below. Example 1 is an example of Composition II. Scheme 1 (FIG. 11A) describes the synthesis and composition, and FIG. 11C displays the complex permittivity spectra which demonstrates a new complex permittivity can be achieved by varying the ratios of liquids 1 & 2.

FIG. 11C shows a graph of the experimentally-determined real part ε′ᵣ of the relative complex permittivity as a function of frequency f of electromagnetic radiation between 0 and 2 GHz for a composition according to an exemplary embodiment, particularly showing curves for N-methylisobutyramide (labelled ‘Liquid 1’), N-methylpropionamide (labelled ‘Liquid 2’), a composition according to an exemplary embodiment comprising N-methylisobutyramide, N-methylpropionamide and a gelator (labelled ‘L+L+G’) and a composition according to an exemplary embodiment comprising N-methylisobutyramide, N-methylpropionamide, Cu particles and a gelator (labelled ‘L+L+G+P’). This Gelated Composite shows an E′-f trace different from that of either Liquid 1 or Liquid 2. Addition of certain particles (such as copper) can increase the overall dielectric constant. This can be used to tune the permittivity. See difference between dashed trace vs dotted trace (i.e. for ‘L+L+G’ vs “L+L+G+P”). Composite materials which satisfy the inverse square rule will benefit from the addition of high dielectric constant particles (such as copper), especially when approaching higher frequencies (up to 30 GHz).

The composition labelled ‘L+L+G’ was prepared, as shown in FIG. 12, by mixing N-methylisobutyramide (0.9 g, 8.90 mmol) and N-methylpropionamide (1.8 g, 20.67 mmol) to create a desired permittivity. LMWG R—C₁₂C₁₂ (as described above) (10 mg, 0.021 mmol) was added to 1 mL of the liquid mixture, which was then heated to 70° C. with stirring until all LMWG had dissolved 5-10 mins). The mixture was allowed to cool to room temperature, upon which a solid composite material was formed.

### Example 2— Liquid+Liquid+Gelator+Particles (L+L+G+P)

Generally, composition III may comprise two organic liquids from which variation of the ratios of each liquid produces a new mixture which has a permittivity inversely proportional to the square of the frequency in a given range, or closer to it. This liquid composite may be gelated or “hardened” using organo-gelator additives or polymer additives (heating may be required) which would then be able to host a variety of particles, which can also contribute to altering the overall permittivity of the composite material.

An example of L+L+G+P composite material is described below. Example 2 is an example of Composition III. Scheme 2 (FIG. 11B) describes the synthesis and composition, and FIG. 11C displays the complex permittivity spectra which demonstrates how addition of metal particles (in this example copper) can increase the overall dielectric constant Vs frequency.

The composition labelled ‘Liquid 1+Liquid 2+Cu Particles Gelated Composite’ was prepared, as shown in FIG. 12, by mixing N-methylisobutyramide (0.9 g, 8.90 mmol) and N-methylpropionamide (1.8 g, 20.67 mmol) to create a desired permittivity. LMWG R—C₁₂C₁₂ (as described above) (10 mg, 0.021 mmol) was added to 1 mL of the liquid mixture, which was then heated to 70° C. with stirring until all LMWG had dissolved 5-10 mins). Copper powder (precipitated copper particles, having a diameter of about 10 μm) (33.3 wt. %) was added to the hot mixture and stirred for 5 mins. The mixture was allowed to cool to room temperature, upon which a solid composite material was formed.

### Example 3—Liquid+Solid+Gelator (L+S+G)

Comprises an organic solid dissolved in an organic liquid from which variation of the amount of dissolved solid produces a new liquid mixture which has a permittivity inversely proportional to the square of the frequency in a given range, or closer to it. This liquid composite may be gelated or “hardened” using organo-gelator additives or polymer additives (heating may be required).

An example of L+S+G composite material is described below. Example 3 is an example of Composition II. Scheme 3 (FIG. 12A) describes the synthesis and exact composition, and FIG. 12C displays the complex permittivity spectra which demonstrates how addition of an organic solid (in this example NMLA) to a liquid (in this example NMIBA) can tune the complex permittivity close to the calculated curve, where the permittivity is inversely proportional to the square of the frequency (f) in a given range.

FIG. 12C shows a graph of the experimentally-determined real part ε′ᵣ of the relative complex permittivity as a function of frequency f of electromagnetic radiation between 0 and 0.2 GHz for a composition according to an exemplary embodiment, particularly showing curves for N— N-methylisobutyramide (labelled ‘Liquid NMIBA’), a composition according to an exemplary embodiment comprising N-methyllauramide and N-methylisobutyramide (labelled ‘Liquid (NMIBA)+Solid (NMLA) Mixture’), a composition according to an exemplary embodiment comprising N-methyllauramide, N-methylisobutyramide and a gelator (labelled ‘Liquid+Solid Gelator Composite’) and a calculated inverse square curve. The ‘Liquid (NMIBA)+Solid (NMLA) Mixture’ composition and the ‘Liquid+Solid Gelator Composite’ show quasi-ideal behaviour. Particularly, these compositions have a permittivity inversely proportional to the square of the frequency (f) in a given range.

The composition labelled ‘Liquid (NMIBA)+Solid (NMLA) Mixture’ was prepared, as shown in FIG. 12A, by mixing N-methyllauramide and N-methylisobutyramide.

The composition labelled ‘Liquid+Solid Gelator Composite’ was prepared, as shown in FIG. 12A, from the composition labelled ‘Liquid+Solid Mixture’ by adding the gelator R—C₁₂C₁₂, as shown below, mixing for about 10 minutes at 70° C. and cooling to room temperature.

Gelator R—C₁₂C₁₂:

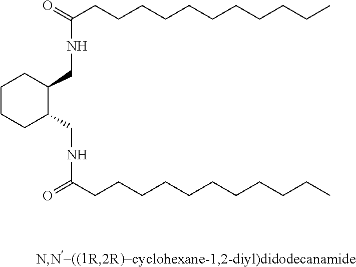 [SMILES: CCCCCCCCCCCC(=O)NC[C@@H]1CCCC[C@H]1CNC(=O)CCCCCCCCCCC]

### Example 4—Liquid+Solid+Gelator+Particles (L+S+G+P)

Generally, Composition III comprises an organic solid dissolved in an organic liquid from which variation of the amount of dissolved solid produces a new liquid mixture which has a permittivity inversely proportional to the square of the frequency in a given range, or closer to it. This liquid composite may be gelated or “hardened” using organo-gelator additives or polymer additives (heating may be required) which would then be able to host a variety of particles, which can also contribute to the overall permittivity of the composite material.

An example of L+S+G+P composite material is described below. Example 4 is an example of Composition III. Scheme 4 (FIG. 12B) describes the synthesis and exact composition, and FIG. 12D displays the complex permittivity spectra which demonstrates the permittivity boost effect from addition of metal particles (in this example copper), which can be tuned as required by varying the quantity.

FIG. 12D shows a graph of the experimentally-determined real part ε′ᵣ of the relative complex permittivity as a function of frequency f of electromagnetic radiation between 0 and 10 GHz for a composition according to the exemplary embodiment, described above, comprising N-methyllauramide and N-methylisobutyramide (labelled ‘NMIBA+NMLA’), and a composition according to an exemplary embodiment comprising N-methyllauramide and N-methylisobutyramide and additionally comprising Cu particles (labelled ‘NMIBA+NMLA+Cu’). The Cu particles enhance the experimentally-determined real part ε′ᵣ of the relative complex permittivity while showing quasi-ideal behaviour.

The composition labelled ‘NMIBA+NMLA+Cu’ was prepared, as shown in FIG. 12B.

### Example 5—Polymer+Particles+Liquid (Po+P+L)

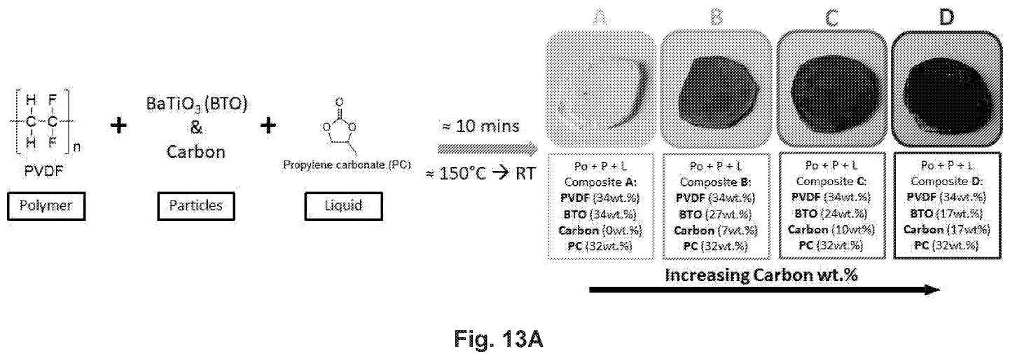

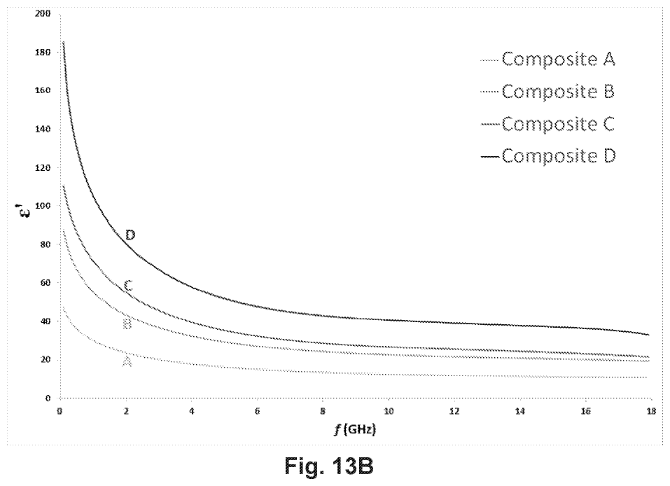

Generally, Composition IV comprises a polymer (insulating matrix material) mixed with particles or a combination of particles of different types (filler material) and also a liquid additive which may behave as a solvent or plasticizer binding the composite material together (heating may be required), all at which certain ratios of materials correspond to a desired complex permittivity inversely proportional to the square of the frequency in a given range, or close to it. The complex permittivity of these composite materials can be tuned by varying the ratios of starting materials. Examples of Po+P+L composite materials are described below. Example 5 is an example of Composition III. Scheme 5 (FIG. 13A) describes the synthesis and exact compositions, and FIG. 13B displays the complex permittivity spectra which demonstrate how increasing the wt. % of carbon filler particles can increase the overall permittivity and sharpen the relaxation.

TABLE
Composite compositions (wt. %)

| | Composite | Composite | Composite | Composite |
|---|---|---|---|---|
| | A | B | C | D |
| PVDF | 34 | 34 | 34 | 34 |
| BTO | 34 | 27 | 24 | 17 |
| Carbon | 0 | 7 | 10 | 17 |
| PC | 32 | 32 | 32 | 32 |

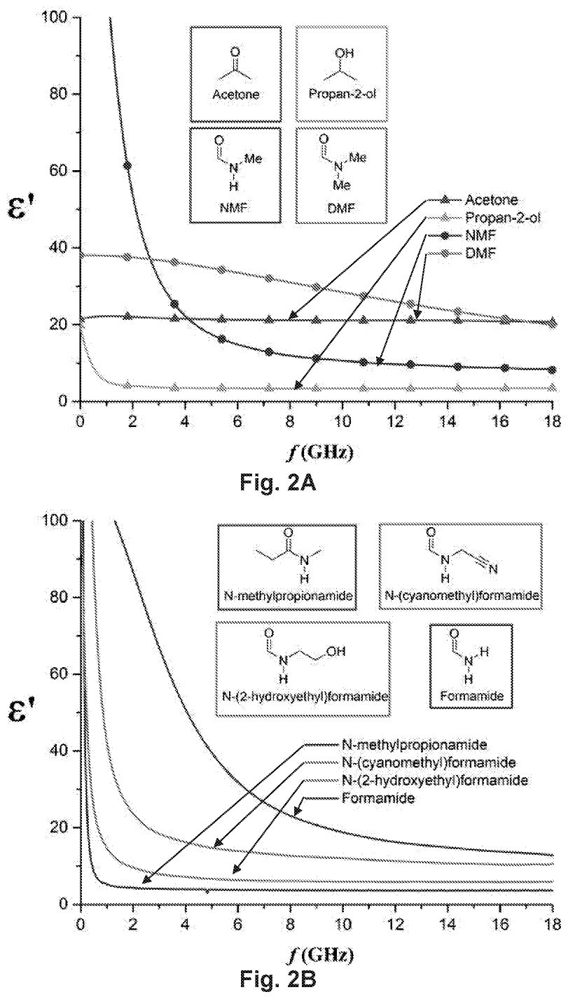

FIG. 2A shows a graph of the experimentally-determined real part ε′ᵣ of the relative complex permittivity as a function of frequency f of electromagnetic radiation between 0 and 18 GHz for acetone, propan-2-ol, NMF and DMF.

FIG. 2B shows a graph of the experimentally-determined real part ε′ᵣ of the relative complex permittivity as a function of frequency f of electromagnetic radiation between 0 and 18 GHz for N-methylpropionamide, N-(cyanomethyl)formamide, N-(2-hydroxyethyl)formamide and formamide.

N-methylpropionamide shows quasi-ideal behaviour (i.e. ε′ᵣ ∝1/f²).

Although a preferred embodiment has been shown and described, it will be appreciated by those skilled in the art that various changes and modifications might be made without departing from the scope of the invention, as defined in the appended claims and as described above.

Experimental Methods and Preparation of Ionic Liquids

### 0. Introduction

The behaviour of molecules under the influence of electromagnetic waves at frequencies >1 THz has been extensively studied in the field of physical chemistry and closely related subjects using techniques such as infra-red and UV-visible spectroscopy. However, the influence of radio and microwave frequencies on the behaviour of molecules, such as relative complex permittivity, is comparatively less researched or considered, especially in the field of chemistry. The relative complex permittivity of a material provides useful information on the dielectric relaxation and absorption processes that are prevalent in a wide frequency range. Information relating to polarity, conductivity, dielectric loss, ionic/dipolar relaxations and atomic/electronic resonances can be deduced from the complex permittivity spectrum of a given material [2]. Relative complex permittivity εᵣ can be defined as in Equation (1), where ε is the absolute permittivity and ε₀ is the vacuum permittivity (often referred to as the permittivity of free space). The value of ε₀ is fixed at 8.85×10⁻¹² F/m. The real and imaginary parts of the relative complex permittivity are experimentally measured and denoted by ε′ and ε″, respectively, and ω describes the dependence upon frequency and is called angular frequency which is ω=2πf.

$${ε}_{r} ( ω ) = \frac{ε ( ω )}{{ε}_{0}} = {ε}^{′} ( ω ) - i {ε}^{″} ( ω ) \qquad Equation ( 1 )$$

Complex permittivity is a very important material property for electromagnetics and related subjects. Data derived from relative complex permittivity measurements have been utilized in applications, such as liquid antennas, radio-frequency and microwave devices, lithium batteries, carbon nanotube (CNT) microwave absorbers and even field-deployable sensors for the detection of improvised explosives. The availability of accurate permittivity data, both static (i.e. 0 Hz, or direct current (DC)) and as a function of frequency, for ionic liquids (ILs) and other solvents, liquids and materials, will play a vital role in the development and discovery of new technologies and spectroscopic techniques.

Dielectric loss describes the inherent dissipation of electromagnetic energy by a material and can be defined by the loss tangent tan δₑ as in Equation (2). It is typically frequency-dependent and parametrized using the real and imaginary parts of the relative complex permittivity as described in Equation (1). For time-varying electromagnetic fields, the electromagnetic energy is typically viewed as waves propagating either through free space, in a transmission line, or through a waveguide. Dielectrics are often used in all of these environments to mechanically support electrical conductors and keep them at a fixed separation. In these scenarios, the electromagnetic energy is often dissipated in the form of heat.

$$tan {δ}_{e} = \frac{{ε}^{″} ( ω )}{{ε}^{′} ( ω )} \qquad Equation ( 2 )$$

The relative permittivity of a material at 0 Hz is referred to as the static relative permittivity (often called the static dielectric constant) and is normally derived by extrapolation of values measured at higher frequencies. It can also be measured through techniques such as capacitance measurements of a capacitor at DC (0 Hz). There are many literature sources that report static dielectric constants of organic molecules, solvents, binary mixtures but far fewer for ILs.

ILs are generally described as salts completely comprised of ions with melting points lower than 100° C., although the term room temperature ionic liquid (RTIL) has been more commonly used recently and invokes a much lower melting temperature. First reported over 100 years ago (ethylammonium nitrate, melting point 12° C.), ILs have received a huge increase in interest over the last two decades, with over 5000 publications in 2016 alone. ILs boast highly desirable properties, such as a wide liquid range, extremely low volatility, good conductivity, excellent electrochemical windows, tunable polarity, thermal stability and low flammability. ILs have been described as “designer solvents” and due to the anionic/cationic combinatorial nature of their preparation, ILs can be customized to almost any desired requirements. Thousands of articles utilizing ILs have been reported in the fields of energy, materials, nano-area, electrochemistry and catalysis with novel and more niche applications arising regularly. Recent articles with novel applications of ILs include battery technologies, metal-organic frameworks (MOFs), separation of rare-earth minerals and an ever increasing amount of research in the field of catalysis.

The static dielectric constants of ionic liquids have been reported with updated values found in more recent publications. There appear to be some discrepancies within the literature over the accuracy of values derived using various measurement techniques, such as microwave dielectric spectroscopy and polarity-sensitive fluorescent molecular probes. This variation has reportedly been linked to their inherent conductivity which can essentially short-circuit the system when directly measuring ε using fluorescent probes. To the best of our knowledge, there are no studies of complex permittivity (i.e. frequency dependent dielectric constants) reported for pure ILs so far, except for the original IL N_{HHH2} NO₃. This study provides data on the dielectric behaviour of ILs as a function of frequency.

Static dielectric constants are a useful indicator of polarity, often presented along with dipole moment or polarity index values. However, complex permittivity (over a broad frequency range) can provide additional information vital to many chemical and electrical engineers. Recently we have demonstrated, for the first time, that ILs can be used to fabricate dielectric resonator antennas (DRAs) with their performance inherently linked to their frequency-dependent dielectric constants and the loss factor derived from the real and imaginary parts of the permittivity spectrum (Equation 2).

Herein we report the experimentally derived complex permittivity data of 64 imidazolium, choline, phosphonium, ammonium, pyrrolidinium, pyridinium and piperidinium ILs in the range of 1 to 18 GHz and extrapolated static values at 0 Hz (measured down to 30 KHz). The information disclosed will be of value when selecting a material for engineering applications which require precise electromagnetic properties.

### 1. General Information

All synthetic reactions were carried out under an atmosphere of N₂(g) using standard techniques, all chemicals were purchased commercially and used as received without further purification (unless otherwise stated), and all solvents were of HPLC grade. ¹H, ¹³C, ³¹P and ¹⁹F NMR spectra were recorded on a Bruker 400 MHz spectrometer at 298 K using deuterated solvents as specified for each compound.

### 2. Materials

High purity samples of C₂C₁im BF₄, C₂C₁im CH₃CO₂, C₂C₁im EtOSO₃, C₂C₁im N(CN)₂, C₂C₁im OTf, C₂C₁im NTf₂, C₂C₁im SCN, C₂C₁im DEP, C₂C₁im FeCl₄, C₃C₁im I, C₃C₁im NTf₂, C₄C₁im BF₄, C₄C₁im SCN, C₄C₁im MeOSO₃, C₄C₁im N(CN)₂, C₄C₁im NTf₂, C₄C₁C₁im NTf₂, C₆C₁im NTf₂, C₆C₁im PF₆, C₆C₁im I, P₄₄₄₁ MeOSO₃, P₆₆₆₍₁₄₎ Cl, P₆₆₆₍₁₄₎ NTf₂, S₂₂₂ NTf₂, N_{HHH2} NO₃, N₈₈₈₁ NTf₂, N_{122(2O1)} BF₄, C₄C₁Pyrr OTf, C₃C₁Pip NTf₂ were purchased from loLiTec, Germany. High purity samples of C₆C₁im BF₄, C₄C₁Pyrr N(CN)₂, C₄C₁Pyrr FAP, C₄-3-MePyrr NTf₂, C₆py BF₄, C₆py NTf₂ and C₄-3-Mepy MeOSO₃ were purchased from Merck, UK. C₂OHC₁im OTf, C₂OHC₁im PF₆ and C₃OC₁im PF₆ were purchased from Solchemar, Portugal. N_{(2OH)(2OH)(2OH)1} MeOSO₃ was purchased from Fluka, UK. C₂C₁im L-Lac and C₄C₁im L-Lac were purchased from Acros Organics.

### 3. Permittivity Measurement Set-Up/Procedure

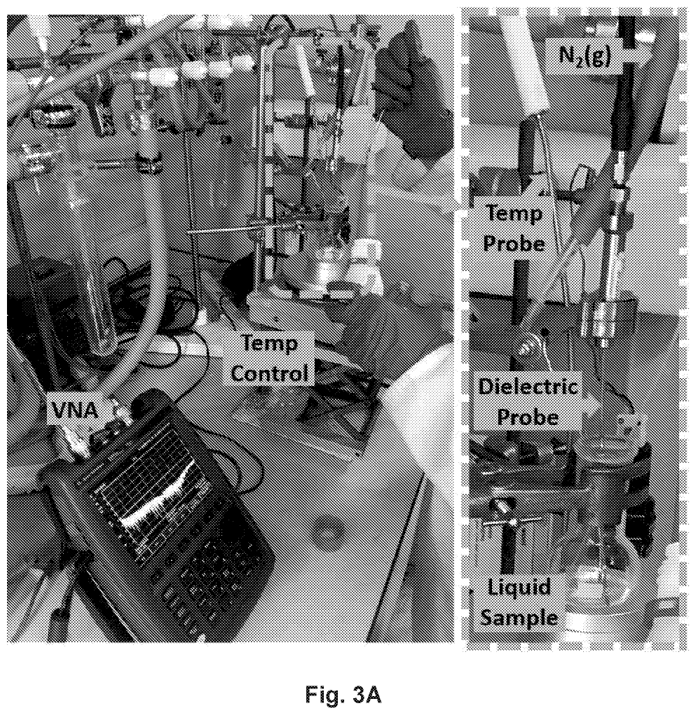

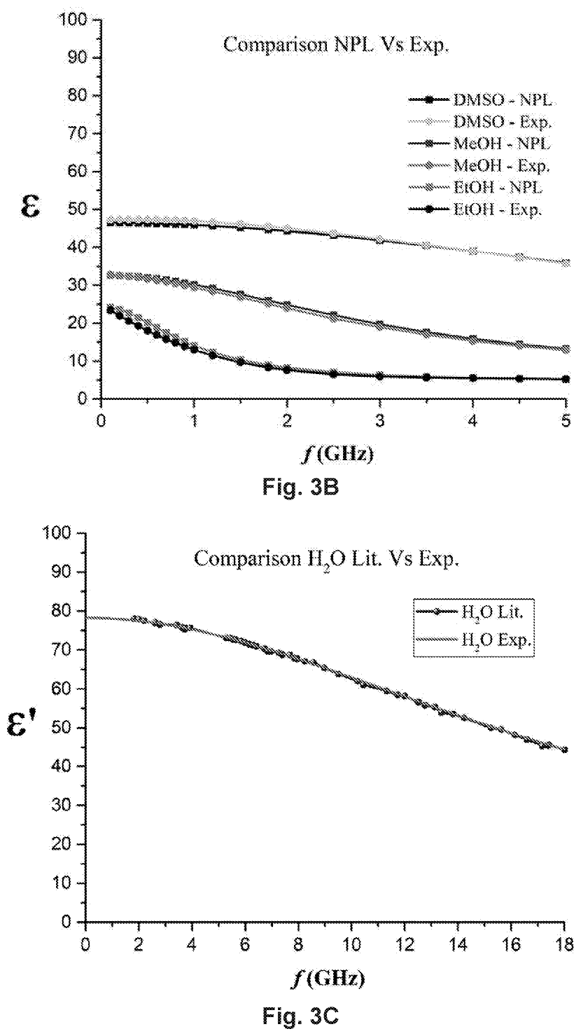

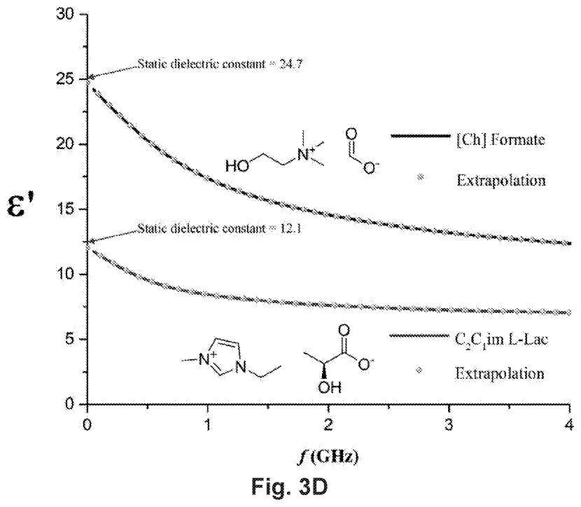

FIG. 3A shows a photograph of permittivity measurement set-up/procedure.

The composite materials are characterised and evaluated in terms of the permittivity, conductivity, thermal and mechanical stability as a function of the frequency, temperature and RF/microwave power level. Most material characterisation measurements are undertaken at room temperature. For this work, the measurement temperature is extended down to −40° C. and up to +70° C. to cover extreme conditions. The Keysight Technology high temperature probe can withstand a wide temperature range (−40° C. to +200° C.) and is used for this measurement. The measurement setup for high temperature measurements is shown in FIG. 3A where the sample under test and the probe can be tuned to the desired temperature. The temperature is maintained constant during the measurement and a digital thermal probe is used to monitor the temperature. The system is computer controlled using LabVIEW®. This measurement system is most suitable for liquid materials. For solid materials, the measurement accuracy could be an issue if an air-gap between the probe and sample is introduced during the measurement, thus an alternative measurement system to cover solid materials and a computer controlled measurement and real time data collecting system, using either LabVIEW or MATLAB®, is employed.

In more detail, there are a number of methods for permittivity measurements with their pros and cons. One of the most suitable methods for liquid material measurement is the open-end coaxial probe approach which has been used for our study. It gives a high degree of accuracy over a wide frequency range. We used an Agilent N9917A FieldFox Microwave Vector Network Analyser (VNA) and a Keysight 85070E Dielectric Probe Kit. The measurement frequency range of the instrument was set from 30 kHz to 18 GHz with 1001 data points. The radio-frequency output power level of the VNA was set to 0 dBm. A 3-point calibration method was employed which was comprised of open-circuit (in air), short-circuit (calibration block) and 25° C. distilled water measurements and as per the manufacturer's guidelines. Each unknown sample was measured using multiple probes and after repeated calibrations to confirm identical permittivity spectra were obtained. All measurements were conducted at 25° C. (unless otherwise stated) under an inert nitrogen atmosphere. The liquid samples were dried in a vacuum oven for >24 h prior to use and held using 10 mL standard lab glass vials with PTFE lined caps. The probe was immersed into the IL samples with a depth of 20-30 mm from the liquids surface. The relative complex permittivities of the compounds, including the real and imaginary parts, were measured accordingly.

To ensure reliability of results before measuring unknown liquid samples, compounds with well-defined relative complex permittivity spectra found in the literature were first measured. These reference liquids include dimethylsulfoxide (DMSO), methanol (MeOH) and ethanol (EtOH), the dielectric constants of which have been described to a high degree of accuracy by the National Physical Laboratory (NPL, U.K.) up to a frequency of 5 GHz. As shown in FIG. 3B, our experimentally measured results are in excellent agreement with the literature.

A further comparison with the literature data, recreated from the tables in the literature, can be seen in FIG. 3C, using H₂O measured at 25° C. up to 18 GHz, which is also the high frequency limit of our presented data. Again our data shows excellent agreement with the literature across the broad measured frequency range.

In order to validate the accuracy of our results, the same measurement and extrapolation procedures were employed for selected common liquid materials with static dielectric constants well defined in the literature by a myriad of sources. The static dielectric constants derived using our method were found to be in excellent agreement with the literature sources; a comparison between the experimental and literature values is shown in Table 1. The reference values presented in Table 1 are the highest and lowest published static dielectric constants available; however, it should be noted that the vast majority of the literature values generally lie somewhere between. The liquids chosen include those with negligible contributions from the imaginary part ε″ of the complex permittivity (i.e. acetonitrile) and those with considerable imaginary contributions (i.e. propylene carbonate). It should also be noted that our experimental values of these liquid materials are also in excellent agreement with those available in the literature at higher frequencies, which further confirms the validity of the measured results within this paper.

TABLE 1
Comparison of experimental static dielectric
constants derived in this study with values
found in the literature.

| | Static ε′ | Static ε′ |
|---|---|---|
| Liquid | Experimental | Literature |
| H₂O | 78.3 | 77.9-79.5 |
| DMSO | 46.2 | 45.9-48.8 |
| Acetone | 20.1 | 19.1-20.8 |
| DMF | 38.1 | 36.7-40.2 |
| Acetonitrile | 35.8 | 34.3-37.0 |
| Propylene Carbonate | 64.9 | 63.0-65.5 |

The dielectric constants presented in Table 2, Table 3, Table 4, Table 5, Table 6 (vide infra) within the frequency range of 1-18 GHz are taken directly from the experimentally measured data. The reported dielectric constants in the tables at 0 Hz (static dielectric constants) were extrapolated from the experimental data (measured down to the low frequency of 30 KHz, which is the approximate accuracy range of the Keysight 85070E Dielectric Probe Kit [39]). The polynomial curve fitting (PCF) method of MATLAB 2017 was then employed to extrapolate the values. An example of this low frequency extrapolation can be seen in FIG. 3D, where the solid line represents the experimental data and the markers indicate the extrapolated values.

Full details of the 64 commercially available and synthesized ILs used in this study are presented below, including the full structures, chemical names, abbreviated names, synthetic procedures and characterisation data. Also included are individual spectra for all ILs measured containing both real ε′ and imaginary ε″ parts of the relative complex permittivity εᵣ.

### 4. Structures, Names and Abbreviations of Ionics Liquids

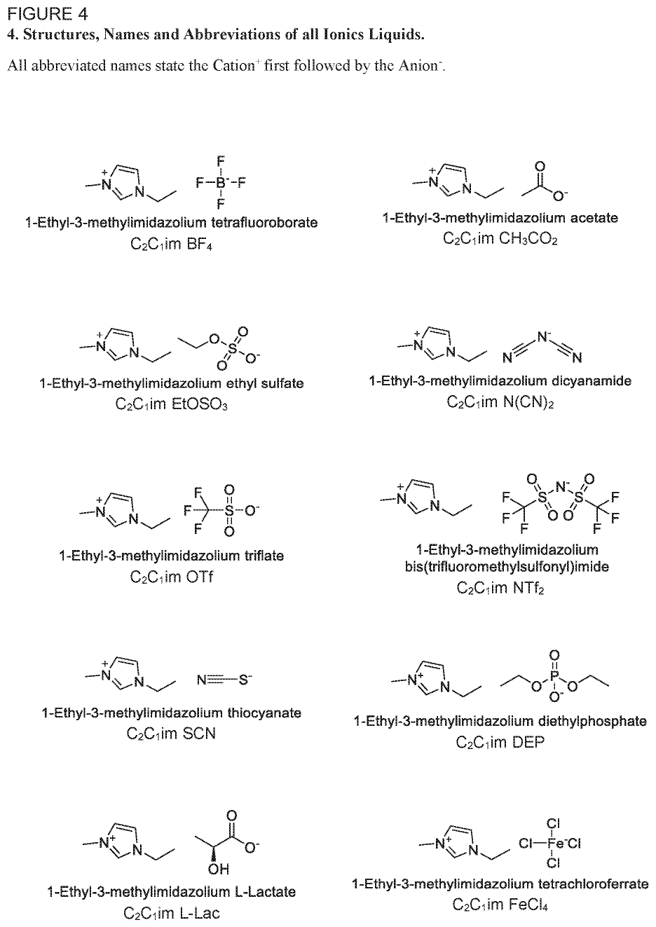

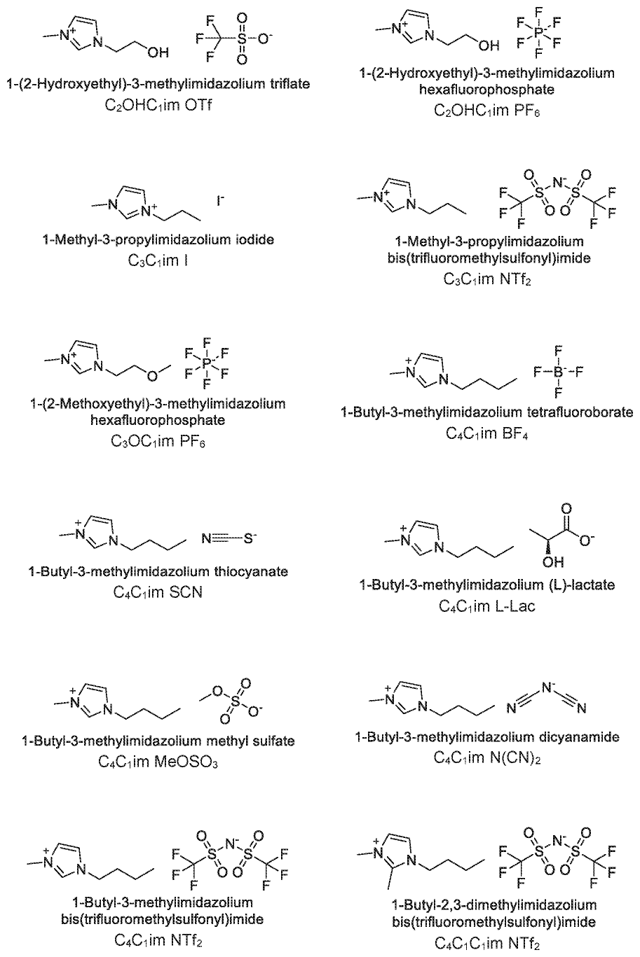

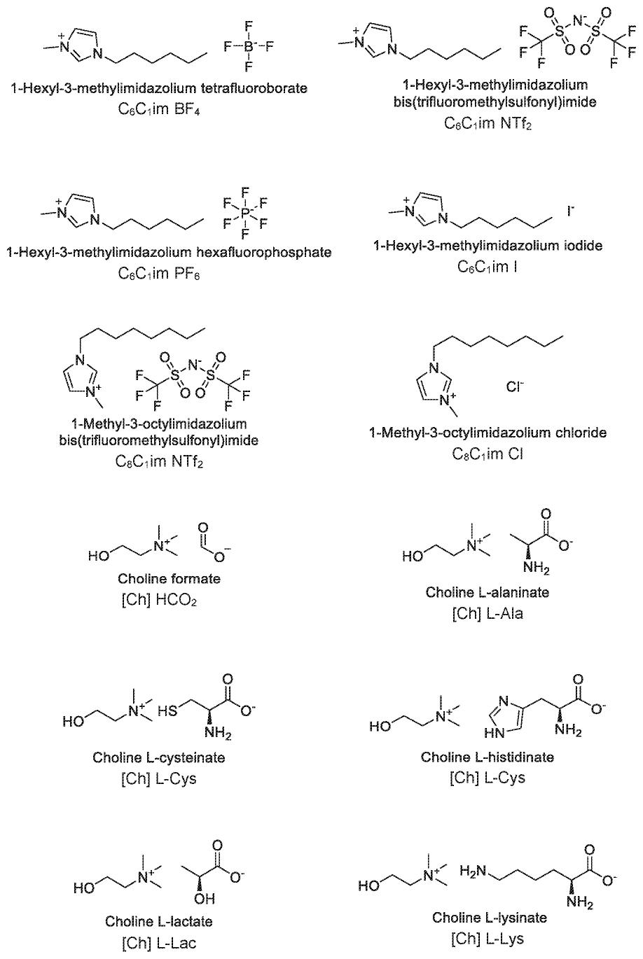

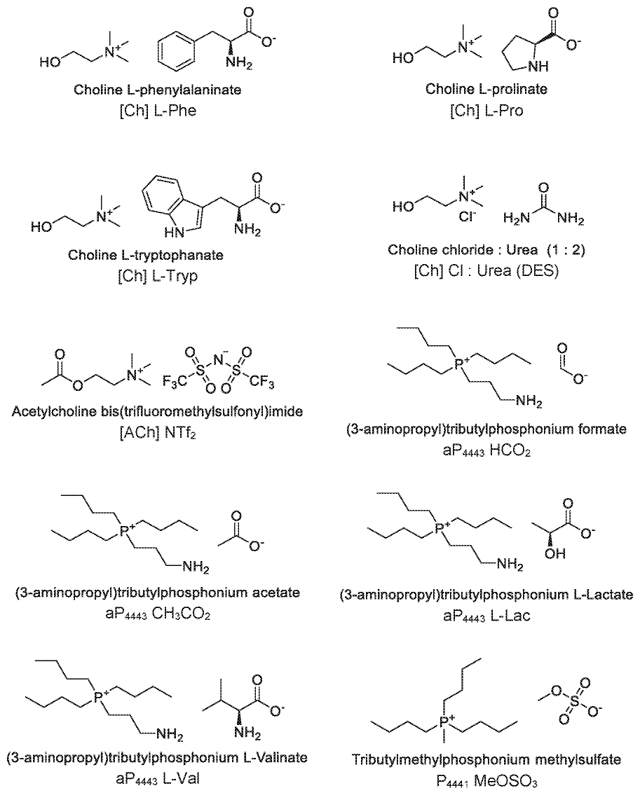

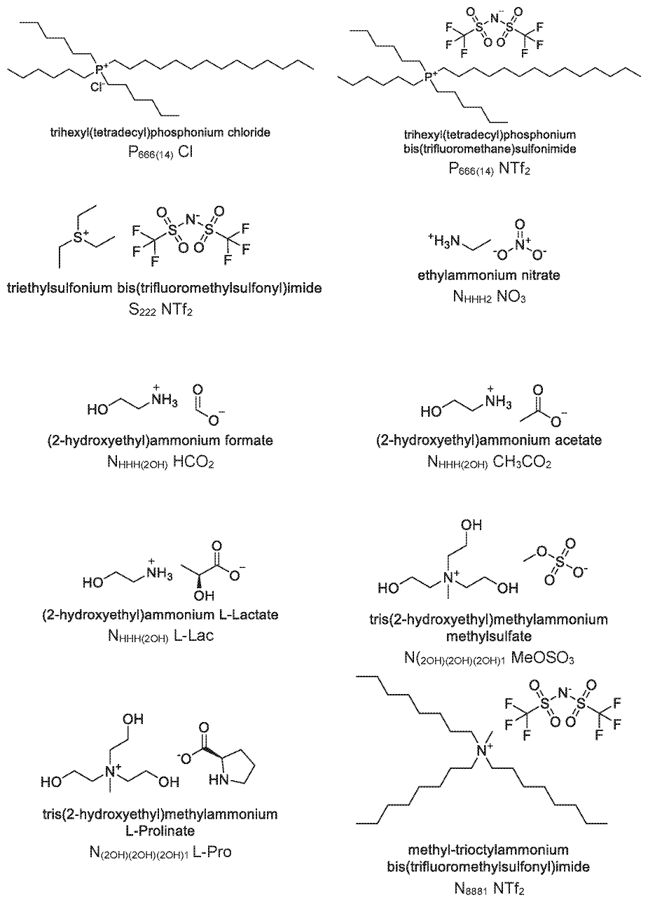

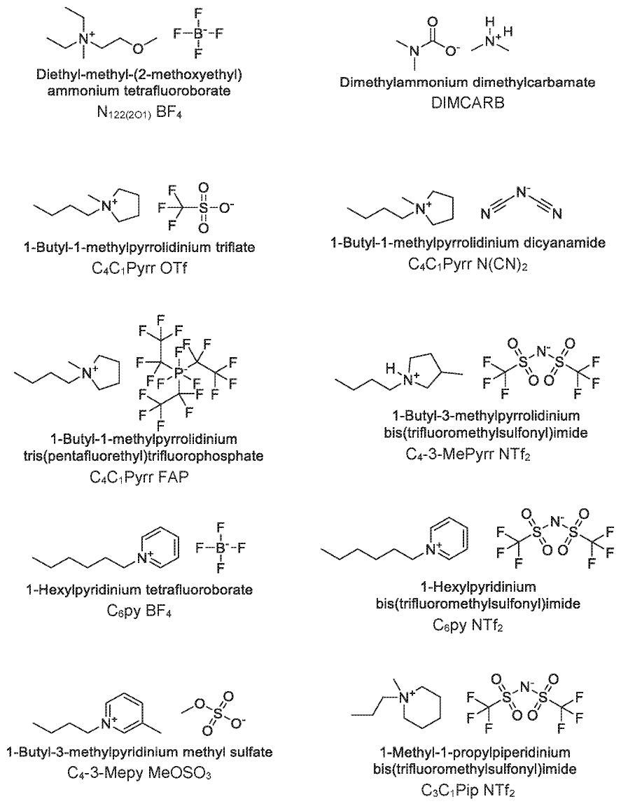

FIG. 4 shows structures, names and abbreviations of ionic liquids. All abbreviated names state the Cation+first followed by the Anion-.

### 5. Procedures and Characterisation Data for Prepared Ionic Liquids

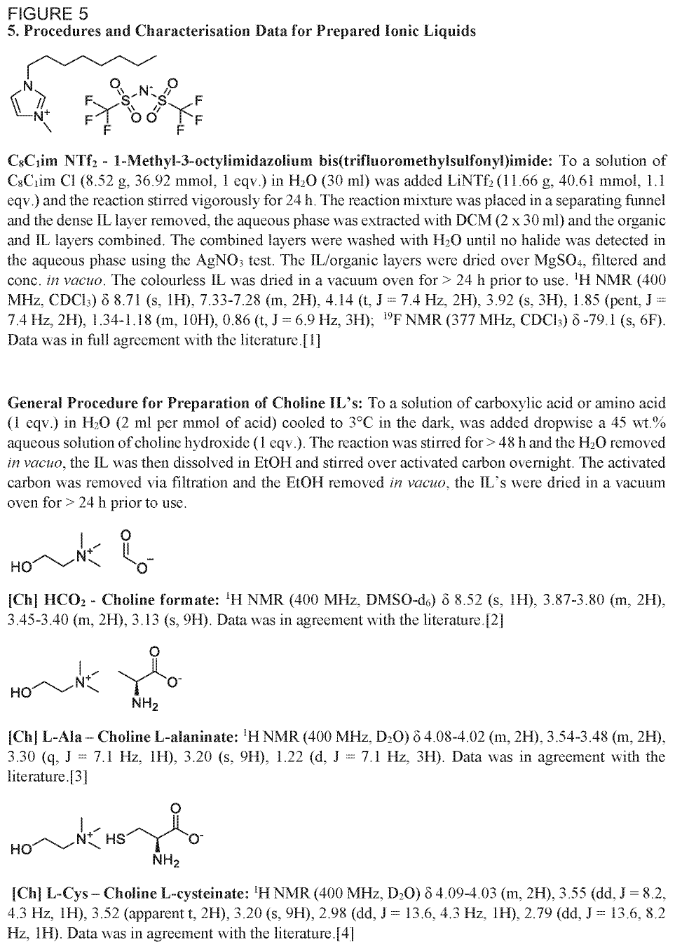

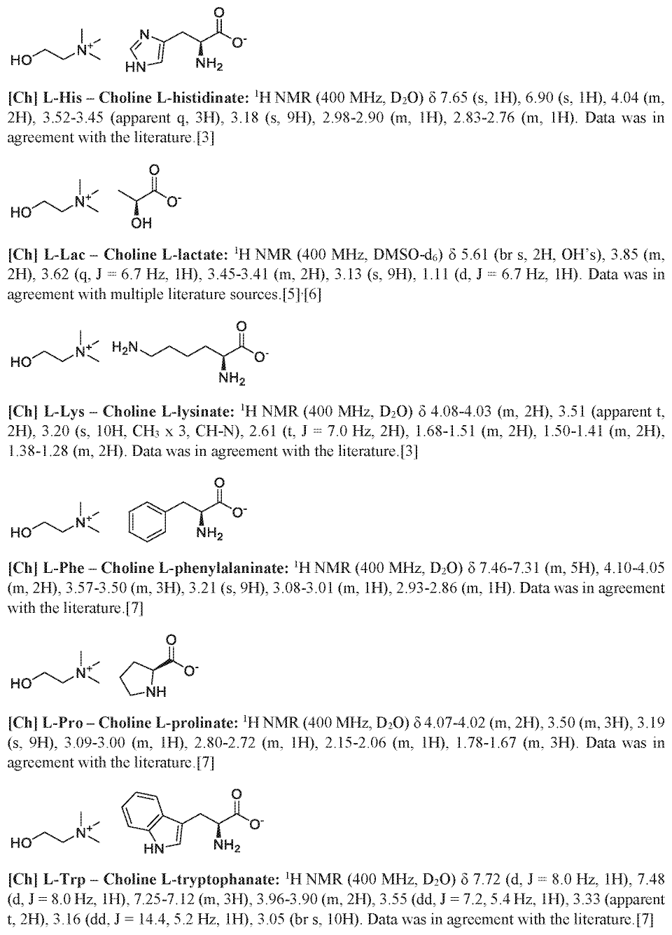

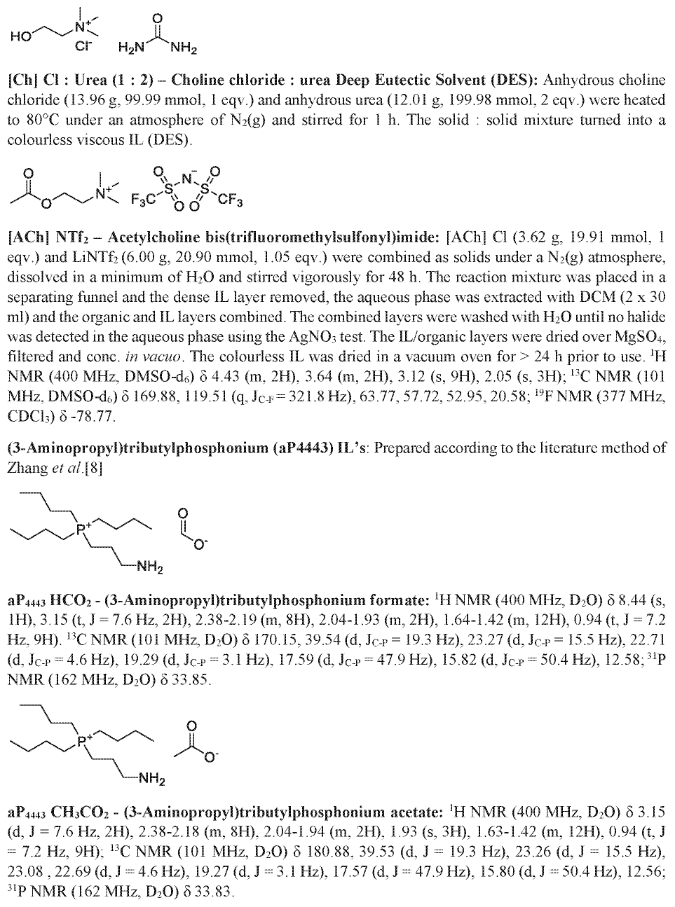

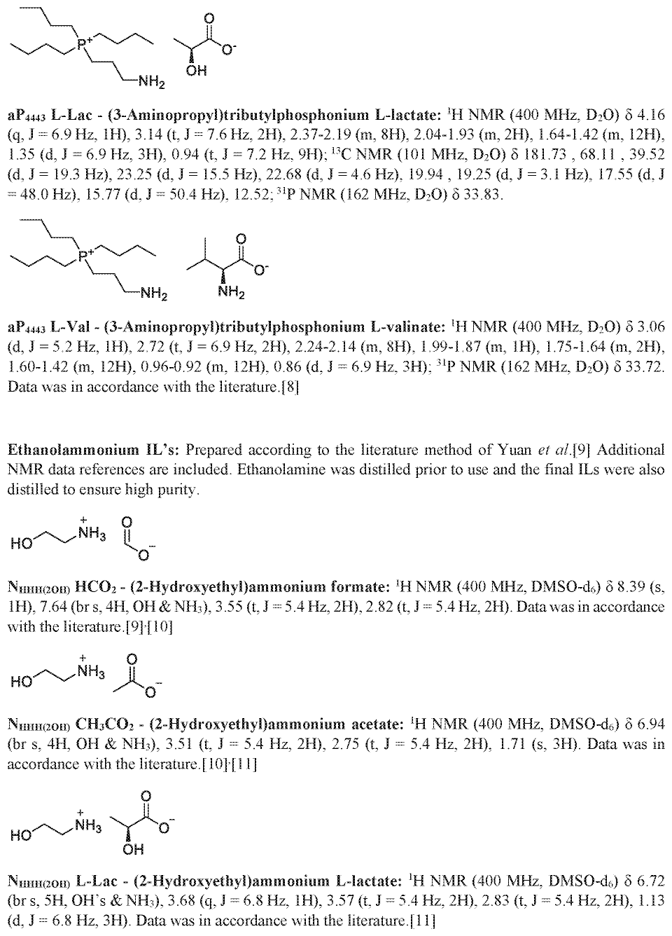

FIG. 5 shows procedures and characterisation data for prepared ionic liquids.

### 6. Relative Complex Permittivity Spectra (εᵣ)—Real (ε′) and Imaginary Parts (ε″)

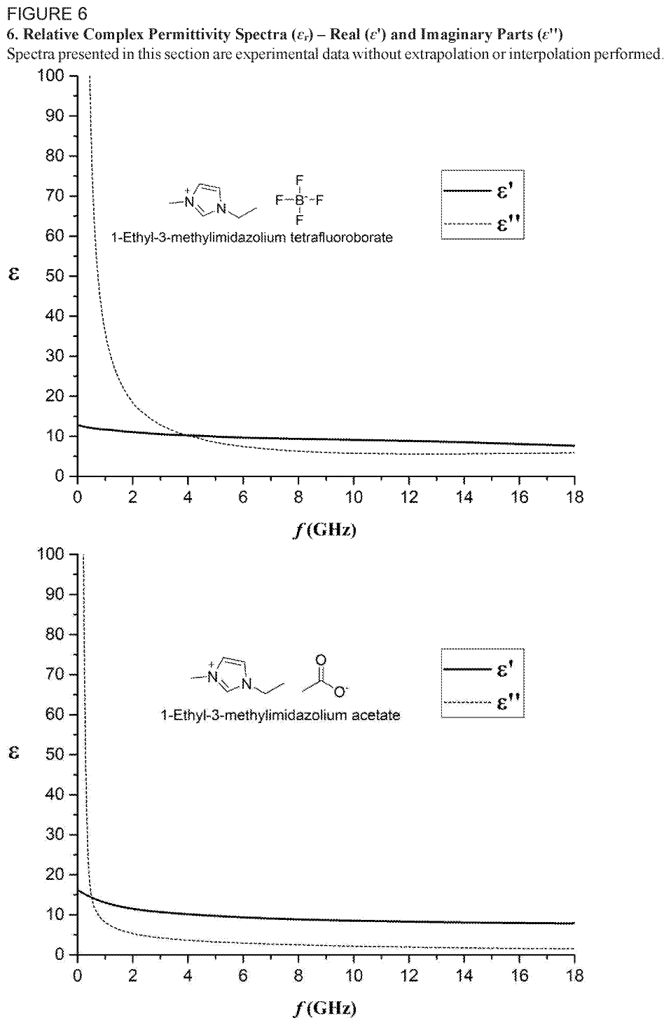

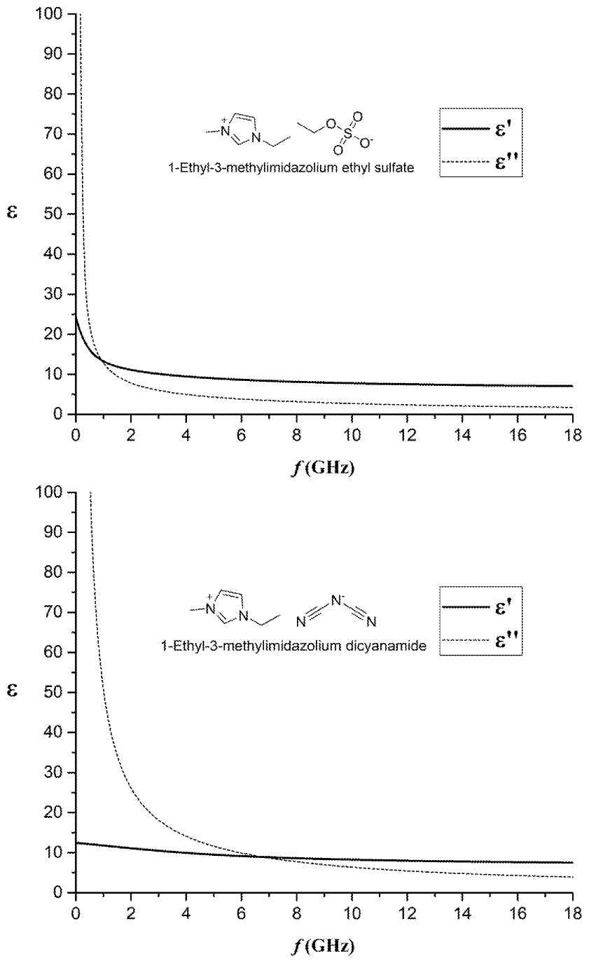

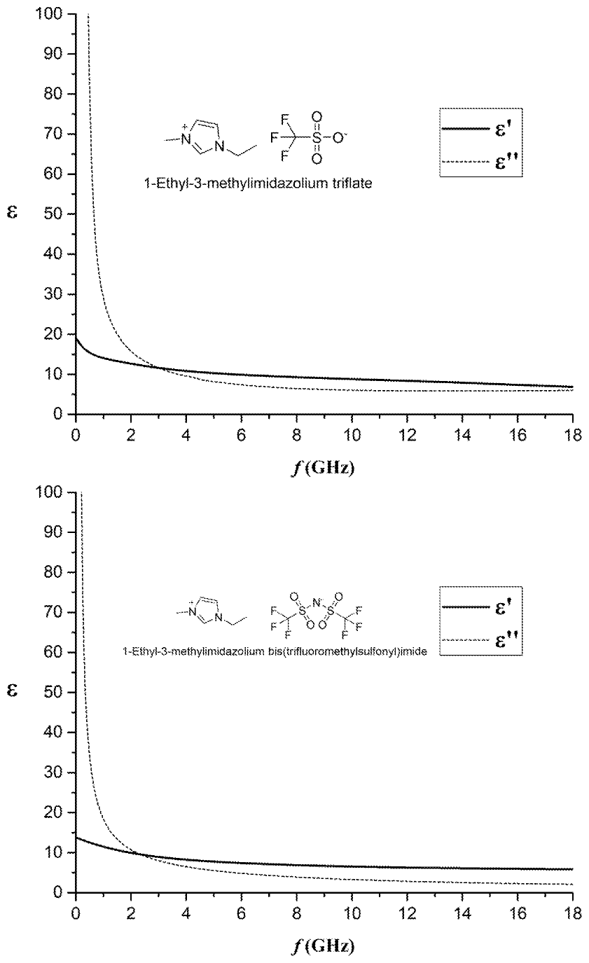

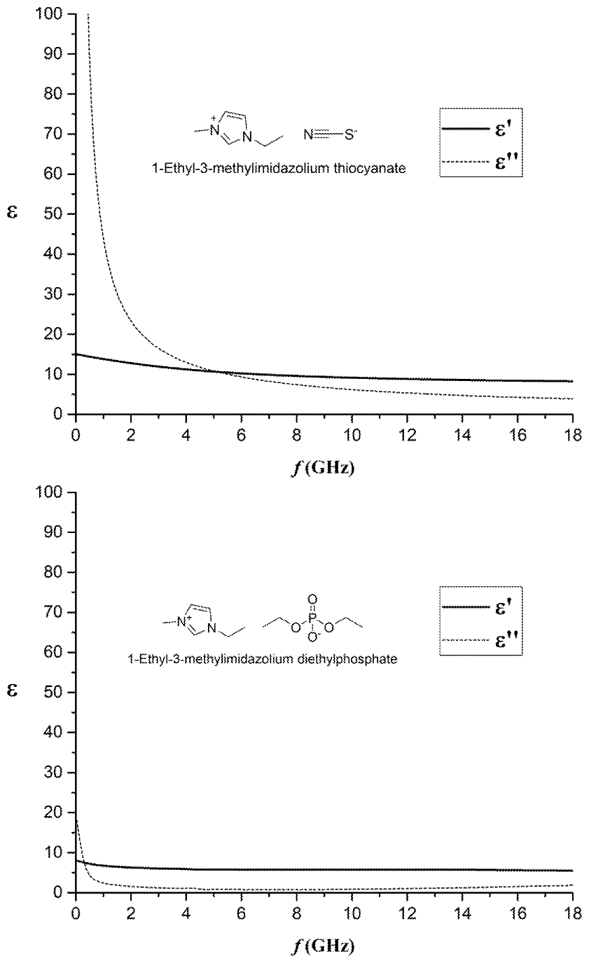

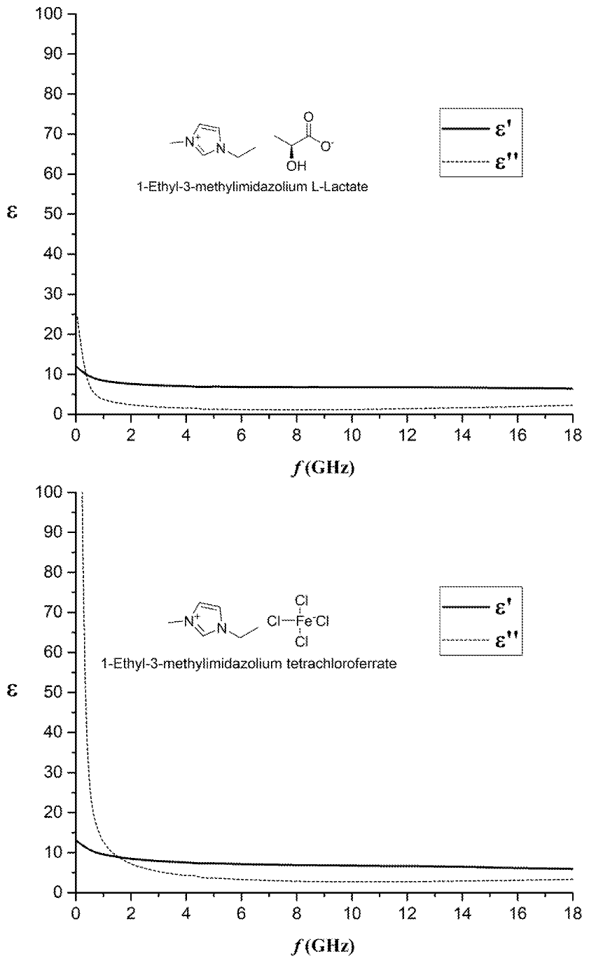

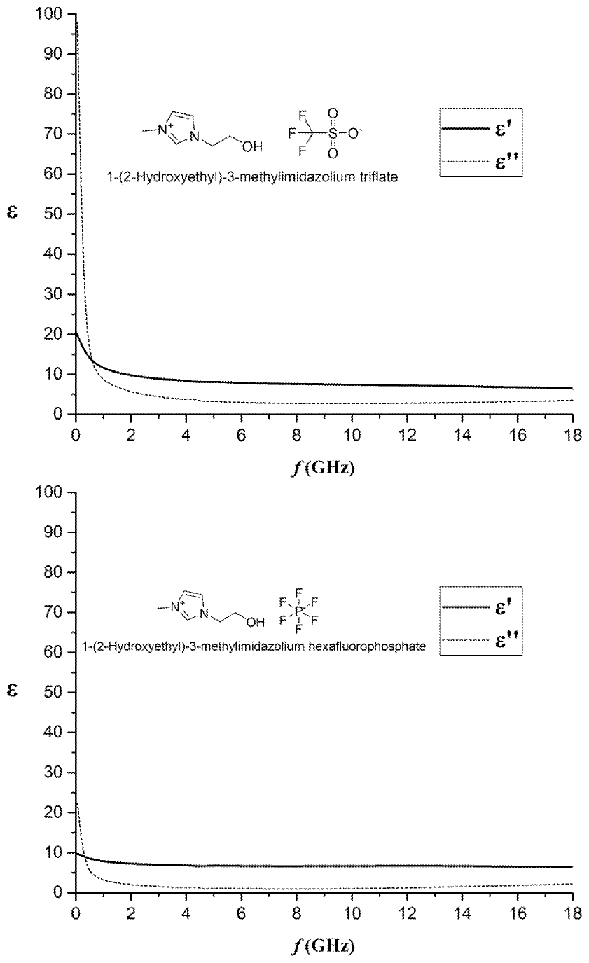

FIG. 6 shows spectra acquired for the ionic liquids. The spectra are experimental data without extrapolation or interpolation performed.

### 7. References

[1] R. Bini, C. Chiappe, V. L. Mestre, C. S. Pomelli, T. Welton, A rationalization of the solvent effect on the Diels—Alder reaction in ionic liquids using multiparameter linear solvation energy relationships, Org. Biomol. Chem. 6 (2008) 2522. doi:10.1039/b802194e.
[2] N. Oberleitner, A. K. Ressmann, K. Bica, P. Gartner, M. W. Fraaije, U. T. Bornscheuer, F. Rudroff, M. D. Mihovilovic, From waste to value-direct utilization of limonene from orange peel in a biocatalytic cascade reaction towards chiral carvolactone, Green Chem. 19 (2017) 367-371. doi:10.1039/c6gc01138a.
[3] Q.-P. Liu, X.-D. Hou, N. Li, M.-H. Zong, Ionic liquids from renewable biomaterials: synthesis, characterization and application in the pretreatment of biomass, Green Chem. 14 (2012) 304-307. doi:10.1039/C2GC16128A.
[4] S. De Santis, G. Masci, F. Casciotta, R. Caminiti, E. Scarpellini, M. Campetella, L. Gontrani, Cholinium-amino acid based ionic liquids: a new method of synthesis and physico-chemical characterization, Phys. Chem. Chem. Phys. 17 (2015) 20687-20698. doi:10.1039/C5CP01612F.
[5] A. Xu, X. Guo, Y. Zhang, Z. Li, J. Wang, Efficient and sustainable solvents for lignin dissolution: Aqueous choline carboxylate solutions, Green Chem. 19 (2017) 4067-4073. doi:10.1039/c7gc01886j.
[6] Z. Li, X. Liu, Y. Pei, J. Wang, M. He, Design of environmentally friendly ionic liquid aqueous two-phase systems for the efficient and high activity extraction of proteins, Green Chem. 14 (2012) 2941. doi:10.1039/c2gc35890e.
[7] Q.-P. Liu, X.-D. Hou, N. Li, M.-H. Zong, SUPP MAT—Ionic liquids from renewable biomaterials: synthesis, characterization and application in the pretreatment of biomass, Green Chem. 14 (2012) 304. doi:10.1039/c2gc16128a.
[8] Y. Zhang, S. Zhang, X. Lu, Q. Zhou, W. Fan, X. Zhang, Dual Amino-Functionalised Phosphonium Ionic Liquids for CO 2 Capture, Chem.—A Eur. J. 15 (2009) 3003-3011. doi:10.1002/chem.200801184.
[9] X. L. Yuan, S. J. Zhang, X. M. Lu, Hydroxyl Ammonium Ionic Liquids: Synthesis, Properties, and Solubility of SO2, J. Chem. Eng. Data. 52 (2007) 596-599. doi:10.1021/je060479w.
[10] N. Iranpoor, H. Firouzabadi, Y. Ahmadi, Carboxylate-based, room-temperature ionic liquids as efficient media for palladium-catalyzed homocoupling and sonogashira-hagihara reactions of aryl halides, European J. Org. Chem. (2012) 305-311. doi:10.1002/ejoc.201100701.
[11] J. Sun, N. V. S. N. M. Konda, R. Parthasarathi, T. Dutta, M. Valiev, F. Xu, B. A. Simmons, S. Singh, One-pot integrated biofuel production using low-cost biocompatible protic ionic liquids, Green Chem. 19 (2017) 3152-3163. doi:10.1039/C₇GC01179B.

### 8. Results and Discussion

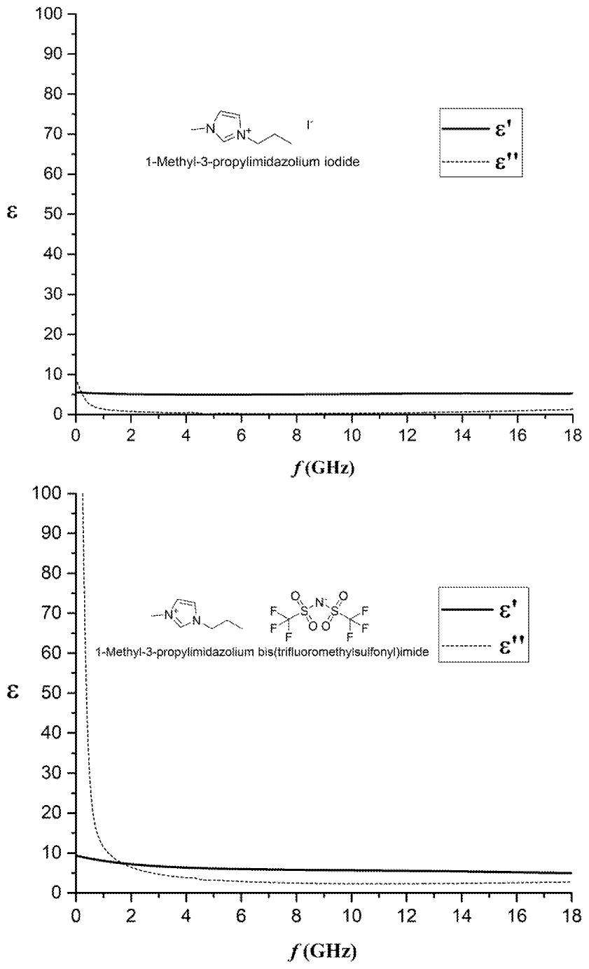

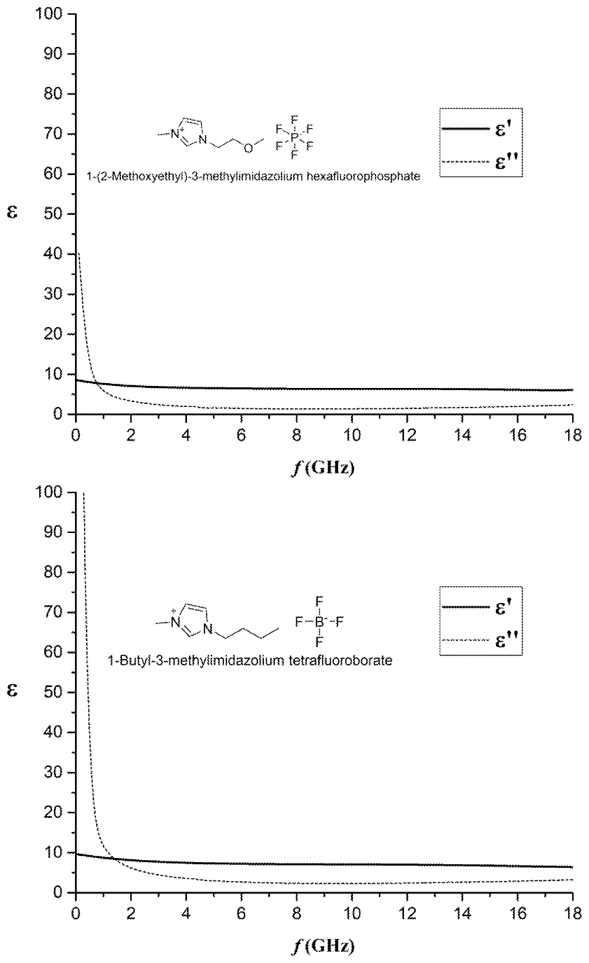

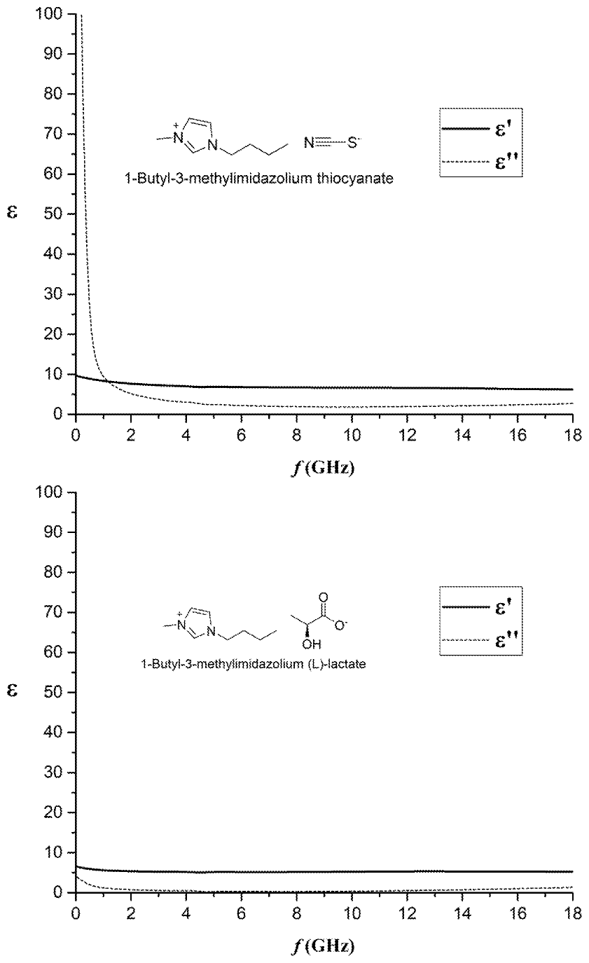

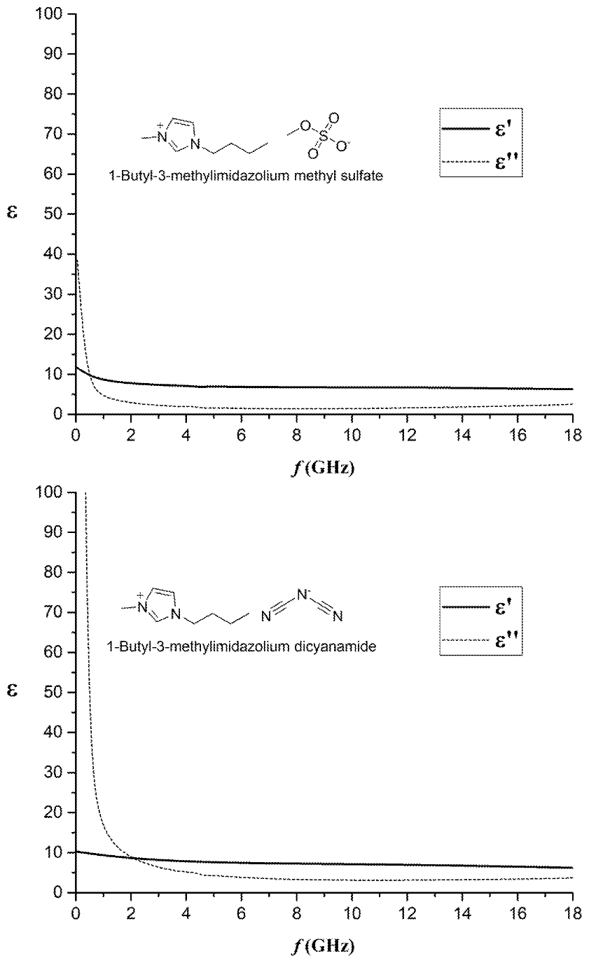

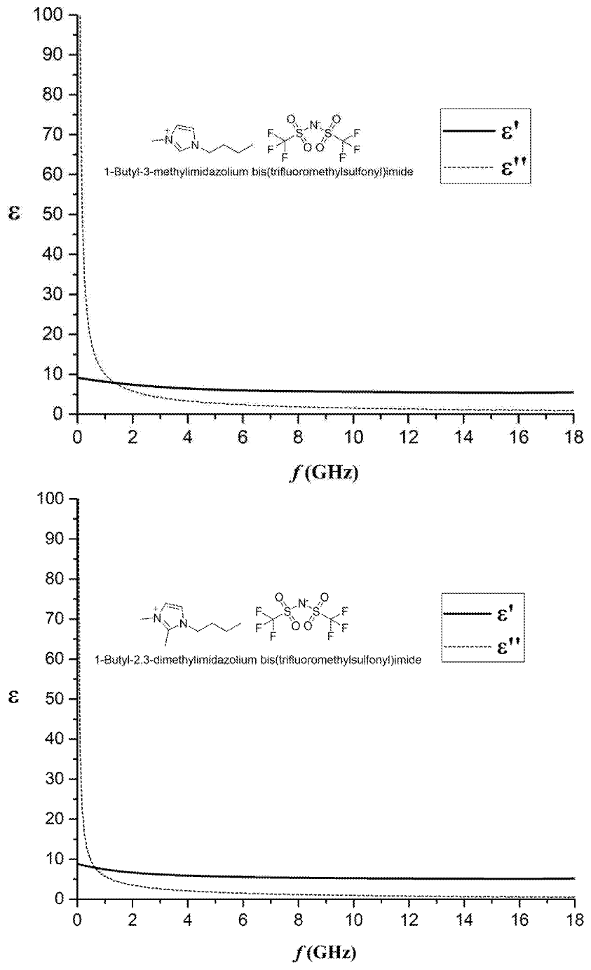

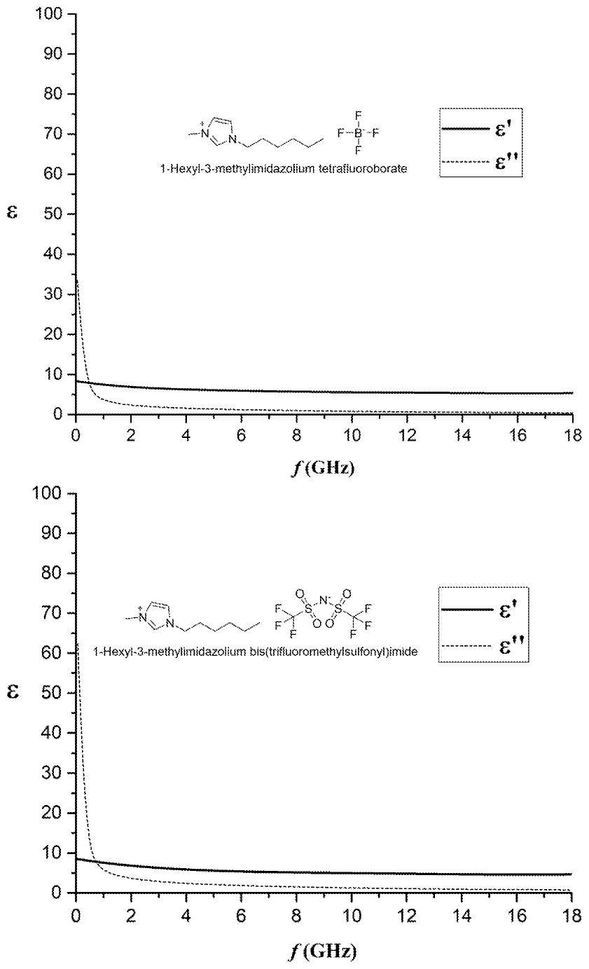

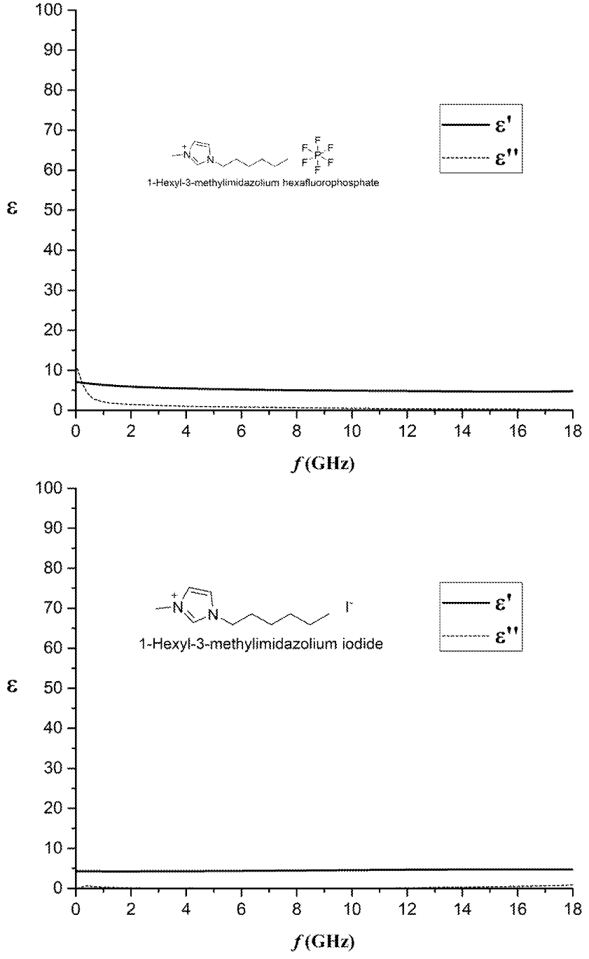

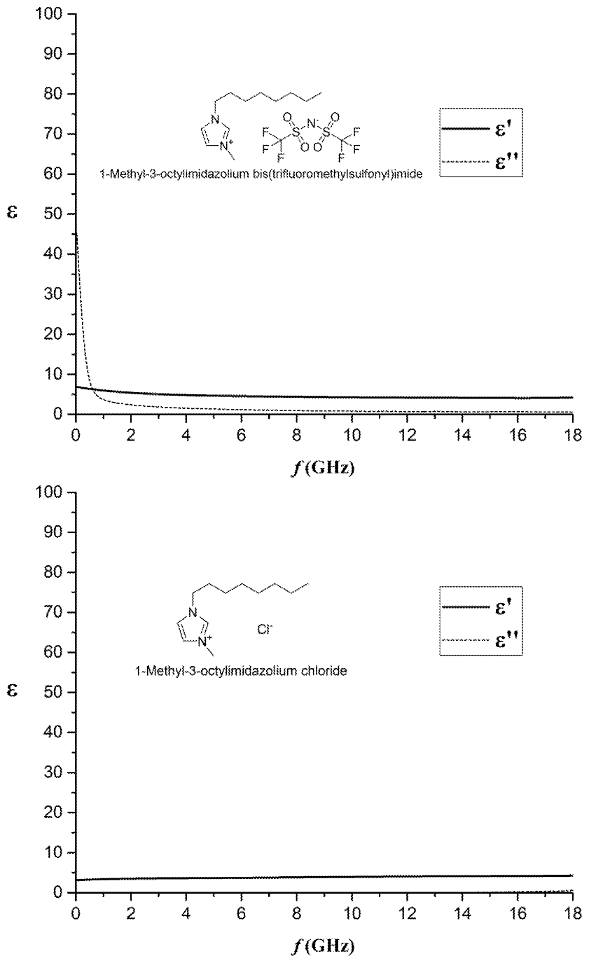

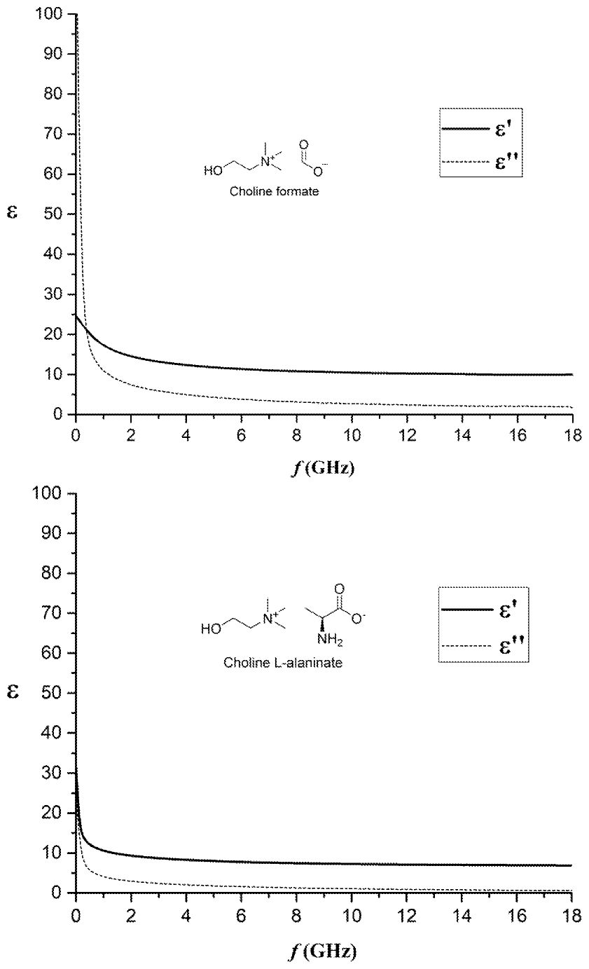

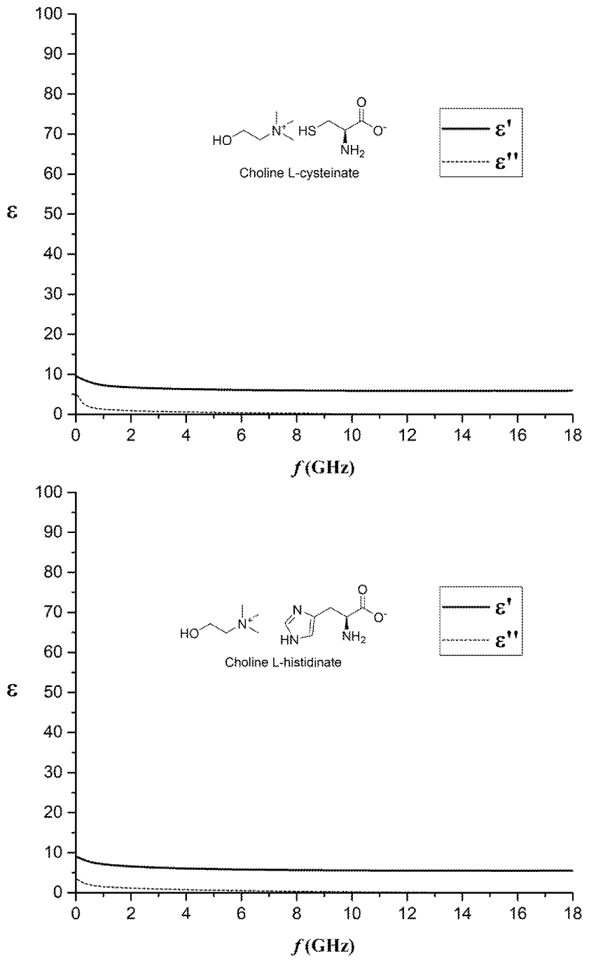

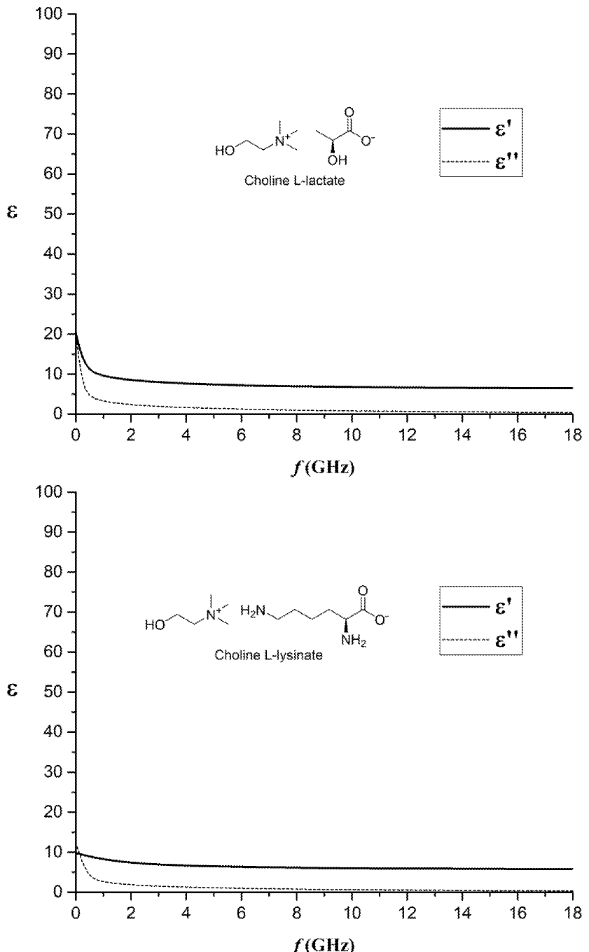

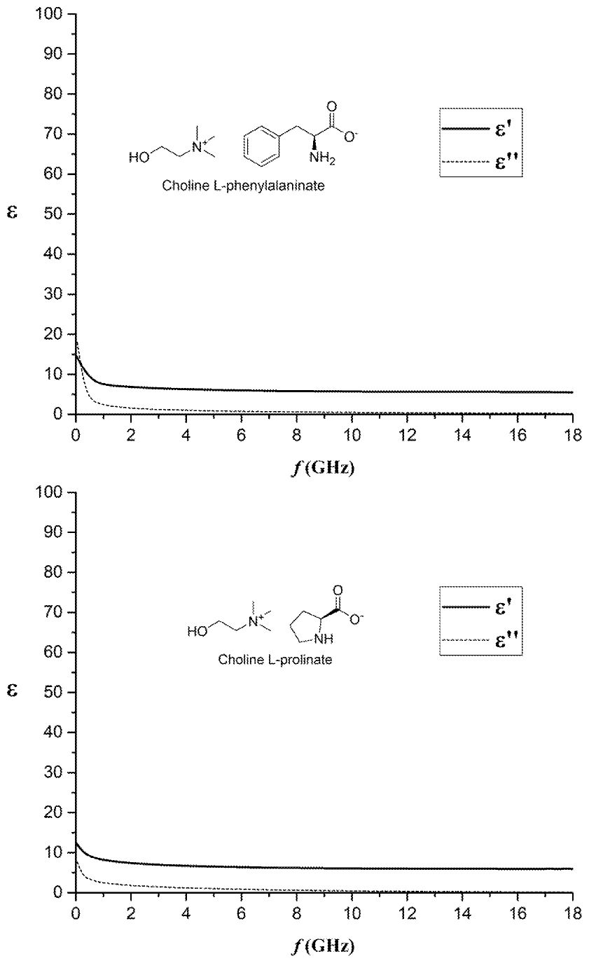

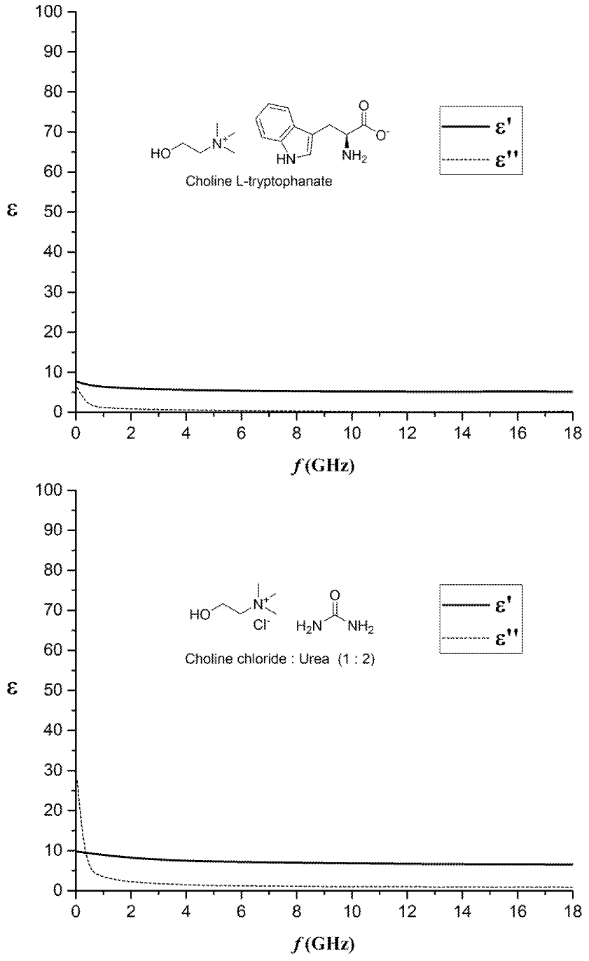

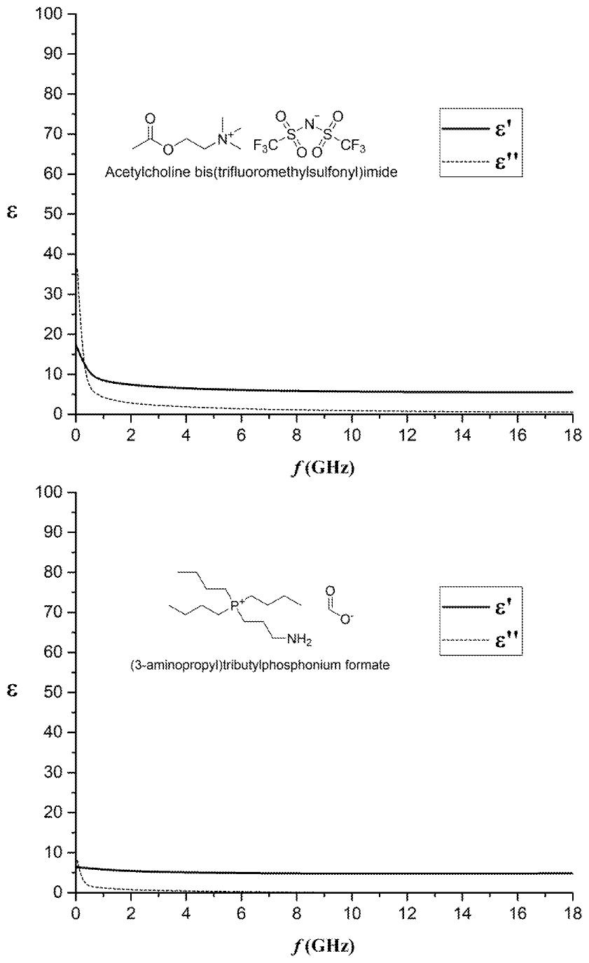

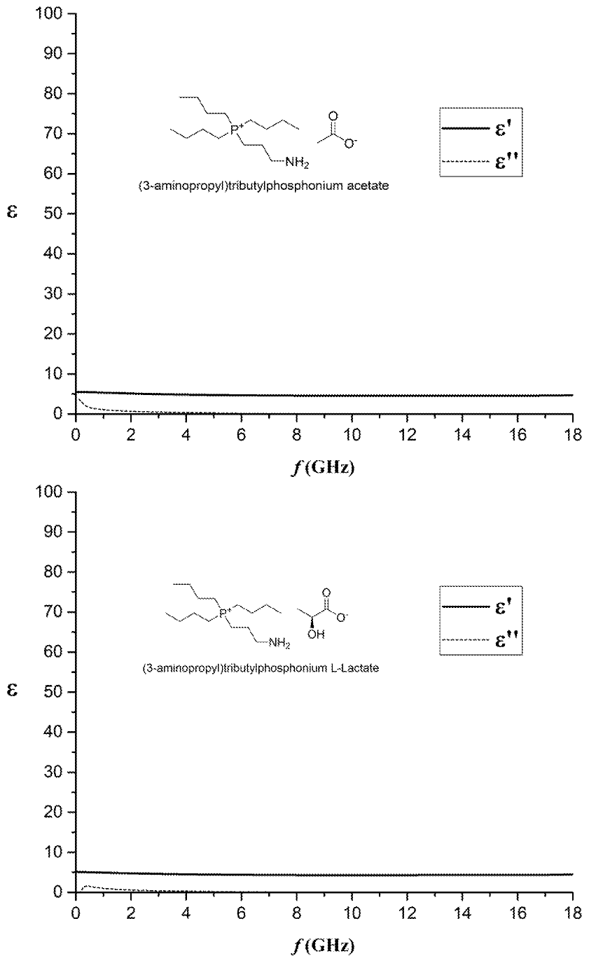

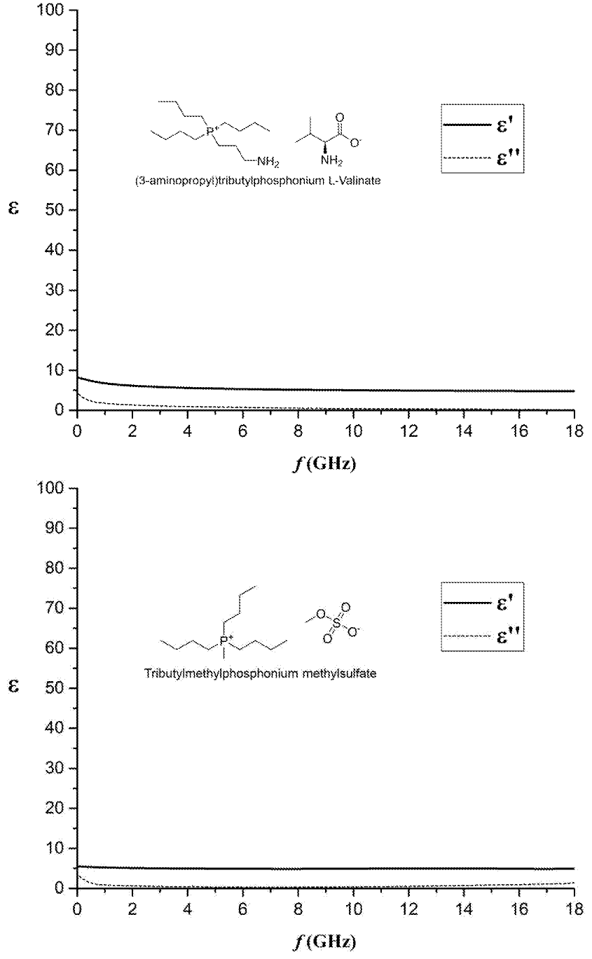

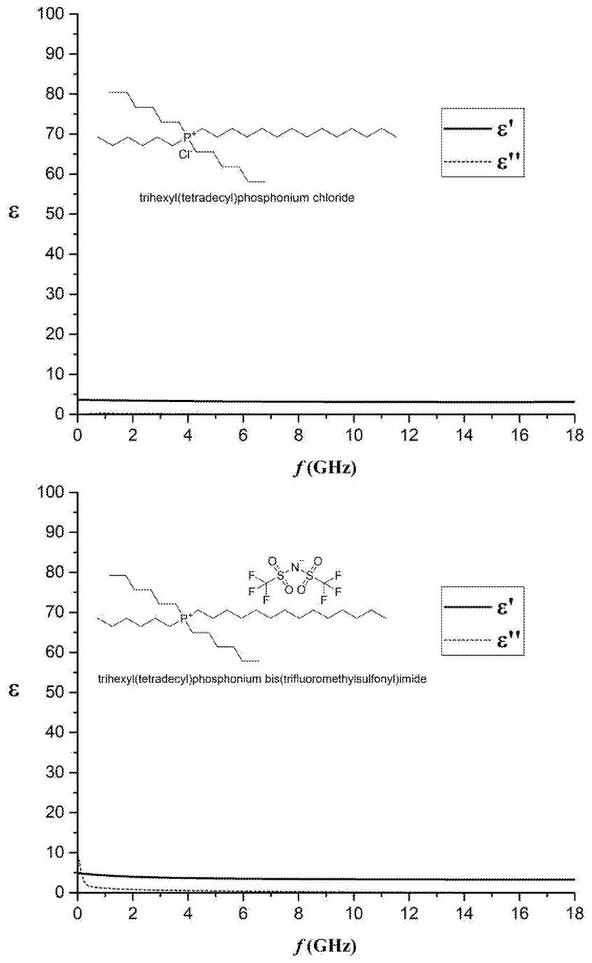

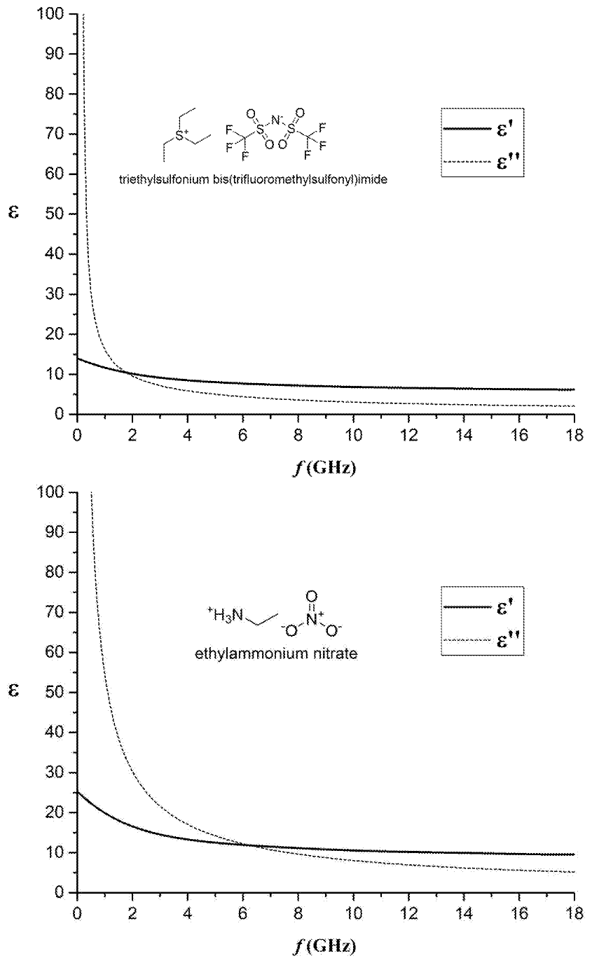

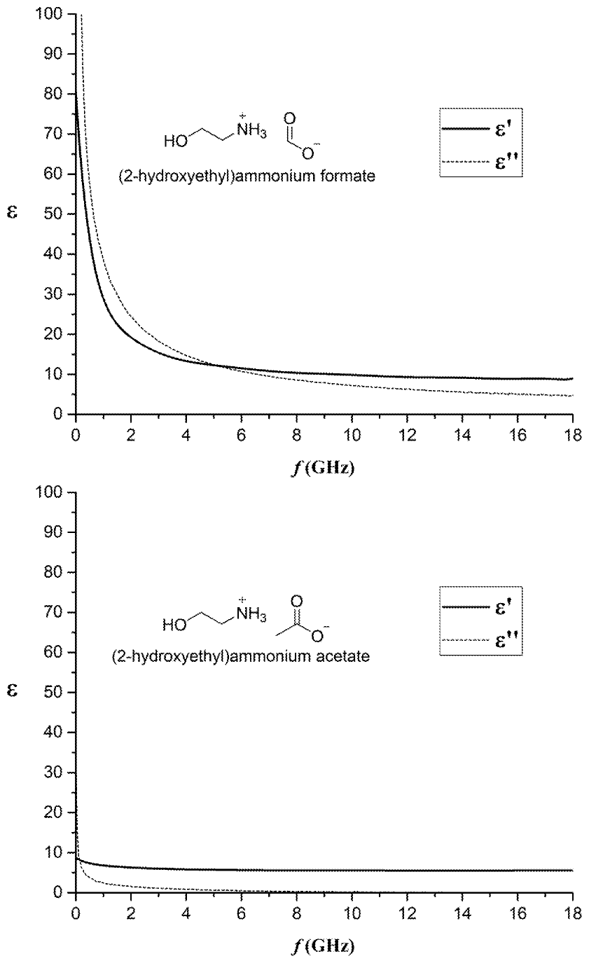

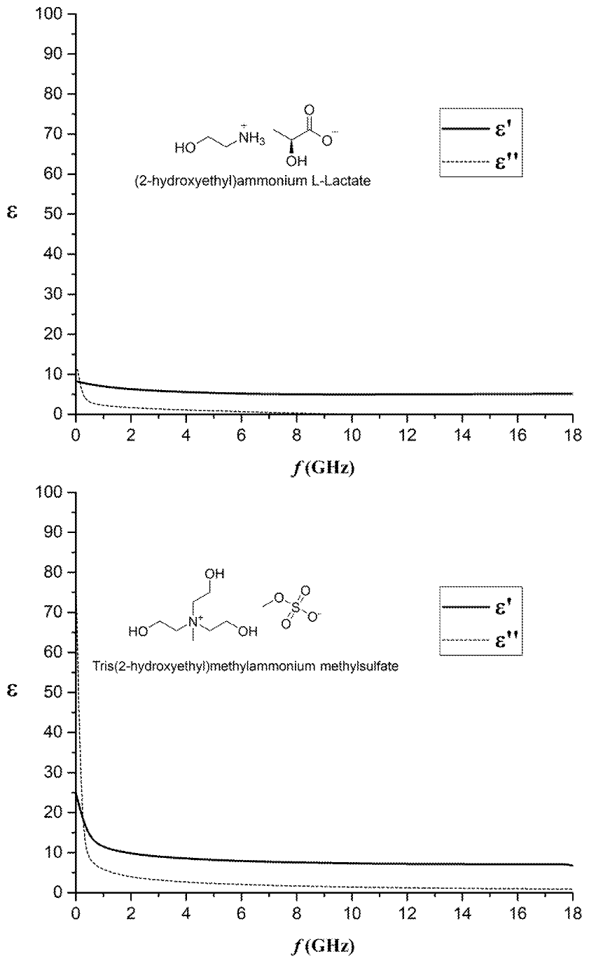

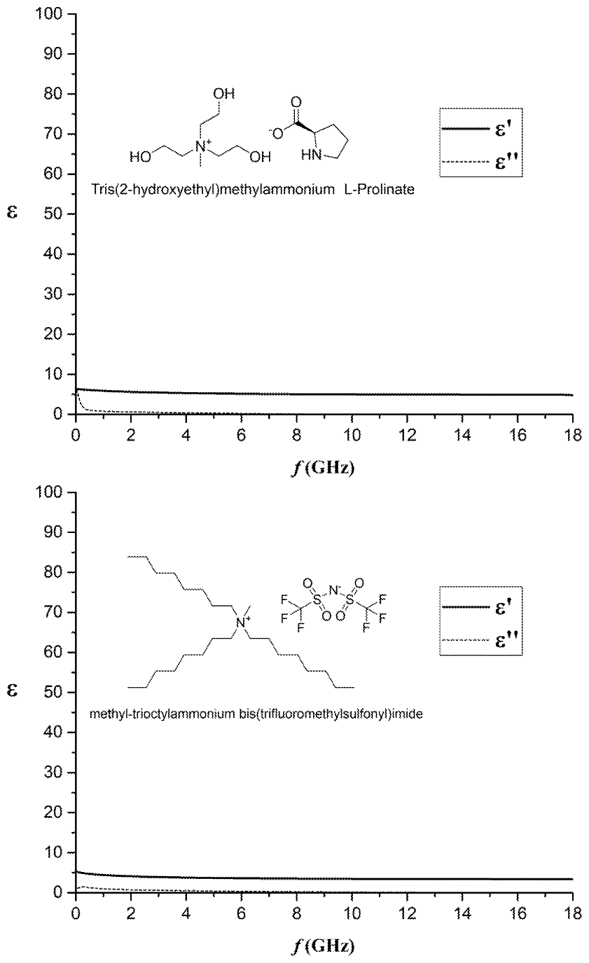

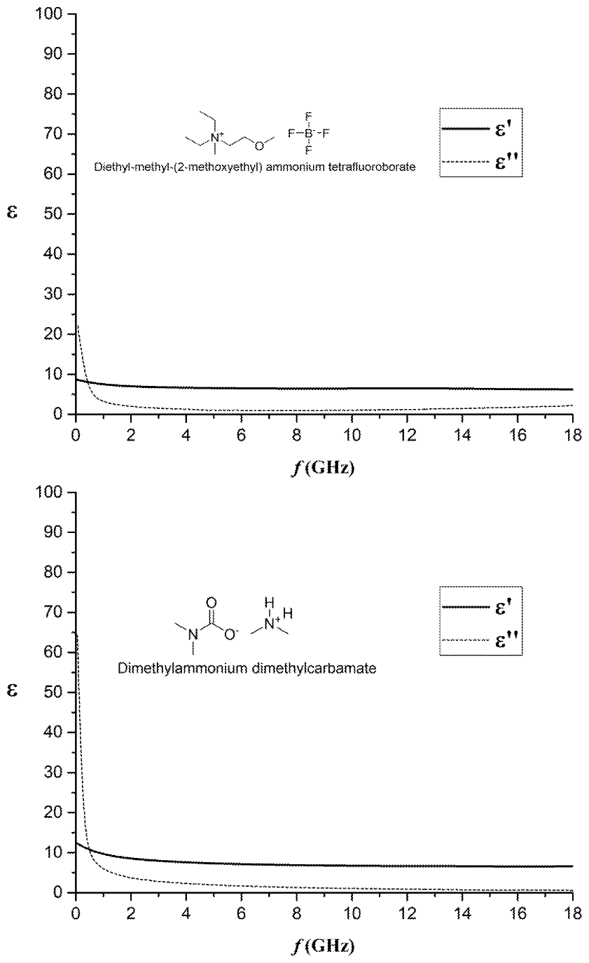

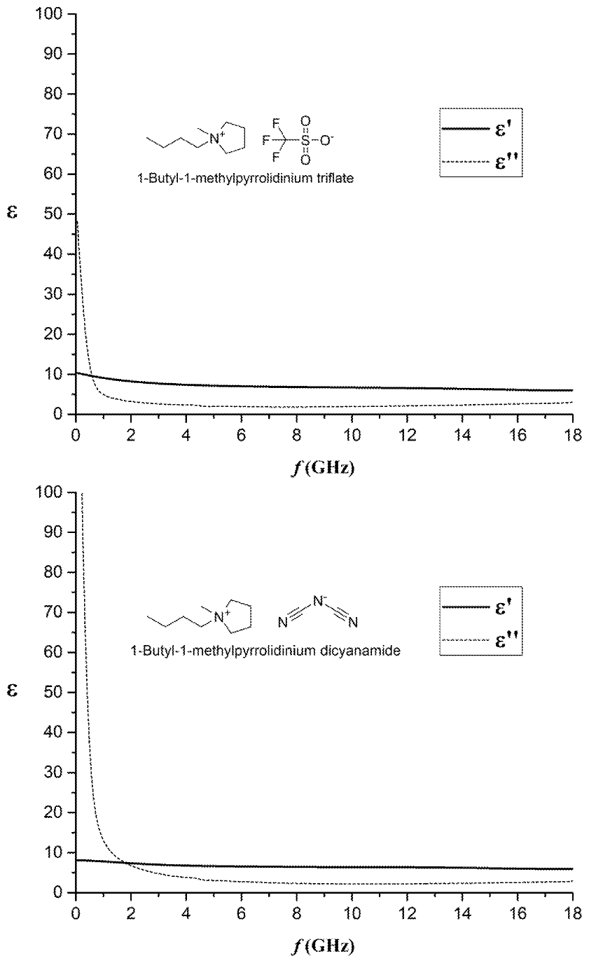

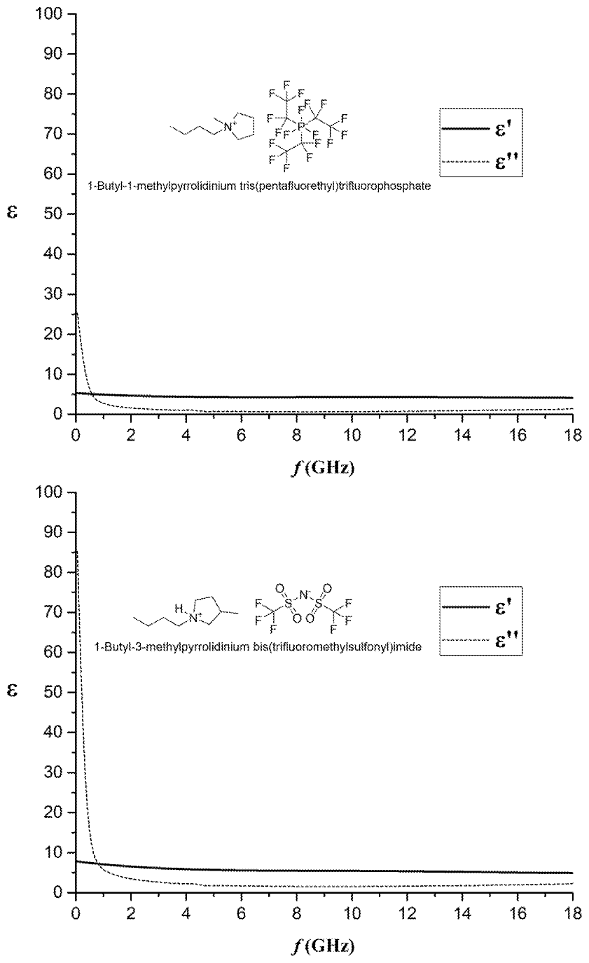

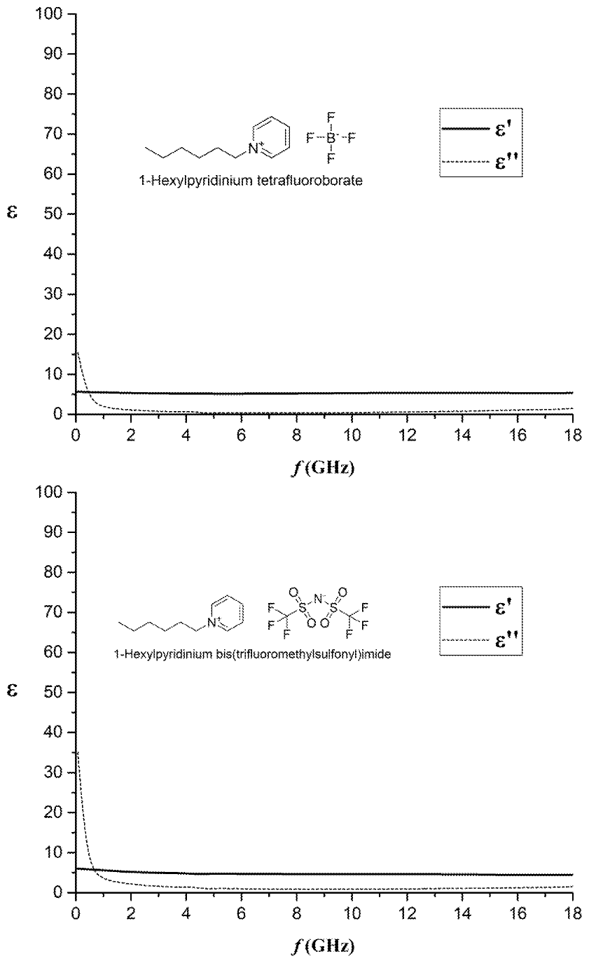

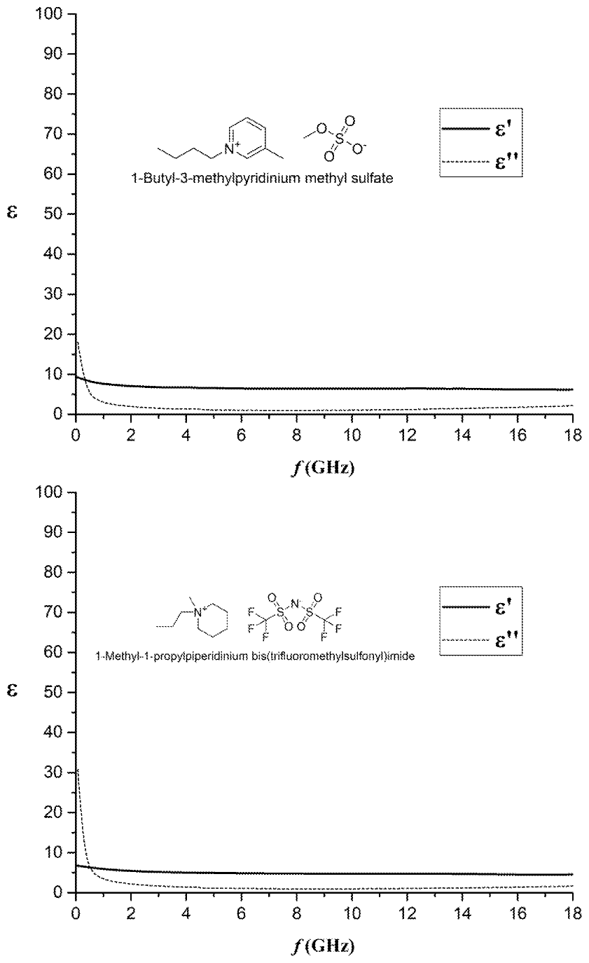

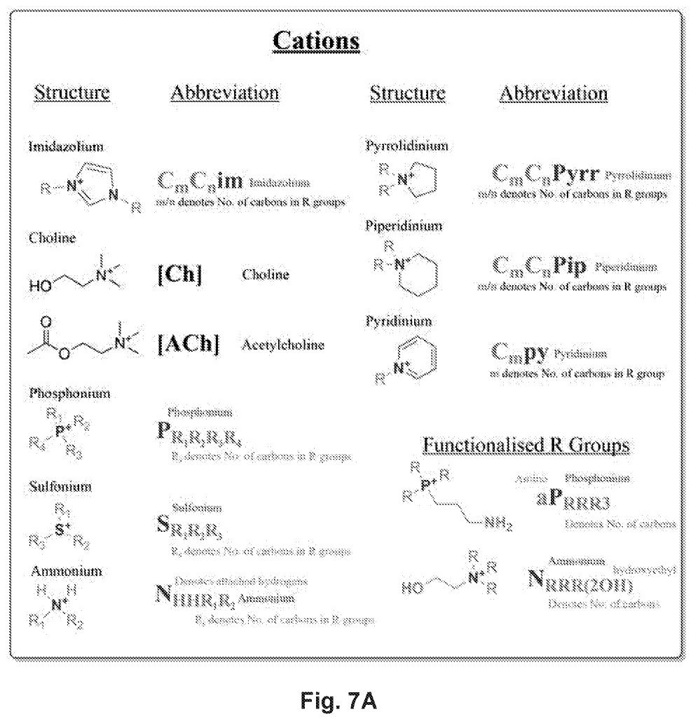

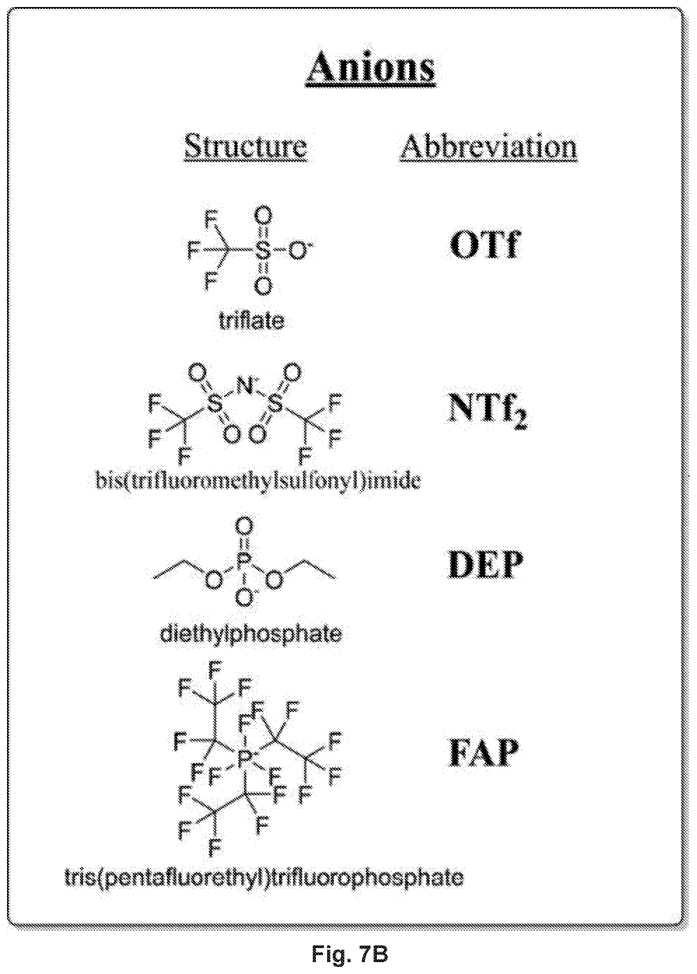

Due to the cationic/anionic nature of IL structures and the huge number of possible combinations, including their associated long chemical names, an abbreviation system is often used. FIG. 7A gives a structural breakdown of the abbreviations used for IL cations in this study. 1-Ethyl-3-methylimidazolium, for example, has previously been abbreviated as EMIM; however, using the ethyl/methyl description would not suffice for some alkyl chains, such as propyl/pentyl. More recently a numbered R-group carbon system has been implemented and we have tried to stick to this naming system herein, e.g. EMIM now described as C₂C₁im.

For anion abbreviations, structural or molecular formulae work for most common anions, such as tetrafluoroborate (BF₄) or formate (HCO₂). FIG. 7B gives the structures associated with more complex anions and their abbreviations. When the source of the anion is an amino acid (AA), the standard 3-letter abbreviations have been used, i.e. L-Alaninate written as L-Ala.

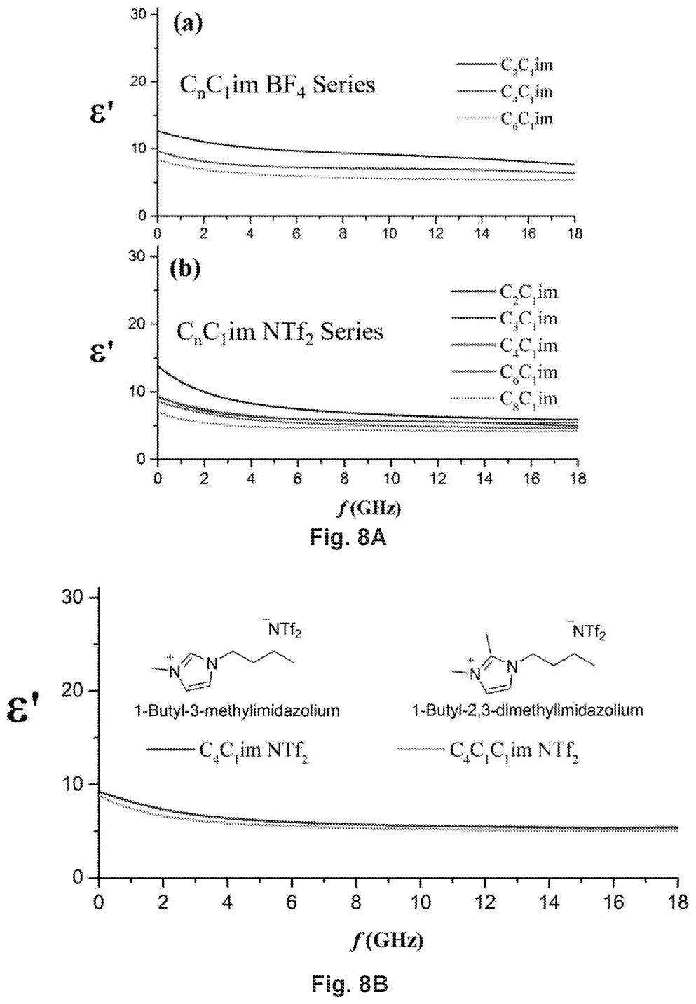

Air and moisture stable imidazolium ILs are some of the most studied and commercially available classes of IL. From the results presented in Table 2, we can see the effect that increasing the imidazolium alkyl chain length has on the dielectric constant. In two of the most common IL series, CₙC₁im with BF₄ anions and also with NTf₂ anions, there is a significant drop in the overall permittivity when increasing alkyl chain length and therefore molecular weight, which can be further seen in FIG. 8A. Literature sources have shown that increasing alkyl chain length on imidazolium ILs results in an increase in viscosity, and this reduction in ionic mobility also correlates to a decrease in the overall polarity as well as electrical conductivity.

TABLE 2
Dielectric constants of imidazolium ionic liquids as a function of frequency f (GHz).

| Ionic liquid | 0^{a} | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|---|
| C₂C₁im BF₄ | 12.9 | 11.7 | 11 | 10.5 | 10.2 | 9.9 | 9.7 | 9.5 | 9.4 | 9.2 | 9.1 | 9 | 8.9 | 8.7 | 8.5 | 8.3 | 8.1 | 7.9 | 7.7 |
| C₂C₁im | 16.3 | 13 | 11.5 | 10.7 | 10.1 | 9.7 | 9.4 | 9.1 | 8.9 | 8.7 | 8.5 | 8.4 | 8.3 | 8.2 | 8.1 | 8 | 7.9 | 7.9 | 7.9 |
| CH₃CO₂ | | | | | | | | | | | | | | | | | | | |
| C₂C₁im | 24.4 | 13.3 | 11.1 | 10.1 | 9.4 | 9 | 8.7 | 8.4 | 8.2 | 7.9 | 7.8 | 7.7 | 7.5 | 7.4 | 7.4 | 7.3 | 7.2 | 7.1 | 7.1 |
| EtOSO₃ | | | | | | | | | | | | | | | | | | | |
| C₂C₁im | 12.5 | 11.8 | 11.1 | 10.5 | 9.9 | 9.5 | 9.1 | 8.9 | 8.6 | 8.4 | 8.3 | 8.1 | 8 | 7.9 | 7.8 | 7.7 | 7.7 | 7.6 | 7.5 |
| N(CN)₂ | | | | | | | | | | | | | | | | | | | |
| C₂C₁im OTf | 19.3 | 14.1 | 12.7 | 11.6 | 10.9 | 10.3 | 9.9 | 9.6 | 9.3 | 9.1 | 8.8 | 8.6 | 8.4 | 8.2 | 7.9 | 7.6 | 7.4 | 7.1 | 6.9 |
| C₂C₁im | 13.8 | 11.5 | 9.9 | 8.9 | 8.3 | 7.8 | 7.4 | 7.1 | 6.9 | 6.7 | 6.5 | 6.4 | 6.3 | 6.2 | 6.1 | 6 | 6 | 5.9 | 5.9 |
| NTf₂ | | | | | | | | | | | | | | | | | | | |
| C₂C₁im | 15.1 | 13.8 | 12.8 | 11.9 | 11.2 | 10.7 | 10.2 | 9.9 | 9.6 | 9.3 | 9.2 | 9 | 8.8 | 8.7 | 8.6 | 8.5 | 8.4 | 8.3 | 8.3 |
| SCN | | | | | | | | | | | | | | | | | | | |
| C₂C₁im | 8.1 | 6.8 | 6.3 | 6 | 5.9 | 5.8 | 5.8 | 5.8 | 5.8 | 5.8 | 5.8 | 5.8 | 5.8 | 5.8 | 5.7 | 5.7 | 5.6 | 5.6 | 5.5 |
| DEP | | | | | | | | | | | | | | | | | | | |
| C₂C₁im L- | 12.1 | 8.5 | 7.6 | 7.2 | 7 | 6.9 | 6.9 | 6.8 | 6.8 | 6.8 | 6.8 | 6.8 | 6.8 | 6.8 | 6.7 | 6.6 | 6.6 | 6.5 | 6.5 |
| Lac | | | | | | | | | | | | | | | | | | | |
| C₂C₁im | 13.1 | 9.6 | 8.5 | 7.9 | 7.5 | 7.3 | 7.2 | 7 | 6.9 | 6.8 | 6.8 | 6.7 | 6.6 | 6.6 | 6.5 | 6.3 | 6.2 | 6.1 | 6 |
| FeCl₄ | | | | | | | | | | | | | | | | | | | |
| C₂OHC₁im | 20.7 | 11.6 | 9.8 | 8.8 | 8.3 | 8.1 | 7.9 | 7.7 | 7.6 | 7.5 | 7.4 | 7.3 | 7.2 | 7.2 | 7.1 | 6.9 | 6.7 | 6.6 | 6.6 |
| OTf | | | | | | | | | | | | | | | | | | | |
| C₂OHC₁im | 9.9 | 7.9 | 7.3 | 7 | 6.8 | 6.7 | 6.7 | 6.7 | 6.7 | 6.7 | 6.7 | 6.7 | 6.7 | 6.7 | 6.7 | 6.6 | 6.5 | 6.5 | 6.5 |
| PF₆ | | | | | | | | | | | | | | | | | | | |
| C₃C₁im I | 5.5 | 5.2 | 5.2 | 5.2 | 5.2 | 5.2 | 5.1 | 5.1 | 5.1 | 5.1 | 5.1 | 5.1 | 5.1 | 5.1 | 5.1 | 5.1 | 5.1 | 5.1 | 5.1 |
| C₃C₁im | 9.4 | 8.1 | 7.2 | 6.7 | 6.3 | 6.1 | 6 | 5.9 | 5.8 | 5.7 | 5.7 | 5.6 | 5.5 | 5.5 | 5.4 | 5.3 | 5.2 | 5.1 | 5 |
| NTf₂ | | | | | | | | | | | | | | | | | | | |
| C₃OC₁im | 8.6 | 7.6 | 7.1 | 6.8 | 6.7 | 6.6 | 6.5 | 6.4 | 6.4 | 6.4 | 6.4 | 6.4 | 6.4 | 6.4 | 6.3 | 6.2 | 6.2 | 6.1 | 6.1 |
| PF₆ | | | | | | | | | | | | | | | | | | | |
| C₄C₁im BF₄ | 9.7 | 8.8 | 8.1 | 7.7 | 7.5 | 7.3 | 7.2 | 7.2 | 7.1 | 7.1 | 7.1 | 7 | 7 | 6.9 | 6.9 | 6.8 | 6.7 | 6.5 | 6.4 |
| C₄C₁im | 9.7 | 8.4 | 7.7 | 7.3 | 7 | 6.9 | 6.8 | 6.7 | 6.7 | 6.7 | 6.7 | 6.7 | 6.6 | 6.6 | 6.5 | 6.5 | 6.4 | 6.3 | 6.2 |
| SCN | | | | | | | | | | | | | | | | | | | |
| C₄C₁im L- | 6.6 | 5.6 | 5.4 | 5.3 | 5.3 | 5.2 | 5.2 | 5.2 | 5.2 | 5.2 | 5.2 | 5.2 | 5.2 | 5.2 | 5.2 | 5.2 | 5.2 | 5.2 | 5.2 |
| Lac | | | | | | | | | | | | | | | | | | | |
| C₄C₁im | 11.9 | 8.7 | 7.8 | 7.3 | 7.1 | 7 | 6.9 | 6.8 | 6.8 | 6.8 | 6.7 | 6.7 | 6.7 | 6.7 | 6.6 | 6.5 | 6.4 | 6.4 | 6.4 |
| MeOSO₃ | | | | | | | | | | | | | | | | | | | |
| C₄C₁im | 10.3 | 9.4 | 8.7 | 8.2 | 7.9 | 7.6 | 7.5 | 7.4 | 7.3 | 7.2 | 7.1 | 7.1 | 7 | 6.9 | 6.8 | 6.6 | 6.5 | 6.4 | 6.3 |
| N(CN)₂ | | | | | | | | | | | | | | | | | | | |
| C₄C₁im | 9.2 | 8.2 | 7.4 | 6.8 | 6.4 | 6.2 | 6 | 5.9 | 5.8 | 5.7 | 5.6 | 5.5 | 5.5 | 5.5 | 5.4 | 5.4 | 5.4 | 5.4 | 5.4 |
| NTf₂ | | | | | | | | | | | | | | | | | | | |
| C₄C₁C₁im | 8.8 | 7.5 | 6.7 | 6.2 | 5.9 | 5.7 | 5.6 | 5.5 | 5.4 | 5.3 | 5.2 | 5.2 | 5.2 | 5.1 | 5.1 | 5.1 | 5.1 | 5.1 | 5.1 |
| NTf₂ | | | | | | | | | | | | | | | | | | | |
| C₆C₁im BF₄ | 8.4 | 7.5 | 6.9 | 6.5 | 6.3 | 6.1 | 5.9 | 5.8 | 5.7 | 5.6 | 5.6 | 5.5 | 5.5 | 5.4 | 5.4 | 5.3 | 5.3 | 5.3 | 5.3 |
| C₆C₁im | 8.5 | 7.6 | 6.8 | 6.2 | 5.9 | 5.6 | 5.4 | 5.3 | 5.1 | 5 | 4.9 | 4.9 | 4.8 | 4.7 | 4.7 | 4.6 | 4.6 | 4.6 | 4.6 |
| NTf₂ | | | | | | | | | | | | | | | | | | | |
| C₆C₁im PF₆ | 7.1 | 6.4 | 5.9 | 5.6 | 5.5 | 5.3 | 5.2 | 5.1 | 5 | 4.9 | 4.9 | 4.9 | 4.8 | 4.8 | 4.7 | 4.7 | 4.7 | 4.7 | 4.7 |
| C₆C₁im I | 4.3 | 4.3 | 4.3 | 4.3 | 4.3 | 4.3 | 4.4 | 4.4 | 4.5 | 4.5 | 4.6 | 4.6 | 4.7 | 4.7 | 4.7 | 4.7 | 4.7 | 4.8 | 4.8 |
| C₈C₁im | 6.9 | 6 | 5.4 | 5.1 | 4.8 | 4.7 | 4.6 | 4.5 | 4.4 | 4.3 | 4.3 | 4.2 | 4.2 | 4.2 | 4.2 | 4.2 | 4.1 | 4.1 | 4.1 |
| NTf₂ | | | | | | | | | | | | | | | | | | | |
| C₈C₁im Cl | 3.2 | 3.3 | 3.5 | 3.6 | 3.6 | 3.7 | 3.7 | 3.8 | 3.8 | 3.9 | 4 | 4 | 4.1 | 4.1 | 4.1 | 4.1 | 4.2 | 4.2 | 4.3 |

^{a}Static dielectric constants derived by polynomial extrapolation; see experimental section, FIG. 3A and Table 1 for details.

The 2-position of imidazolium ILs are known to be reasonably acidic. This inherent acidity and the ability to generate NHC-type carbenes have been utilized in transition metal catalysis, although any non-innocent side reactions of ILs would generally be considered unwanted in the vast majority of IL applications. FIG. 8B shows the negligible effect of 2-position methylation on the permittivity of butyl-imidazolium ILs with NTf₂ anions. An insignificant change in the overall permittivity spectrum and polarity can be deduced, implying that if required, one may substitute for a similar yet more chemically stable IL without sacrificing a polar environment.

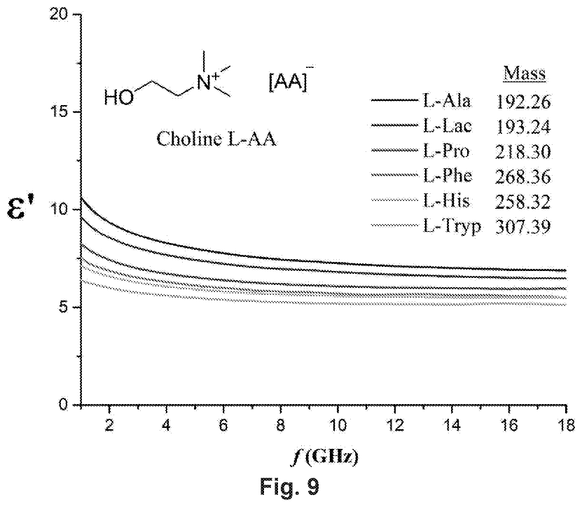

Table 3 shows the relative complex permittivity measurements of choline ([Ch]) amino-acid (AA) or related carboxylic acid ILs. The general trend revealed implies again, that increasing molecular weight results in a decrease in frequency-dependent dielectric constants. This trend is observable in FIG. 9. Individual viscosity and conductivity values for specific ILs vary considerably across multiple literature sources. For example, Ch L-Pro has published viscosity values ranging between 0.5 and 10.6 Pa·S and conductivity values from 0.3 to 7.5 μS cm⁻¹. Thus, although there appears to be a correlation between increased molecular weight and decreased dielectric constants (also see FIG. 8A), any correlation of dielectric constants with the literature values of viscosity or conductivity should be cautious.

TABLE 3
Dielectric constants of choline ionic liquids as a function of frequency. All measurements performed at 298 K, under
an inert N₂(g) atmosphere. See data for imaginary parts of the dielectric spectra and full plotted graphs.

| Ionic liquid | 0^{a} | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|---|
| [Ch] HCO₂^{b} | 24.7 | 17.4 | 14.6 | 13.2 | 12.4 | 11.8 | 11.4 | 11 | 10.8 | 10.7 | 10.5 | 10.4 | 10.3 | 10.2 | 10.1 | 10 | 9.9 | 9.9 | 9.9 |
| [Ch] L-Ala | 31.4 | 10.6 | 9.4 | 8.7 | 8.3 | 8 | 7.8 | 7.6 | 7.4 | 7.3 | 7.3 | 7.2 | 7.1 | 7.1 | 7 | 7 | 6.9 | 6.9 | 6.9 |
| [Ch] L-Cys | 9.5 | 7.3 | 6.8 | 6.5 | 6.3 | 6.2 | 6.1 | 6 | 6 | 5.9 | 5.9 | 5.9 | 5.9 | 5.9 | 5.9 | 5.9 | 5.9 | 5.9 | 5.9 |
| [Ch] L-His | 9.1 | 7.1 | 6.6 | 6.3 | 6.1 | 5.9 | 5.8 | 5.7 | 5.7 | 5.6 | 5.6 | 5.6 | 5.5 | 5.5 | 5.5 | 5.5 | 5.5 | 5.5 | 5.5 |
| [Ch] L-Lac | 20.4 | 9.6 | 8.6 | 8 | 7.7 | 7.4 | 7.2 | 7.1 | 7 | 6.9 | 6.8 | 6.7 | 6.7 | 6.6 | 6.6 | 6.5 | 6.5 | 6.5 | 6.5 |
| [Ch] L-Lys | 9.8 | 8.3 | 7.4 | 7 | 6.7 | 6.5 | 6.4 | 6.2 | 6.1 | 6.1 | 6 | 6 | 5.9 | 5.9 | 5.9 | 5.9 | 5.8 | 5.8 | 5.8 |
| [Ch] L-Phe | 14.8 | 7.6 | 6.9 | 6.5 | 6.3 | 6.1 | 6 | 5.9 | 5.8 | 5.8 | 5.7 | 5.7 | 5.7 | 5.7 | 5.6 | 5.6 | 5.6 | 5.6 | 5.5 |
| [Ch] L-Pro | 12.6 | 8.2 | 7.4 | 7 | 6.7 | 6.5 | 6.4 | 6.3 | 6.2 | 6.1 | 6.1 | 6 | 6 | 6 | 6 | 6 | 6 | 6 | 6 |
| [Ch] L-Tryp | 7.7 | 6.4 | 6 | 5.8 | 5.6 | 5.5 | 5.4 | 5.3 | 5.3 | 5.2 | 5.2 | 5.2 | 5.2 | 5.2 | 5.2 | 5.2 | 5.2 | 5.2 | 5.1 |
| [Ch]Cl/Urea^{c} | 9.8 | 8.9 | 8.3 | 7.8 | 7.5 | 7.3 | 7.2 | 7.1 | 7 | 6.9 | 6.9 | 6.8 | 6.7 | 6.7 | 6.6 | 6.6 | 6.6 | 6.6 | 6.6 |
| [ACh] NTf₂ | 17.5 | 8.5 | 7.4 | 6.9 | 6.5 | 6.2 | 6.1 | 5.9 | 5.9 | 5.8 | 5.7 | 5.6 | 5.6 | 5.6 | 5.6 | 5.6 | 5.5 | 5.5 | 5.6 |

^{a}Static dielectric constants derived by polynomial extrapolation; see experimental section, FIG. 3A and Table 1 for details;
^{b}Measured at 311 K (liquid state of compound); and
^{c}Choline chloride:Urea in a 1:2 ratio, deep eutectic solvent (DES).

The complex permittivities of these completely organic [Ch] AA ILs have extremely small contributions from their imaginary parts ε″, which give these liquids somewhat unique properties among ILs (see data for full spectra displaying ε′ & ε″). Compared to the commonly used imidazolium series, they exhibit extremely low loss (see Equation (2)) and very low electrical conductivity σ_{ac}, which can be calculated as in Equation (3), where ε′ᵣε₀ represents the real part of the absolute permittivity.

$${σ}_{a c} = {ωε}_{r}^{′ ( ω ) {ε}_{0}} tan {δ}_{e} \qquad Equation ( 3 )$$

The phosphonium ILs found in Table 4 all exhibit very little dielectric relaxation with stable permittivities over the full range measured up to 18 GHz. The dielectric constants are small and lie between ≈3-8, and the phosphonium series also possess extremely small imaginary parts and therefore dielectric loss. This is in contrast to the sulfonium IL included in Table 4, which shows some dielectric relaxation from low to high frequencies and also has more contributions from the imaginary part. Therefore, this sulfonium IL can be considered a more dielectrically lossy and electrically conductive material.

TABLE 4
Dielectric constants of phosphonium & sulfonium ionic liquids as a function of frequency
f (GHz). All measurements performed at 298 K, under an inert N₂(g) atmosphere. See
data for imaginary parts of the dielectric spectra and full plotted graphs.

| Ionic liquid | 0^{a} | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|---|
| aP₄₄₄₃ | 6.4 | 5.8 | 5.4 | 5.2 | 5.1 | 5 | 4.9 | 4.9 | 4.8 | 4.8 | 4.8 | 4.8 | 4.8 | 4.8 | 4.8 | 4.8 | 4.8 | 4.8 | 4.8 |
| HCO₂ | | | | | | | | | | | | | | | | | | | |
| aP₄₄₄₃ | 5.5 | 5.3 | 5.1 | 5 | 4.9 | 4.8 | 4.7 | 4.6 | 4.6 | 4.6 | 4.6 | 4.6 | 4.6 | 4.6 | 4.6 | 4.6 | 4.6 | 4.6 | 4.6 |
| CH₃CO₂ | | | | | | | | | | | | | | | | | | | |
| aP₄₄₄₃ L- | 5.1 | 4.9 | 4.7 | 4.6 | 4.5 | 4.4 | 4.4 | 4.4 | 4.3 | 4.3 | 4.3 | 4.3 | 4.3 | 4.3 | 4.3 | 4.3 | 4.3 | 4.3 | 4.3 |
| Lac | | | | | | | | | | | | | | | | | | | |
| aP₄₄₄₃ L- | 8.3 | 6.8 | 6.2 | 5.8 | 5.6 | 5.4 | 5.3 | 5.2 | 5.1 | 5.1 | 5 | 5 | 4.9 | 4.9 | 4.9 | 4.9 | 4.8 | 4.8 | 4.8 |
| Val | | | | | | | | | | | | | | | | | | | |
| P₄₄₄₁ | 5.5 | 5.2 | 5.1 | 5 | 5 | 4.9 | 4.9 | 4.9 | 4.9 | 4.9 | 4.9 | 4.9 | 4.9 | 4.9 | 4.9 | 4.9 | 4.9 | 4.9 | 4.9 |
| MeOSO₃ | | | | | | | | | | | | | | | | | | | |
| P₆₆₆₍₁₄₎ | 3.6 | 3.5 | 3.5 | 3.4 | 3.3 | 3.3 | 3.2 | 3.2 | 3.2 | 3.1 | 3.1 | 3.1 | 3.1 | 3.1 | 3.1 | 3.1 | 3.1 | 3.1 | 3 |
| Cl | | | | | | | | | | | | | | | | | | | |
| P₆₆₆₍₁₄₎ | 4.9 | 4.3 | 4 | 3.8 | 3.7 | 3.6 | 3.5 | 3.5 | 3.4 | 3.4 | 3.4 | 3.3 | 3.3 | 3.3 | 3.3 | 3.3 | 3.3 | 3.3 | 3.3 |
| NTf₂ | | | | | | | | | | | | | | | | | | | |
| S₂₂₂ NTf₂ | 14 | 11.7 | 10.2 | 9.2 | 8.5 | 8.1 | 7.7 | 7.4 | 7.2 | 7 | 6.9 | 6.7 | 6.6 | 6.5 | 6.4 | 6.4 | 6.3 | 6.2 | 6.2 |

^{a}Static dielectric constants derived by polynomial extrapolation; see experimental FIG. 3A and Table 1 for details.

Table 5 presents the results for ammonium based ILs. It appears that N_{HHH2} NO₃, the original IL discovered in 1914, has one of the largest overall complex permittivities across the full frequency range. It has a comparatively large static dielectric constant, which is smaller still than its imaginary part (see supplementary data), and therefore is extremely lossy, especially at frequencies <9 GHz. It has, however, been used as a conductive solvent in electrochemistry; so the large imaginary contribution is expected, Equation (3). N_{HHH(2OH)} HCO₂ exhibits similar properties to N_{HHH2} NO₃ and shows a sharp dielectric relaxation as the frequency increases and with reports in the literature stating a conductivity of =0.34 S/m, the large imaginary contribution is again rationalized and expected. There is a contrast between this formate IL and the very closely related N_{HHH(2OH)} CH₃CO₂ which differs only from a change in anion from formate to acetate. The broadband permittivity of the latter is significantly lower, and the material is much less electrically conductive and lossy. This could be explained by the vastly different viscosities, with the formate analogue having a much greater fluidity compared to the viscous acetate IL. The extra mobility of charge carriers obviously contributes to the conductivity, and the extra methyl group located within the anion could be said to contribute to the reduction in the overall polarity. The rest of the ammonium series progresses as expected, with additional alkyl groups of increasing length, and also with hydroxyl functionality, significantly reducing the dielectric relaxation and imaginary contributions. This is highly likely due to the increase in mass and the hydrogen bonding contributions both intra- and inter-molecularly from the —OH and —NH groups where relevant.

TABLE 5
Dielectric constants of ammonium ionic liquids as a function of frequency f (GHz). All measurements performed at 298 K, under
an inert N₂(g) atmosphere. See supplementary data for imaginary parts of the dielectric spectra and full plotted graphs.

| Ionic Liquid | 0^{a} | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|---|
| N_{HHH2} NO3 | 25.4 | 20 | 16.6 | 14.5 | 13.3 | 12.5 | 11.9 | 11.5 | 11.1 | 10.8 | 10.6 | 10.4 | 10.2 | 10.1 | 9.9 | 9.8 | 9.7 | 9.6 | 9.5 |
| N_{HHH(2OH)} | 80.5 | 28.9 | 19.2 | 15.4 | 13.3 | 12.3 | 11.5 | 10.8 | 10.4 | 10.1 | 9.9 | 9.6 | 9.3 | 9.2 | 9.2 | 9 | 8.9 | 8.9 | 8.9 |
| HCO₂ | | | | | | | | | | | | | | | | | | | |
| N_{HHH(2OH)} | 8.7 | 6.8 | 6.3 | 6 | 5.8 | 5.7 | 5.7 | 5.6 | 5.6 | 5.6 | 5.6 | 5.6 | 5.6 | 5.6 | 5.6 | 5.6 | 5.6 | 5.6 | 5.6 |
| CH₃CO₂ | | | | | | | | | | | | | | | | | | | |
| N_{HHH(2OH)} L- | 8.3 | 7 | 6.3 | 5.9 | 5.6 | 5.4 | 5.2 | 5.1 | 5 | 5 | 5 | 5 | 5 | 5 | 5 | 5 | 5 | 5 | 5 |
| Lac | | | | | | | | | | | | | | | | | | | |
| N_{(2OH)(2OH)(2OH)1} | 24.9 | 11.6 | 9.9 | 9 | 8.6 | 8.2 | 8 | 7.7 | 7.6 | 7.5 | 7.4 | 7.2 | 7.2 | 7.2 | 7.2 | 7.1 | 7.1 | 7.1 | 6.8 |
| MeOSO₃ | | | | | | | | | | | | | | | | | | | |
| N_{(2OH)(2OH)(2OH)1} | 6.4 | 5.9 | 5.6 | 5.4 | 5.3 | 5.2 | 5.2 | 5.1 | 5 | 5 | 5 | 5 | 5 | 5 | 4.9 | 4.9 | 4.9 | 4.9 | 4.8 |
| L-Pro | | | | | | | | | | | | | | | | | | | |
| N₈₈₈₁ NTf₂ | 5.4 | 4.4 | 4.1 | 3.9 | 3.8 | 3.7 | 3.6 | 3.6 | 3.5 | 3.5 | 3.5 | 3.5 | 3.4 | 3.4 | 3.4 | 3.4 | 3.4 | 3.4 | 3.4 |
| N_{122(2O1)} BF4 | 8.8 | 7.5 | 7 | 6.8 | 6.7 | 6.6 | 6.5 | 6.5 | 6.5 | 6.5 | 6.5 | 6.5 | 6.5 | 6.5 | 6.5 | 6.4 | 6.3 | 6.3 | 6.3 |
| DIMCARB^{b} | 12.6 | 9.7 | 8.6 | 8 | 7.6 | 7.3 | 7.2 | 7 | 6.9 | 6.8 | 6.7 | 6.7 | 6.7 | 6.7 | 6.6 | 6.6 | 6.6 | 6.6 | 6.6 |

^{a}Static dielectric constants derived by polynomial extrapolation; see experimental FIG. 3A and Table 1 for details;
^{b}DIMCARB:Dimthylammonium dimethylcarbamate in a 1:1 ratio, distillable ionic liquid.

Table 6 presents the results for pyrrolidinium, pyridinium and piperidinium ILs which exhibit similar dielectric properties. They lie within the range of ε′≈5-10 with the highest found for C₄C₁Pyrr OTf. The other results are as expected with the largest imaginary contributions found for ILs with anions linked to greater electrical conductivities, i.e. OTf, N(CN)₂ and NTf₂.

TABLE 6
Dielectric constants of pyrrolidinium, pyridinium and piperidinium ionic liquids as a function
of frequency f (GHz). All measurements performed at 298 K, under an iert N₂(g) atmosphere.
See data for imaginary parts of the dielectric spectra and full plotted graphs.

| Ionic Liquid | 0^{a} | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|---|
| C₄C₁Pyrr | 10.5 | 9.1 | 8.2 | 7.7 | 7.4 | 7.2 | 7 | 6.9 | 6.8 | 6.8 | 6.7 | 6.6 | 6.6 | 6.5 | 6.4 | 6.3 | 6.1 | 6 | 6 |
| OTf | | | | | | | | | | | | | | | | | | | |
| C₄C₁Pyrr | 8.1 | 7.8 | 7.3 | 7 | 6.8 | 6.7 | 6.6 | 6.5 | 6.4 | 6.4 | 6.4 | 6.4 | 6.4 | 6.3 | 6.2 | 6.1 | 6 | 6 | 6 |
| N(CN)₂ | | | | | | | | | | | | | | | | | | | |
| C₄C₁Pyrr | 5.3 | 5 | 4.7 | 4.5 | 4.4 | 4.4 | 4.3 | 4.3 | 4.3 | 4.3 | 4.3 | 4.3 | 4.3 | 4.3 | 4.3 | 4.3 | 4.2 | 4.2 | 4.2 |
| FAP | | | | | | | | | | | | | | | | | | | |
| C₄-3- | 7.9 | 7.1 | 6.5 | 6.1 | 5.9 | 5.7 | 5.6 | 5.6 | 5.5 | 5.5 | 5.4 | 5.4 | 5.4 | 5.3 | 5.2 | 5.1 | 5 | 5 | 5 |
| MePyrr | | | | | | | | | | | | | | | | | | | |
| NTf₂ | | | | | | | | | | | | | | | | | | | |
| C₆py | 5.7 | 5.5 | 5.4 | 5.3 | 5.2 | 5.2 | 5.2 | 5.2 | 5.2 | 5.2 | 5.2 | 5.2 | 5.2 | 5.2 | 5.2 | 5.2 | 5.2 | 5.2 | 5.2 |
| Bf₄ | | | | | | | | | | | | | | | | | | | |
| C₆py | 6 | 5.6 | 5.2 | 5 | 4.8 | 4.7 | 4.7 | 4.7 | 4.6 | 4.6 | 4.6 | 4.6 | 4.6 | 4.6 | 4.6 | 4.5 | 4.5 | 4.5 | 4.5 |
| NTf₂ | | | | | | | | | | | | | | | | | | | |
| C₄-3- | 9.5 | 7.6 | 7.1 | 6.8 | 6.7 | 6.6 | 6.5 | 6.5 | 6.4 | 6.4 | 6.4 | 6.4 | 6.4 | 6.4 | 6.4 | 6.3 | 6.2 | 6.2 | 6.2 |
| Mepy | | | | | | | | | | | | | | | | | | | |
| MeOSO₃ | | | | | | | | | | | | | | | | | | | |
| C₃C₁Pip | 6.8 | 5.9 | 5.5 | 5.2 | 5 | 4.9 | 4.9 | 4.8 | 4.8 | 4.8 | 4.8 | 4.8 | 4.8 | 4.7 | 4.7 | 4.6 | 4.6 | 4.6 | 4.6 |
| NTf₂ | | | | | | | | | | | | | | | | | | | |

^{a}Static dielectric constants derived by polynomial extrapolation; see experimental, FIG. 3A and Table 1 for details.

Values for extrapolated static dielectric constants (0 Hz frequency) found in the literature often vary. Table 7 shows a comparison between values derived in this study with those for the same ILs found within multiple literature sources.

TABLE 7
Comparison of IL static dielectric constants derived
in this study with values found in the literature.

| | Static ε′ | Static ε′ Lit. |
|---|---|---|
| IL | Exp. | [Ref] |
| C₂C₁im BF₄ | 12.9 | 12.8 |
| | | 12.9 |
| | | 13.6 |
| C₄C₁im BF₄ | 9.7 | 11.2 |
| | | 11.7 |
| | | 12.2 |
| | | 13.9 |
| | | 14.1 |
| C₂C₁im NTf₂ | 13.8 | 12.0 |
| | | 12.3 |
| | | 12.3 |
| | | 14.0 |
| C₃C₁im NTf₂ | 9.3 | 11.8 |
| | | 13.3 |
| C₄C₁im NTf₂ | 9.3 | 11.5 |
| | | 11.6 |
| | | 14.0 |
| | | 15.0 |
| | | 13.7 |
| C₂C₁im N(CN)₂ | 12.5 | 11.7 |
| C₄C₁im N(CN)₂ | 10.3 | 11.3 |
| C₆C₁im PF₆ | 7.1 | 8.9 |
| | | 15.5 |
| N_{HHH2} NO₃ | 25.4 | 26.2 |
| | | 26.3 |
| S₂₂₂ NTf₂ | 14.0 | 13.2 |
| | | 15.8 |

The comparison of static dielectric constants shows a varied agreement with the literature. Some ILs are in good agreement. Our experimental value for S₂₂₂ NTf2 of 14.0 lies neatly between the two reported literature values of 13.2 and 15.8, which were from the same laboratory. Other ILs, such as C₂C₁im BF₄, C₂C₁im N(CN)₂ and N_{HHH2} NO₃, are in good to excellent agreement with multiple literature sources, and values for N_{HHH2} NO3 are also in excellent agreement at higher frequencies. It can be noted that our values for higher order alkyl imidazoliums (such as C₄C₁im BF₄ and NTf₂) are often slightly lower than those of the literature.

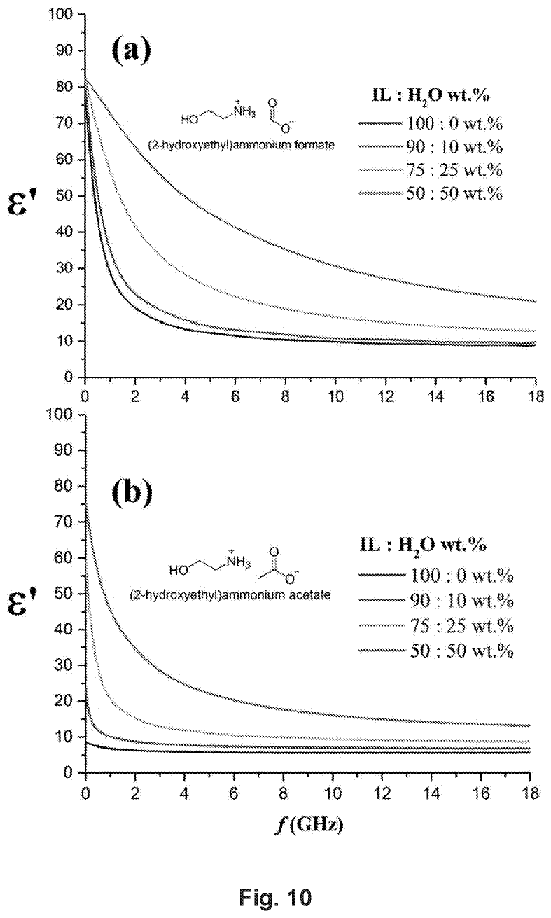

It has been previously reported that the addition of water to ILs has little effect on the permittivity and that at IL weight fractions above 0.75, the static dielectric constant is rather insensitive to the water content. This assertion was deduced using N_{HHH(2OH)} HCO₂ as an example which already possesses a static permittivity close to that of H₂O; thus the effect of water might be less visible. However, this may not be the case with other ILs with typically significantly lower static values, especially the protic ionic liquids (PILs) or those capable of hydrogen bonding. Indeed, significant changes in the permittivity spectra are observed. As shown in FIG. 10, the effect of increasing concentrations of H₂O on the complex permittivity spectra of the PILs N_{HHH(2OH)} formate and acetate is clearly visible. Although the effect on the static permittivity with respect to the formate analogue is negligible (80.5 for neat IL and 82.6 for a 50:50 IL:H₂O mixture), the overall complex permittivity spectra are significantly altered when the concentration of highly polar H₂O is increased. The effect is more dramatic on both the static and complex permittivity for the acetate analogue, which possesses a significantly lower static dielectric constant in its anhydrous form (8.7 for neat IL and 75.2 for a 50:50 IL:H₂O mixture).

The most common route for IL synthesis (especially the well-researched imidazoliums) is via a metathesis reaction involving a halide salt precursor. This can result in trace halides remaining in the final ILs which cannot be removed by treatment at elevated temperatures and reduced pressures. Halide content of ILs has been shown to have an effect on the physicochemical properties, e.g. increasing viscosity and decreasing density. In order to determine whether residual halide content affects IL complex permittivities, we prepared and measured C₂C₁im NTf₂ with varying concentrations of halide (<50 ppm, 250 ppm and 500 ppm). No change in the complex permittivity was observed, even when an extreme excess was added. Residual water content and temperature have much more significant effects on the complex permittivity and these should be of primary concern when measuring the dielectric constant of ILs or when applied to electronic devices exploiting permittivity. Several literature sources provide experimental methods for the quantitative halide determination of ILs, including microfluidic electrochemical devices and specialised capillary electrophoresis techniques.

### 9. Conclusions on ILs

A comprehensive comparison of permittivities was performed with common liquids and solvents, which have been well-defined in the literature from a multitude of sources, using the identical measurement and extrapolation procedure utilized for ILs in this study. Our data are in excellent agreement with the myriad of complex permittivity literature sources. The comparison of static permittivities for ILs between this study and the literature shows agreement ranging from excellent to poor. There are many factors for this disagreement, such as purity and age of samples, water content, the dielectric measurement technique used, the calibration procedure employed, and temperature sensitivity.

64 ILs were selected in this study. These include 28 imidazolium ILs which are the most commonly used and reported cations, paired with a wide variety of anions, and 11 ILs comprising a choline cation with mostly amino acid anions, which generally exhibit higher viscosities when compared to more common ILs and are of interest to those exploiting green chemistry materials or when bio-compatibility is desirable. A sulfonium, 8 phosphonium and 9 ammonium cations were also chosen as these represent a significant portion of the other commonly available ILs classes. Finally, 8 pyrrolidinium, pyridinium and piperidinium ILs were included as these can form a wide variety of useful low-viscosity liquids and are easily synthetically customizable. We feel that the selected ILs represent a wide range of common and lesser known materials that exhibit a variety of thermal, physicochemical, bio-compatible and electromagnetic properties.

The frequency-dependent dielectric constants of all 64 ILs were found to be within the range 3-30 (with the exception of N_{HHH(2OH)} HCO₂) with most following a known general trend of dielectric relaxation when approaching higher frequencies. This relaxation is reversed, albeit to a limited degree, when considering the ILs C₆C₁im I and C₈C₁im Cl. The slight increase in the dielectric constant from 0 to 18 GHz (of 0.5 for C₆C₁im I and 1 for C₈C₁im Cl) may result from the presence of single halide anions (I— or Cl—) which are present in both materials and will be investigated further. Another general observed trend throughout all the series is the reduction in overall permittivity when the mass or alkyl chain length is increased. This feature is best visualized through the imidazolium and choline series (FIG. 8A, FIG. 9). FIG. 8B shows the effect that functionalization of the 2-position of imidazolium cations has on polarity. Thus, addition of a methyl group to this position does not significantly reduce c′ for C₄C₁C₁im NTf₂ compared to C₄C₁im NTf₂. In relation to the imaginary contributions of the complex permittivity spectra, it can be said that ILs with high electrical conductivities have large imaginary parts, which is in accordance with the literature for these inherently linked properties.

We have also shown that the dielectric constants of ILs can be rather sensitive to the concentration of water and maintaining water content as low as possible is necessary for accurate measurement. This could be a reason for the previously reported high static values for the ILs N_{HHH(2OH)} acetate/lactate. We also determined that residual halides in the ILs examined does not affect the observed complex permittivity.

From the full range of ILs and their relative complex permittivity spectra (available in the supplementary data), it may be possible to select liquid materials with desired requirements. ILs with more stable dielectric relaxations across the full frequency range have also been identified, i.e. C₆py BF₄ or ILs with multiple large alkyl groups such as P₆₆₆₍₁₄₎ Cl. This phosphonium chloride IL (P₆₆₆₍₁₄₎ Cl) has other beneficial properties such as a temperature-stable complex permittivity and a wide liquid range (−69.8° C. to 350° C.), ideal for applications that require extreme temperatures and stable dielectric performance. It has recently been exploited by our groups as the resonating material in a miniaturised ultra-wideband DRA, the first example of an ionic liquid RF device. If one's requirements involve a more conductive medium, ILs with large imaginary contributions may be considered; these include C₂C₁im N(CN)₂, S₂₂₂ NTf₂ and N_{HHH2} NO₃. The presented complex permittivities, in combination with other reported physicochemical/thermophysical IL data, such as viscosity, density, conductivity, heat capacity and phase transition temperatures, can be of great use when selecting an IL with specific properties. In particular, the availability of a wide range of data will inform the application of ILs in catalysis, separation, electronics or perhaps a more comprehensive description of solvent properties.

Notes

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A composition having a relative permittivity, preferably a real part ε′ᵣ of a relative complex permittivity εᵣ, substantially inversely proportional to the square of a frequency of an alternating electrical field, preferably due to an electromagnetic field, for example applied thereto and/or propagating therethrough.

2. The composition according to any previous claim, comprising a dielectric liquid and/or a neutral liquid, for example comprising an amide, a sulfonamide, a phosphoramide, an alcohol, a nitrile, a ketone, a pyridine, a pyrrolidine, a piperidine, a furan, a sulfoxide and/or an alkylene carbonates.

3. The composition according to any previous claim, comprising a gelator.

4. The composition according to any previous claim, comprising dispersed particles.

5. The composition according to any previous claim, having a static relative permittivity of at least 100, preferably at least 1,000, more preferably at least 10,000 and/or having a static relative permittivity of at most 20, preferably at most 10, more preferably at most 5 at a frequency of 10 GHz.

6. The composition according to any previous claim, comprising an amide, for example having a functional group R₁—NH—CO—R₂ and/or having an isobutyramide functional group R₁—NH—CO—CH(CH₃)₂.

7. The composition according to any previous claim, comprising an ionic liquid.

8. The composition according to claim 7, wherein the ionic liquid comprises a imidazolium ionic liquid, for example C₂C₁im BF₄, C₂C₁im CH₃CO₂, C₂C₁im EtOSO₃, C₂C₁im N(CN)₂, C₂C₁im OTf, C₂C₁im NTf₂, C₂C₁im SCN, C₂C₁im DEP, C₂C₁im L-Lac, C₂C₁im FeCl₄, C₂OHC₁im OTf, C₂OHC₁im PF₆, C₃C₁im I, C₃C₁im NTf₂, C₃OC₁im PF₆, C₄C₁im BF₄, C₄C₁im SCN, C₄C₁im L-Lac, C₄C₁im MeOSO₃, C₄C₁im N(CN)₂, C₄C₁im NTf₂, C₄C₁C₁im NTf₂, C₆C₁im BF₄, C₆C₁im NTf₂, C₆C₁im PF₆, C₆C₁im I, C₈C₁im NTf₂ and/or C₈C₁im Cl.

9. The composition according to any of claims 7 to 8, wherein the ionic liquid comprises a choline ionic liquid, for example [Ch] HCO₂, [Ch] L-Ala, [Ch] L-Cys, [Ch] L-His, [Ch] L-Lac, [Ch] L-Lys, [Ch] L-Phe, [Ch] L-Pro, [Ch] L-Tryp, [Ch] Cl/Urea and/or [ACh] NTf₂, preferably [Ch] L-Ala.

10. The composition according to any of claims 7 to 9, wherein the ionic liquid comprises a phosphonium ionic liquid and/or a sulfonium ionic liquid, for example aP₄₄₄₃ HCO₂, aP₄₄₄₃ CH₃CO₂, aP₄₄₄₃ L-Lac, aP₄₄₄₃ L-Val, P₄₄₄₁ MeOSO₃, P₆₆₆₍₁₄₎ Cl, P₆₆₆₍₁₄₎ NTf₂ and/or S₂₂₂ NTf₂.

11. The composition according to any of claims 7 to 10, wherein the ionic liquid comprises an ammonium ionic liquid, for example N_{HHH2} NO3, N_{HHH(2OH)} HCO₂, N_{HHH(2OH)} CH₃CO₂, N_{HHH(2OH)} L-Lac, N_{(2OH)(2OH)(2OH)1} MeOSO₃, N_{(2OH)(2OH)(2OH)1} L-Pro, N₈₈₈₁ NTf₂, N_{122(2O1)} BF₄ and/or DIMCARB.

12. The composition according to any of claims 7 to 11, wherein the ionic liquid comprises a pyrrolidinium ionic liquid, a pyridinium ionic liquid and/or a piperidinium ionic liquid, for example C₄C₁Pyrr OTf, C₄C₁Pyrr N(CN)₂, C₄C₁Pyrr FAP, C₄-3-MePyrr NTf₂, C₆py BF₄, C₆py NTf₂, C₄ Mepy MeOSO₃ and/or C₃C₁ Pip NTf₂.

13. The composition according to any of claims 4 to 12, wherein the particles comprise a metal and/or a metal compound, for example a pure or unalloyed metal, an alloy thereof, an inorganic compound such as a ceramic comprising the metal, a metal chalcogenide, or an organometallic comprising the metal and/or mixtures thereof.

14. The composition according to claim 13, wherein the metal is a transition metal, for example a first row, a second row or a third row transition metal.

15. The composition according to any of claims 4 to 14, wherein the particles have a regular, such as spherical, cuboidal or rod, shape and/or an irregular, such as spheroidal, flake or granular, shape.

16. The composition according to any of claims 4 to 15, wherein at least 50% by weight of the particles have a diameter at most 200 μm, at most 100 μm, at most 50 μm, at most 25 μm, at most 15 μm, or at most 10 μm and/or wherein at least 1% by weight of the particles have a diameter of at least 10 nm, at least 100 nm, at least 1 μm, at least 2.5 μm, at least 5 μm, at least 7.5 μm, or at least 10 μm.

17. The composition according to any of claims 4 to 16, comprising from 1 to 60 wt. %, preferably from 5 to 50 wt. %, more preferably from 10 to 45 wt. %, most preferably from 15 to 40 wt. %, for example from 25 to 35 wt. % particles, for example 33 wt. %.

18. The composition according to any of claims 4 to 17, wherein the particles are in suspension.

19. The composition according to any previous claim, comprising and/or is a gel, for example a hydrogel, a nanocomposite hydrogel, an organogel and/or a xerogel.

20. The composition according to any previous claim, having a dynamic viscosity in a range from 10 to 1,000 Pa·s at 25° C.

21. The composition according to claim 1, comprising an electrically insulating polymer, dispersed particles and a binder/plasticizer.

22. The composition according to claim 21, wherein the polymer is a fluoro-polymer (such as PVDF and its co-polymers e.g. PVDF-HFP), carbopols, an acrylic such as PMMA, a polystyrene, a polyester, an epoxy, a polyamide, a silicone, a polyvinylpyrrolidone, a polyvinyl chloride, a polypropylene, a polyethylene, a polysiloxane, a polyimide, a polyacrylonitrile, a sulfur polymer, a synthetically functionalised polymeric material or a mixture thereof.

23. The composition according to any of claims 21 to 22, wherein the particles comprise a metal and/or a metal compound, for example a pure or unalloyed metal, an alloy thereof, an inorganic compound such as a ceramic comprising the metal, a metal chalcogenide, or an organometallic comprising the metal and/or mixtures thereof.

24. The composition according to any of claims 21 to 23, wherein the binder comprises and/or is a solvent, for example an organic solvent, an aprotic solvent and/or a polar solvent such as propylene carbonate, and/or a plasticizer such as dimethylcarbonate, diethylcarbonate, dibutyl phthlalate, tetramethylurea, triethylphosphate and trimethylphosphate.

25. A method of providing a composition having a relative permittivity, preferably a real part ε′ᵣ of a relative complex permittivity εᵣ, substantially inversely proportional to the square of a frequency of an alternating electrical field, preferably due to an electromagnetic field, for example applied thereto and/or propagating therethrough, wherein the method comprises:
including a solid phase in a liquid phase; and
optionally solidifying, at least in part, the liquid phase, thereby providing the composition.

26. An electronic device comprising a composition according to any of claims 1 to 24.

27. Use of dispersed powders in a dielectric matrix as an antenna.
